(19) United States
(12) Patent Application Publication
(10) Pub. No.: US 2021/0224759 A1
(43) Pub. Date: Jul. 22, 2021

(54) Method and System for Implementing a Currency Guaranteed By An Investment Vehicle

(71) Applicant: JOSE FRANCISCO ZORZANO BLASCO, LOGRONO (ES)

(72) Inventor: JOSE FRANCISCO ZORZANO BLASCO, LOGRONO (ES)

(21) Appl. No.: 16/768,995

(22) PCT Filed: Aug. 24, 2018
(86) PCT No.: PCT/US2018/047852

§ 371 Date: Jun. 2, 2020

Related U.S. Application Data
(60) Provisional application No. 62/612,823, filed on Jan. 2, 2018.

(51) Int. Cl. G06Q 20/06; G06Q 20/38; G06Q 40/02; G06Q 40/06; G06Q 20/36; G06Q 40/04; G06F 9/54

(52) U.S. Cl. CPC G06Q 20/0655; G06Q 20/381; G06Q 40/02; G06Q 40/06; G06Q 20/3674; G06Q 2220/00; G06Q 20/3676; G06Q 20/389; G06Q 40/04; G06F 9/541; G06Q 20/3829

(57) ABSTRACT

A computer-based system for issuing and managing a new currency of New Money including a management module, executable by a computer processor, configured to: create and manage a new currency backed by assets stored in acquired by an investment vehicle, in which a currency unit of the new currency is a title of an undifferentiated interest in the investment vehicle. The system allows the creation of more than one currency that can coexist simultaneously, so that each of them is backed by its own investment vehicle, which will be managed by its corresponding managers. The valuation of each currency will evolve according to the performance and valuation of the investment vehicles that support it. Money and investment vehicles are joined together and as a result a new type of money is created.

### BACKGROUND OF THE INVENTION

### 1. Field of the Invention

The present invention relates generally to value exchanges and in particular to a method and system for implementing a currency guaranteed by an investment vehicle.

### 2. Description of the Related Art

A conventional monetary system is known as fiat money. This system is the model was established in 1971, when President Nixon suspended dollar-gold convertibility by breaking the system that had emerged in 1944 with the Bretton Woods agreements under which the dollar was backed by gold, with one ounce of gold being equivalent to 35 dollars. Under this monetary model currently in force, money does not base its value on any metal, but on the faith or trust of the community. Its value in itself is null, the value of banknotes is reduced to the piece of paper on which they are printed and the metal with which coins are made does not have the value they represent. This is possible because of people's trust in the banknote issuer, usually the central bank of the country or the government itself, and also because of the certainty that money will be accepted by anyone in exchange for other goods or services.

Fiat money has drawbacks such as it may lead to the irresponsible management of central banks and governments, since they are able to create money at will without any material limit. Debts are transferred to future generations because the capacity of indebtedness of a country is infinite. It facilitates monetary speculation because money has no intrinsic value and allows all kinds of manipulations. The use of a given fiduciary currency is limited to one country or at most to a group of countries such as the Euro Zone.

There can be a loss of the value of money due to inflation and sometimes a lack of credibility with the consequent negative effects: it reduces the purchasing power of individuals whose income does not increase at the same rate as prices; it benefits debtors and damages creditors; it damages savings; it diminishes external competitiveness of the country's products. There can be damage caused by currency devaluations: a fall in real wages, an increase in the weight of debt denominated in foreign currency, or transfers of resources from one sector of the population with a high propensity to consume to another sector with a tendency to consume less.

The “idea of private money” has evolved which is embodied through a phenomenon of virtual currency, in particular, crypto-currency with crypto-currency systems The European Central Bank defines a virtual currency as the digital representation of value, not issued by any central banking authority, credit institution or recognized electronic money issuer, which can sometimes be used as an alternative to money as a means of payment. Crypto-currencies are a subset of virtual currencies based on cryptography. Crypto-currencies do not have a physical equivalent and usually are decentralized. Crypto-currencies do not depend on states, countries, governments, economic or banking entities. The holders of crypto-currency act as bankers of their money. Crypto-currencies use mathematical algorithms and an accounting registry, called blockchain, to ensure that every transaction is legitimate and to prevent fraud.

Crypto-currencies are a subset of virtual currencies based on cryptography, which deal with methods of information encryption for data security and authentication. Crypto-currencies use mathematical algorithms and a public accounting registry, called blockchain, to ensure that every transaction is legitimate and to prevent fraud. Crypto-currency is a virtual currency. It does not have a physical equivalent, it is decentralized, and it does not depend on states, countries, governments, economic or banking entities. The holders of crypto-currency act as bankers of their money.

Fiat money depends on a state, government or economic entity for its issuance, withdrawal and quotation, while crypto-currencies are decentralized, not dependent on any public entity. Similar to fiat money, crypto-currencies have the drawback of having no intrinsic value. Their value resides in the trust that the community places in currency.

These are extremely speculative and volatile currencies. The evolution of the value of Bitcoins is an example. At the time of their first acquisition, in October 2009, the price of one was $0.00076. At the beginning of 2009, when it was available for purchase by everyone, it was $0.003, compared to almost $20,000 in December 2017. They have either an extremely high or low unit value, which makes them unsuitable for everyday operations. An example of the former case is Bitcoin, where a loaf of bread costs 0.0003 Bitcoins. Coins with demand and acceptance tend to rise exaggeratedly, while those that are not accepted typically have very low unit values.

A collective investment vehicle is any entity that allows the capture of resources from a group of investors, to subsequently manage and invest them in goods, rights, securities or other instruments, whether financial or otherwise. The return to be received by each investor is determined on the basis of the collective results and the proportional part of the vehicle it owns.

Conventional types of investment vehicles include traditional investment funds, and Exchange Trade Funds (ETFs). An investment fund is an asset constituted by the contributions of several investors, called unit-holders of the fund, managed by a management company, and by a depository entity that holds the securities and cash and carries out guarantee and supervisory functions. The money contributed by clients is received by the depositary entity. The management company invests the money by acquiring products on the market that are stipulated in the investment vocation of the fund. The number of participations increases and decreases according to market needs. If the demand for the fund increases, the management company invests the money contributed by the unit holders and creates new participations of the fund. If demand decreases, the management company can “undo” those remaining participations by selling part of the fund's assets. It can acquire assets of all types such as quoted securities (shares, bonds, public debt, private debt, and the like), money (local or foreign currency), other funds, real estate, assets assigned to a holding (loans mortgage) and the like. Fees can vary depending on the fund. Conventional fees include management fees: cost the administration costs of the fund manager and deposit fees: cost for the custody of the depositary entity. Other fees that can be applied are: the subscription fee that is the cost of acquiring participations in the fund and the refund fee that is the cost of divestment in the fund. When people invest in a fund, they get a number of units, which have a daily price or net asset value, obtained by dividing the fund valued assets by the number of units in circulation. The yield of the fund is obtained at the time of sale of the participations, owing to the difference between the acquisition price and the amount obtained from its sale.

Exchange Trade Funds (ETFs) are investment funds that are quoted on the stock exchange in the same way as shares. These are intermediate products that match both traditional investment funds and equities. Similar to investment funds, the money contributed by clients is received by a depositary entity and the management company is responsible for making the investment of the money received. It also incorporates a specialist whose function is to promote the liquidity of the ETFs, and to ensure that the price of the listed fund is maintained at levels close to its net worth through arbitration.

The objective of an ETF is to reproduce a certain index; for example, a common ETF would be that of the IBEX-35, whose components are all those forming part of the Ibex-35. The return on this ETF would depend on the return on each of the assets in the basket. As with investment funds, the number of shares increases and decreases, depending on market needs. If the ETF demand increases, the management company buys more shares on the market and creates new ETF shares. If demand decreases, the management company can “undo” those surplus shares by selling them on the market. ETFs have a theoretical price, which is calculated by dividing their net worth by the number of shares in circulation of the ETF. The yield of the ETF is obtained, as in the case of funds, at the time of sale of holdings, by the difference between the acquisition price and the disposal price. In addition, ETFs may distribute dividends, which consist of the delivery of all or part of the dividends received from the shares forming the ETF and the interest that these have generated. Similar to investment funds, they have a management and deposit fee. However, this fee is often much lower than in traditional investment funds due to the passive management philosophy of these normally indexed vehicles.

It is desirable to provide a method and system for implementing a new type of money in which money and investment vehicles are joined together.

### SUMMARY OF THE INVENTION

In the present invention money and investment vehicles are joined together and as a result a new type of money is created, which is referred to as “New Money” that has a real objective value. In the present invention, to provide an objective real value to money, an investment vehicle is divided into equal undifferentiated parts and each of the resulting parts is associated with a New Money monetary unit, so that the monetary unit will be the property title of any participation in the investment vehicle. In the present invention, the new currency has an economic return that is derived from the investment vehicle. The profitability can be determined by the dividends and returns on the assets that make up the investment vehicle, as well as the increase in the price of these assets.

The owner of New Money currency unit will also be the owner of the stake in the investment vehicle and can, at any time, exchange the currency unit for its value as a stake in the investment vehicle. If the monetary unit is transmitted, the percentage of participation that it represents in the investment vehicle will also, necessarily, be transmitted, so that the new holder of the currency will have the ownership title of the percentage that corresponds to the monetary unit in the investment vehicle.

The investment vehicle will be managed by professional managers and the evolution of its value, and thus the value of the monetary unit will depend on the skill of the investment vehicle managers. This is an essential difference from conventional credit money, the value of which depended exclusively on the evolution of the price of metals, whereas in the system of the present invention the evolution of the value of the monetary unit will depend fundamentally on the skill of the investment vehicle managers

New Money will have a return that will correspond to its participation in the investment vehicle and will be determined, on the one hand, by the returns on the assets that make up the vehicle (dividends, interest, etc.) and on the other hand, by the variation in the price of these assets.

The New Money proposed in the present invention, unlike the conventional credit money (supported by gold and other metals) can be backed by an almost infinite base of goods since, in theory, it could be extended to all existing assets, which solves the problem of scarcity since the support of currency is globalized, thus guaranteeing that the resources on which it is based will not run out.

The price of the currency will hardly deviate from its value as a result of its participation in the investment vehicle in which the investment is made. This will substantially limit speculation and manipulation, since unlike fiat money or crypto-currencies, New Money will have an objective real value that will serve as a reference. The currency unit of New Money can have two different price types, theoretical and actual. The theoretical price is calculated by dividing the equity of the investment vehicle by the number of monetary units that have been issued, while the actual price is the result of the market price of the currency unit. However, as a result of the arbitrage that will be carried out by the managers, both theoretical and real price will be very similar: if the real price is lower than the theoretical one, the managers will buy currency units and sell the corresponding proportional part of the assets, thus obtaining a profit, and vice versa, if the real price is higher than the theoretical one, they will buy assets increasing the property and selling currencies in exchange, thus obtaining a profit.

The system of the present invention allows the creation of more than one currency that can coexist simultaneously, so that each of them is backed by its own investment vehicle, which will be managed by its corresponding managers. The valuation of each currency will evolve according to the performance and valuation of the investment vehicles that support it. If the currency unit was also a crypto-currency or electronic money, in addition to being backed by different investment vehicles it could also have different technical characteristics. The present invention provides a computer-based system for issuing and managing a new currency of New Money including a management module, executable by a computer processor, configured to: create and manage a new currency backed by assets acquired by an investment vehicle, in which a currency unit of the new currency is a title of an undifferentiated interest in the investment vehicle.

The different currencies that can be created will be quoted in relation to each other, depending on the type of investment vehicle and its particular characteristics. By comparing the theoretical valuation of different currencies, a theoretical quotation between them can be obtained. The actual price between them will depend on the market, but the arbitration processes will make the actual prices tend to coincide with the theoretical ones.

The currencies thus created by the system and method of the present invention can also quote, both in relation to fiat money and in relation to crypto-currencies such as Bitcoin. The purchase and sale of the currency can be made not only through the system manager but also on the secondary markets, either through “peer to peer” platforms or through other intermediaries. Like any other money, the currency of the present invention can be used as a means of electronic and online payment, through the use of credit cards, mobile devices and the like. The currency of the present invention referred to as New Money can be embodied in any of the known money options, such as paper money, coins, electronic money, crypto-currency and the like.

New Money will have a real objective value since it represents a participation in an investment vehicle; on the contrary, fiat money has no intrinsic value, its value resides in the trust placed by the community. In the present invention the management of the new currencies does not depend on any public entity and that they are limited by the value and evolution of the investment vehicle avoids any arbitrariness in the management, either of the central banks or of any entity that might try to manipulate the currency. In particular, it prevents governments from creating money without any material limits. In the present invention, currency speculation is limited, as the value of the currency will hardly deviate from the value of the investment vehicle in which the investment is made. The opposite is true of fiat money, which has no intrinsic value and allows all kinds of manipulation. By the present invention, society is prevented from living beyond its means by financing goods and services from debts to be borne by future generations. The system of the present invention, by its very nature, will encourage governments to manage themselves like families, that is to say, to spend resources to the best of a nation's ability.

The system of the present invention involves, among others, the manager of the crypto-currency and investment vehicle, and a depositary company for the money and the investment vehicle. The way in which these elements interact will give rise to different variants.

In the present invention a promoter can be used which is a managing entity that implements the system and that is not initially linked to an investment vehicle or a depository entity. The delivery of the New Money and the subsequent deposit of the vehicles can be in an independent depository entity, such as a bank. the managing entity and a mixed organization. The managing entity can implement the system and then its administration and management. The managing entity can also be responsible for the professional management of the investment vehicle. The present invention is a centralized model, where there are no miners, thus reducing energy consumption and where all the management is carried out by the managing entity together with a depository entity that will guarantee that both the money and the investment vehicle are guarded and at the disposal of clients until they decide to recover them. This means that the managing entity will not have access to the investment vehicle or to the money deposited by clients, as both belong to clients. The currency will be personal so that its owner is identified at all times, which will make it difficult to use for illicit purposes and it will also provide security against fraud and theft since it is associated with the identity of a natural or legal person and both the managing entity and the competent bodies of the administration will have access to the amounts held by each natural or legal person, as well as to the transactions carried out.

In the present invention, a policy of accumulation of dividends is chosen, which means that if the investment vehicle generates returns, these will not be distributed and will be accumulated in the existing patrimony. In contrast to crypto-currency, which in general has a very high or extremely low unit value, making it unsuitable for everyday operations, the unit value of New Money will be adapted to the needs of everyday operations. Initially its value can be approximately that of the Dollar or Euro and depending on its evolution it can be adapted, if necessary, by means of splits or contra-splits. Thus, for example, the number of currencies could be increased, without the investment vehicle varying, which would reduce their value proportionally, or, on the contrary, the number of currencies could be grouped together, which would increase their value in the same proportion as that of the grouping carried out.

In the present invention, the client is the New Money user. The managing entity can be the one in charge of the system management. As long as the managing entity contributes money to the investment vehicle it can also act as a client. The managing entity can also function in the market as a client by participating in New Money purchase and sale processes. The investment vehicle is the assets constituted by the contributions of clients or the managing entity, and which then materialize in whole or in part in the acquisition of assets. The depositary entity is the custodian of the assets (fiat money, crypto-currency and the investment vehicle), and performs guarantee and surveillance functions. A blockchain is a distributed computer system that serves as the basis for the operations of New Money materialized in the crypto-currency.

In the present invention, a client's assets, made up of the money given by them and the assets acquired, are always protected. For this purpose, the assets will always be deposited with a depositary entity. Clients, purchasers of New Money, will deliver their money to the depository entity that will keep it until it is invested in the purchase of shares of funds, ETFs, and the like to incorporate them into the investment vehicle. The shares acquired shall also be held by the same entity. In addition, clients can have in the depositary entity fiat money accounts and New Money wallets, as well as those of other crypto-currencies. The depositary entity can be the guarantor and shall be liable to client for the fact that the money delivered is used only for the purpose for which it was contracted, so that the money may only leave the depositary entity for one of the following four purposes: acquisition of shares in funds, ETFs, and the like for incorporation into the investment vehicle; to pay client the compensation due to a client after having delivered all or part of New Money units to the managing entity; for the payment to the managing entity of the commissions that will have been previously stipulated and that will be of public knowledge; and for the return to client, because he requires it, of the fiat money or the crypto-currency that could have deposited in the depository entity.

The managing entity can invest the money received from clients by purchasing on the asset market products that are stipulated in the investment vocation of the investment vehicle that supports the currency. The managing entity can decide the amounts to be invested in the different products of the asset market. The number of New Money units will increase and decrease according to market demand. If the demand for New Money increases, the fund manager will invest the money contributed by clients acquiring assets and creating new New Money units. If demand decreases, the managing entity will dispose of those surplus shares by selling part of the investment vehicle's assets in exchange for New Money units that will be delivered to it by clients. The shares, participations and other assets that are included in the investment vehicle and that are giving support to New Money will be out of the market so that they cannot be bought and sold. The only way to transfer these shares can be with the transfer of the crypto-currency. This means that shares, participations and other assets that are supporting New Money will automatically be out of the stock markets until such time as they are sold by the managing entity to reduce existing New Money units. It is known that most national legislations require that there be a minimum percentage of investment instruments (ETFs, funds, and the like) that must be able to be traded on organized markets. These percentages will vary depending on the investment instrument. Therefore, there will be cases in which the investment vehicle that supports the crypto-currencies will not be able to acquire 100% of other investment instruments: funds, ETFs, etc.

There can be two types of valuation: theoretical valuation and actual valuation. The theoretical price is calculated by dividing the equity of the investment vehicle by the number of New Money units issued, while the actual price will be the result of New Money quoted on the market. Generally both prices will tend to coincide. If there is an anomaly in the operation of the market that implies a deviation between the theoretical and the actual price, this can be resolved through arbitration by the managing entity: if the real price is lower than the theoretical price, the managing entity will buy New Money units and sell the corresponding proportionate share of the investment vehicle, thus obtaining a profit, and vice versa if the real price is higher than the theoretical price, it will buy assets by increasing the investment vehicle and selling New Money in exchange, thus obtaining a profit.

The invention will be more fully described by reference to the following drawings.

### BRIEF DESCRIPTION OF THE DRAWINGS

This disclosure is illustrated by way of example and not by way of limitation in the accompanying figures. The figures may, alone or in combination, illustrate one or more embodiments of the disclosure. Elements illustrated in FIGS. 1 through 15 are not necessarily drawn to scale. Reference labels may be repeated among the figures to indicate corresponding or analogous elements.

FIG. 1A is a schematic diagram of prior art currency of fiat money.

FIG. 1B is a schematic diagram of a currency of the present invention of New Money

FIG. 2 is a schematic diagram of the unit of currency of New Money which is the property title of an undifferentiated participation in the investment vehicle.

FIG. 3 is a schematic diagram of generation of new units of New Money.

FIG. 4 is schematic diagram of reduction in the number of New Money units

FIG. 5 is a schematic diagram of added value derived from the activity of the professional investment vehicle managers.

FIG. 6 is a schematic diagram that illustrates that New Money is backed by a practically infinite asset base because, in theory, it could be extended to all existing assets solving the problem of scarcity.

FIG. 7 is a schematic diagram of a New Money Yield that illustrates that New Money generates a return as a consequence of its share in the investment vehicle and that is the sum of the return on assets and the variation in their prices.

FIG. 8 is a schematic diagram of theoretical, real and arbitrage price of New Money.

FIG. 9 is a schematic diagram of adapting the value of New Money to the needs of daily life. illustrating that the price of New Money will generally be adapted to the needs of day-to-day operations, through the use of splits and reverse splits.

FIG. 10 is a schematic diagram of possible materializations of New Money

FIG. 11 is a schematic diagram of multiple currencies with different properties

FIG. 12 is a schematic diagram of functions and ways to acquire New Money

FIG. 13 is a schematic diagram of advantages of New Money versus fiat money.

FIG. 14 is a schematic diagram of advantages of New Money over the usual crypto-currencies.

FIG. 15 is schematic diagram of user relationship with central servers network.

FIG. 16 is schematic diagram of a working environment of a New Money system.

FIG. 17 is schematic diagram of central server network systems.

FIG. 18 is schematic diagram of a server system.

FIG. 19 is a flow diagram of client administrative registration.

FIG. 20 is a flow diagram of expansion of the investment vehicle as a result of the need to issue new units of New Money.

FIG. 21 is a flow diagram of the process of decreasing the investment vehicle as a result of the need to reduce the number of units of New Money.

FIG. 22 is a flow diagram of purchase of New Money from the managing entity

FIG. 23 is a flow diagram of the process of selling New Money by a client to the managing entity using, specifically, the services provided by the managing entity.

FIG. 24 is a flow diagram of Peer-to-peer currency exchange using internal exchange platform.

FIG. 25 is a flow diagram of a communication process between an external platform and the central server network systems to make secure use of the services implemented by the central server network systems.

FIG. 26. is a flow diagram of Peer to peer New Money transfers using the internal platform.

FIG. 27 is a flow diagram of Peer-to-peer New Money transfers using an external platform.

FIG. 28 is a flow diagram of executing an operation in a blockchain system for the execution of a particular request and the updating of the database distributed in the form of a secure blockchain.

FIG. 29 is a flow diagram of client registration security with a remote wallet.

FIG. 30 is a flow diagram of registration client security with wallet or local wallet.

FIG. 31 is a flow diagram of a registration platform security operation for the online registration of an external platform.

FIG. 32 is a flow diagram of a security operation for the identification process of a client who has previously registered with the system and who is accessing it through a public network.

FIG. 33 is a flow diagram of security in external platform identification.

FIG. 34. is a flow diagram of the security operation for the confidentiality process in transactions.

### DETAILED DESCRIPTION

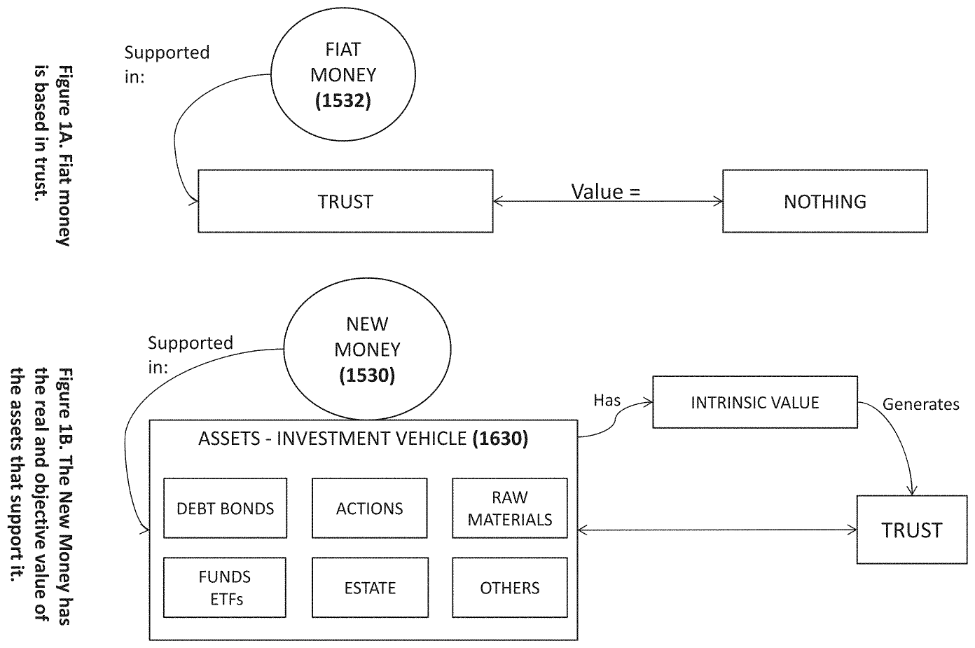

FIG. 1A is a schematic diagram illustrating that fiat money 1532 and conventional crypto-currencies, by themselves, are worth nothing. The value of fiat money 1532 or crypto-currencies lay in the trust that individuals place in them, as they think they can obtain goods and services in return.

FIG. 1B is a schematic diagram illustrating New Money 1530 being backed with an asset base of investment vehicle 1630, so that the value of New Money 1530 is the value of the assets that support it. The owner of New Money 1530 money units is also, in his or her proportion, the owner of the assets that support them and the target value of New Money 1530 units is the market value of the proportionate share they are entitled to in the investment vehicle 1630. Investment vehicle 1630 is any entity that makes it possible to raise resources, generally monetary, to invest them in assets, rights, securities or other instruments, whether financial or otherwise, and then to manage them.

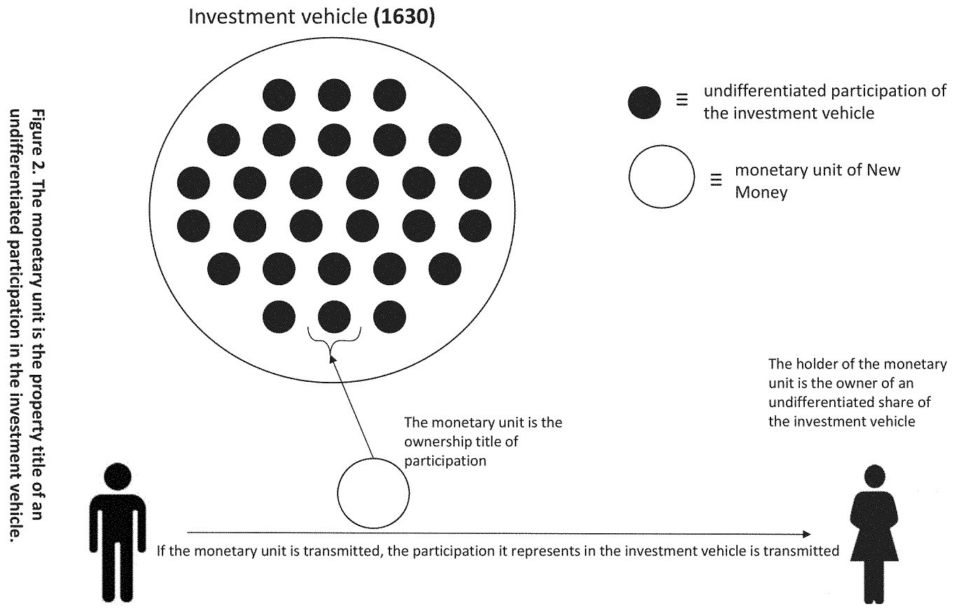

FIG. 2 is a schematic diagram illustrating the unit of currency of New Money is the property title of an undifferentiated participation in investment vehicle 1630. Investment vehicle 1630 can be divided in equal undifferentiated parts. Each of the resulting parts is associated with a New Money 1530 monetary unit so that the monetary unit can be the title of any participation in the investment vehicle 1630. The owner of New Money 1530 currency unit is the owner of the participation in investment vehicle 1630 and can, at any time, redeem the currency unit for its value as a participation in investment vehicle 1630. If the monetary unit of New Money 1530 is transmitted, the participation that it represents in investment vehicle 1630 is necessarily transmitted, so that the new holder of the currency holds the title to the percentage that corresponds to the monetary unit in investment vehicle 1630.

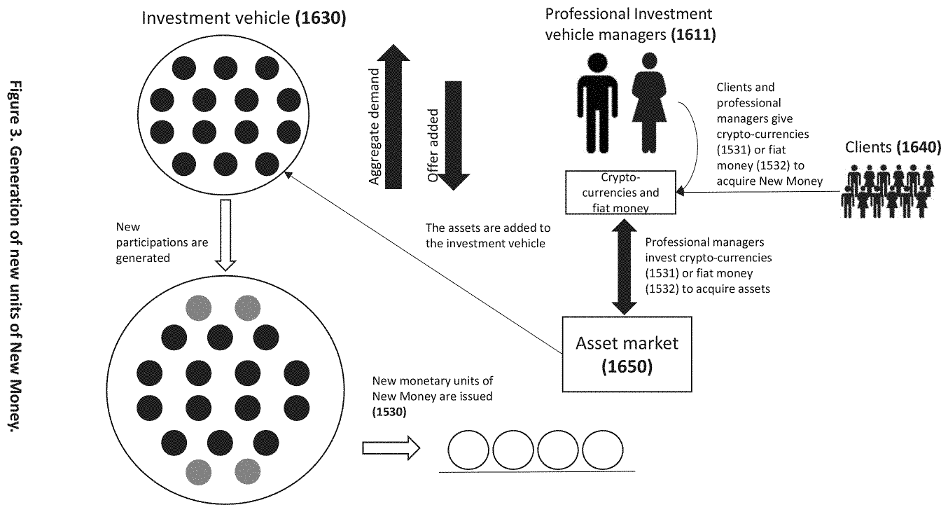

FIG. 3 is a schematic diagram illustrating generation of new units of New Money. Each currency unit of New Money 1530 is the title deed to an undifferentiated participation in investment vehicle 1630. The number of units of New Money 1530 will increase or decrease as the aggregate balance of supply and demand of New Money 1530 evolves. If aggregate demand is greater than aggregate supply, professional investment vehicle managers 1611 can issue new units of New Money 1530 to meet this difference can result in expansion of investment vehicle 1630. For this purpose, professional investment vehicle managers or clients 1640 demanding new money units of New Money 1530, can generally contribute 1532 fiat money or crypto-currencies 1531 to the investment vehicle 1630 for professional investment vehicle managers 1611 to invest, if they consider it appropriate, the money given, in acquiring assets that are added to investment vehicle 1630 and that will support New Money 1530 units that will be generated.

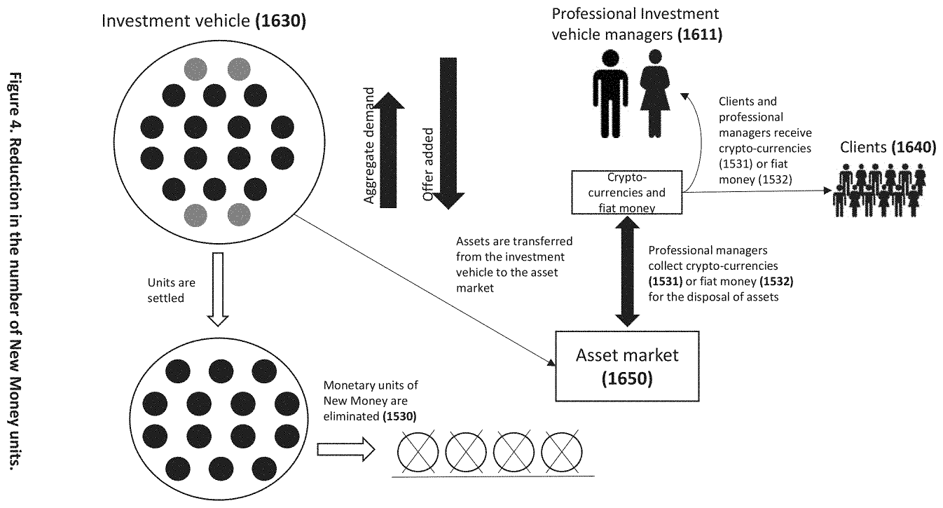

FIG. 4 is a schematic diagram illustrating a reduction in the number of New Money units. Each unit of currency of New Money 1530 is the title deed to an undifferentiated participation in investment vehicle 1630. The number of units of New Money 1530 will increase or decrease as the aggregate balance of New Money 1530 supply and demand to professional investment vehicle managers 1611 evolves. If the aggregate supply is greater than the aggregate demand, professional investment vehicle managers 1611, in order to meet this difference, can acquire the excess of New Money 1530 units from clients 1640, which in turn leads, if market conditions so advise, to a reduction in the investment vehicle. Generally, professional investment vehicle managers 1611 sell, if they consider it appropriate, the proportional part of the investment vehicle 1630 corresponding to the number of units of New Money 1530 delivered by clients 1640, and then transfer to them the amount obtained, for example in the form of fiat money 1532 or crypto-currency 1531.

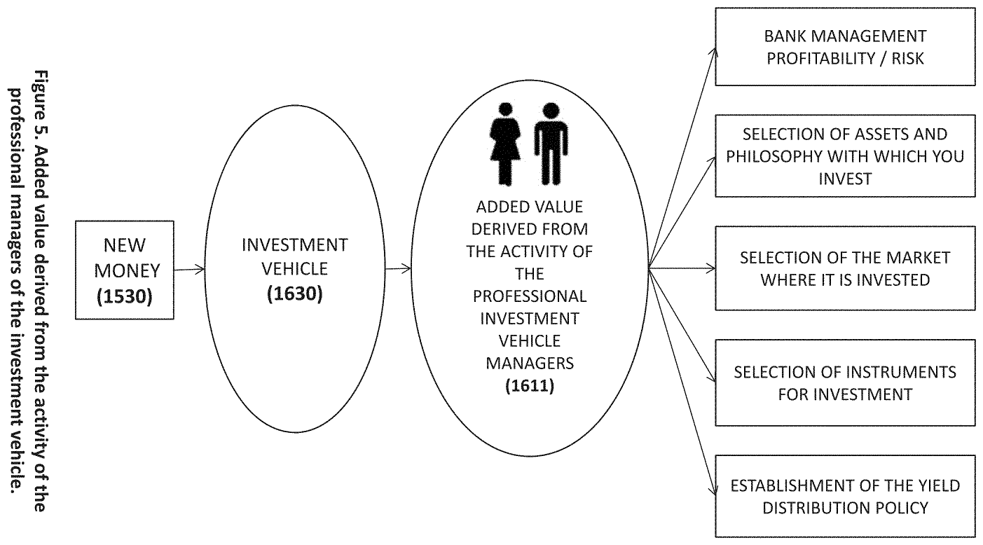

FIG. 5 is a schematic diagram of an added value derived from the activity of professional Investment Vehicle Managers. Investment vehicle 1630 and the evolution of its value can be managed by professional investment vehicle managers 1611. The value of New Money 1530 currency unit can depend on the expertise of investment vehicle managers 1611. Depending on the type of implementation some of the functions of professional investment vehicle managers 1611 are: management of the profitability/risk binomial, if security is preferred to profitability, the investment vehicle 1630 is conservative and invests in low-risk products even if the expected return is not high or if the return is more valued, regardless of the risk, then the investment vehicle 1630 invests in products of high expected return, which leads to the assumption of more risk; selection of assets and investment philosophy, including listed securities such as stocks, bonds, public debt, or private debt, fiat money, usually in local or foreign currency, investment funds, real estate or assets assigned to an operation as mortgage notes, equities, bonds, commodities, specific sectors, single country, multi-country, global, sectoral, regional, with a specific investment style or philosophy, direct, reverse, developed market, emerging market, currency market, alternative investments, short index, leveraged or other assets; selection of the market where the investment is made such as investment vehicles 1630 that invest in unlisted securities on official markets or investment vehicles 1630 that invest in listed securities such as for example shares, bonds, public debt, private debt, mortgage bills and the like; selection of instruments for investment such as for example invests indirectly through funds, ETFs, collective investment schemes or directly in shares, real estate, raw materials; and establishment of the yield distribution policy such as for example investment vehicles 1630 that distribute dividends to coin holders and investment vehicles 1630 that do not distribute dividends by accumulating them in existing equity.

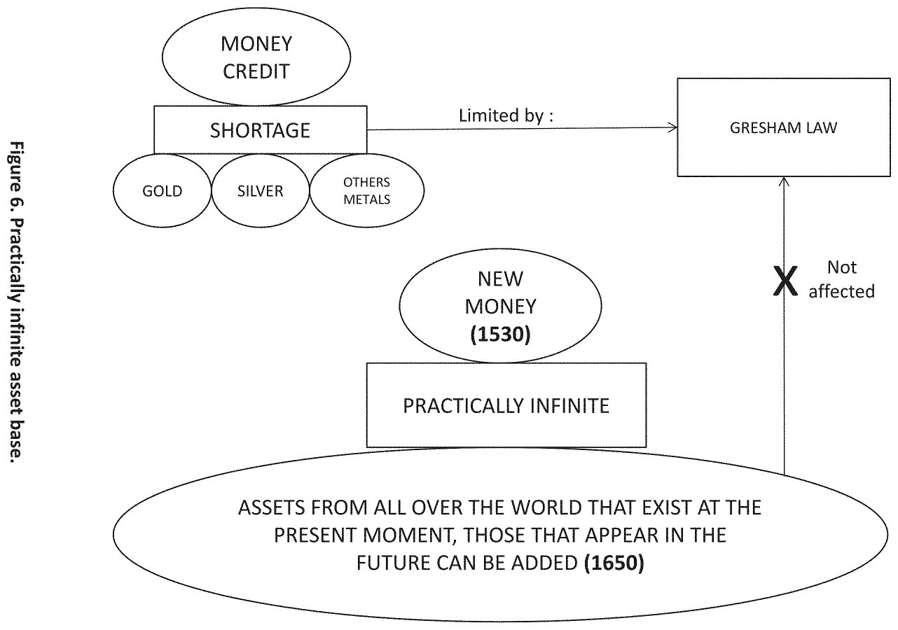

FIG. 6 is a schematic diagram of attributes of New Money 1530 of having a substantially infinite asset base. Prior art money credit which is supported by gold and other metals is limited by Gresham's law. This law, states that a currency with intrinsic value tends to disappear from circulation as it is demanded in exchange for coins with no intrinsic value until its stocks are exhausted.

New Money 1530, unlike prior art money, can be backed by a virtually infinite asset base and is not controlled by Gresham's law. New money 1530 can be extended to all existing assets 1650, which solves the problem of scarcity in relation to the modern version of Gresham's law. Since the support of New Money 1530 is globalized, it guarantees that the resources on which it is based will not run out.

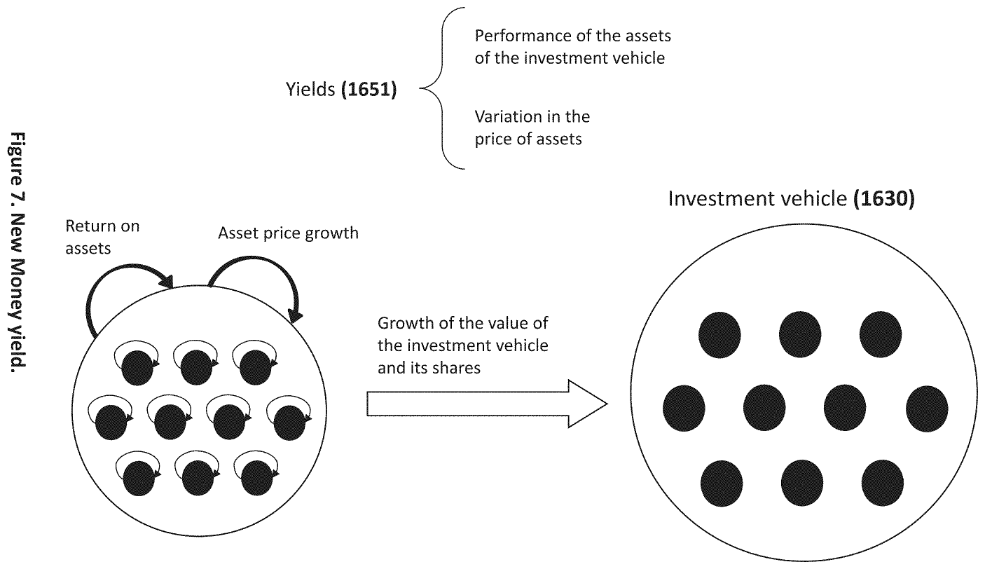

FIG. 7 is a schematic diagram of a yield of New Money 1530. New Money 1530, being the title of ownership of a share in an investment vehicle 1630, generates a return that corresponds to participation in the investment vehicle 1630. The return will be the sum of the return on the assets making up the investment vehicle 1630 as dividends or interest and the variation in the price of these assets.

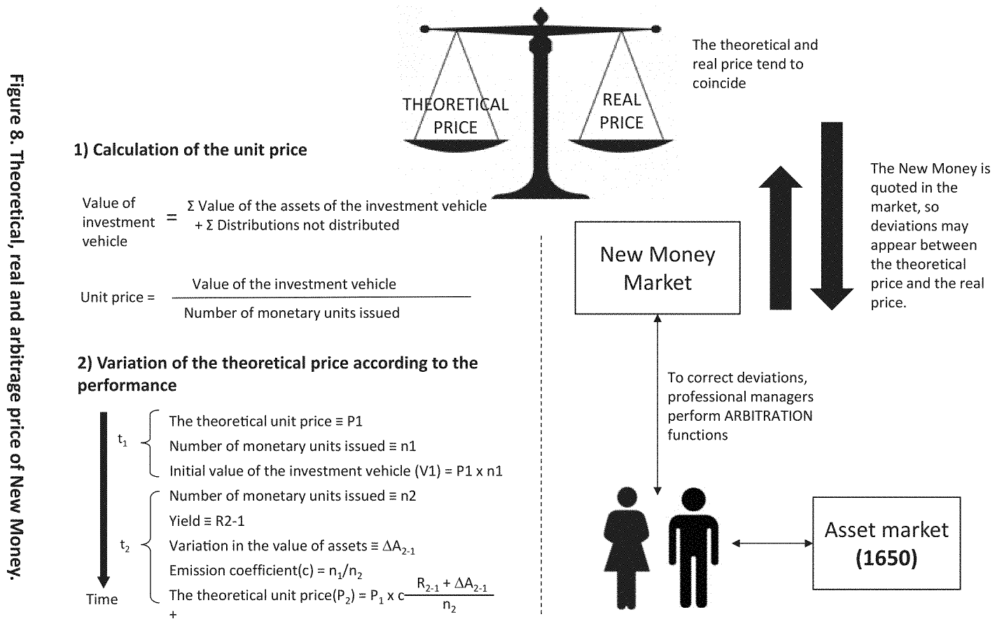

FIG. 8. is a schematic diagram of a theoretical, real and arbitrage price of New Money. New Money 1530 can generally have two types of prices: theoretical and real. The theoretical price is calculated by the quotient between the equity of the investment vehicle 1630 and the number of units of New Money 1530 issued. The assets of investment vehicle 1630 are made up of the value of its assets plus the value of the returns that they have generated and that have not been distributed. Thus, they have been accumulated to the investment vehicle 1630. FIG. 8 shows the variation in the theoretical price as a result of the performance of the investment vehicle 1630.

P₁≡Theoretical price of New Money currency unit 1530 at time 1
V₁≡Theoretical initial value of investment vehicle 1630 at time 1
V₂≡Theoretical initial value of investment vehicle 1630 at time 2
V₂₋₁≡Change in the theoretical value of investment vehicle 1630 between moments 1 and 2
R₂₋₁≡Undistributed return on investment vehicle 1630 generated from time 1 to time 2
ΔA₂₋₁ ≡Change in value of assets from time 1 to time 2
n₁≡Number of New Money money units 1530 at time of writing 1
n₂≡Number of New Money money units 1530 at time of writing 2
c≡Emission coefficient≡n₁/n₂ After a period of time the new theoretical price will be P₂ which is calculated as follows:

P₂=V₂/N₂=(V₁+V₂₋₁)/N₂=(P₁×N₁+R₂₋₁+ΔA₂₋₁)/N₂=P₁×C+(R₂₋₁+ΔA₂₋₁)/N₂

The real price is the result of the quotation of New Money 1530 on the market. It has been found that generally the real price tends to coincide with the theoretical price, thereby substantially limiting speculation and manipulation. This is because, unlike fiat money 1532 or crypto-currencies 1531, New Money 1530 will have a real objective value that serves as a reference. If there is an anomaly in the functioning of the market that leads to a deviation between the theoretical and the real price, this can generally be resolved through arbitration by professional investment vehicle managers 1611: if the real price of New Money 1530 is lower than the theoretical price, professional investment vehicle managers 1611 can buy units of New Money 1530 and sell the corresponding proportional part of the assets of investment vehicle 1630. Alternatively, if the real price is higher than the theoretical one, professional investment vehicle managers 1611 can buy assets, increasing the assets of the investment vehicle 1630 and sell New Money 1530 in return.

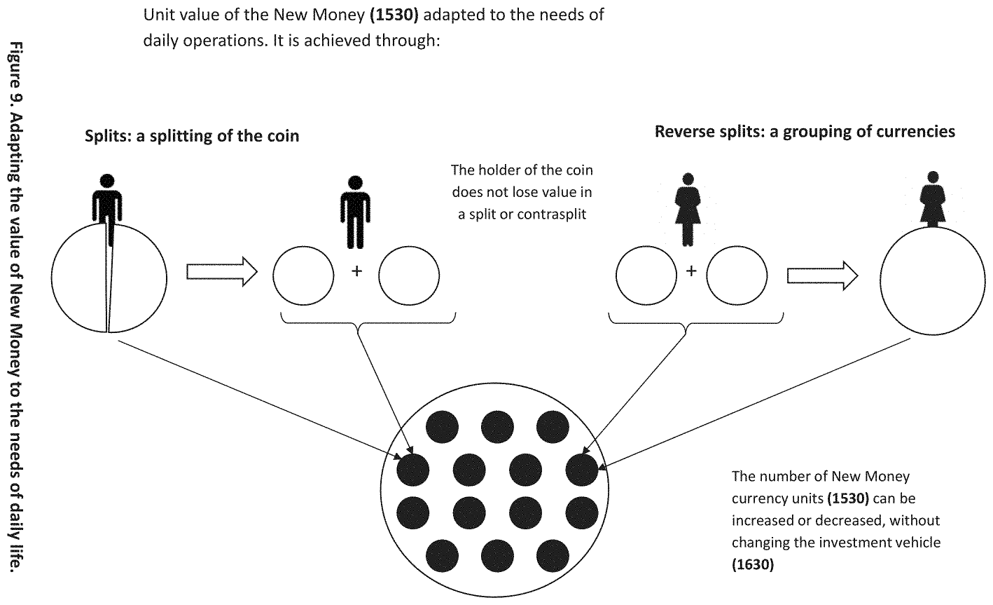

FIG. 9. is a schematic diagram of how New Money of the present invention is adapted for the needs of daily operation. In one embodiment, the adaptation of New Money 1530 is achieved by means of splits, which is a currency splitting, or counter-splits which is the opposite, a grouping of currencies. For example, the number of monetary units of New Money 1530 can be increased without investment vehicle 1630 varying, which would reduce their value proportionally or, on the contrary, the number of monetary units can be grouped together without changing the investment vehicle 1630, which means that their value increases in the same proportion as the grouping carried out. Split or counter-split operations do not affect the value of New Money 1530 held by holders of New Money 1530, which is compensated by an increase or decrease in the number of currency units proportional to the split or counter-split.

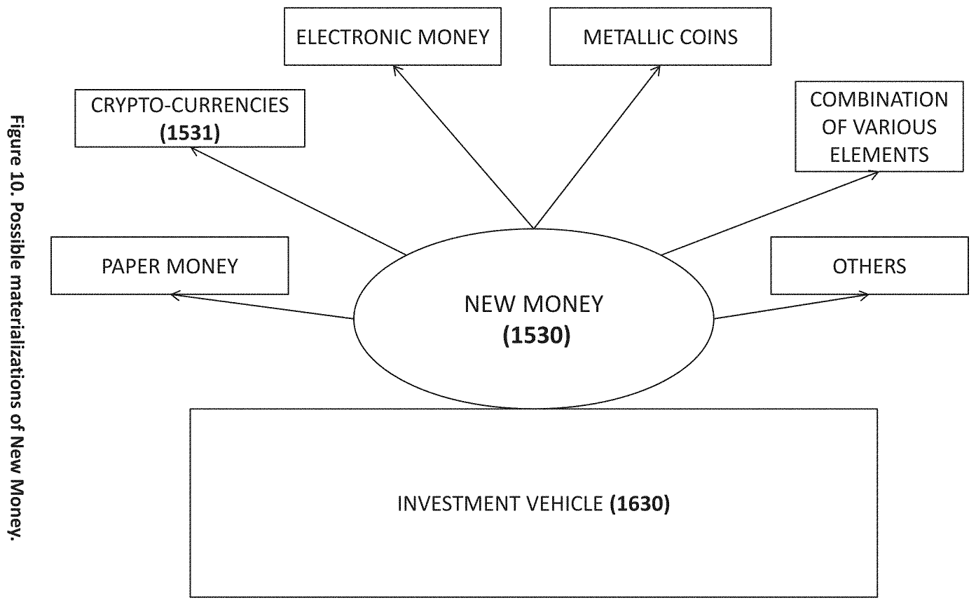

FIG. 10. is a schematic diagram of possible materializations of New Money 1530. New Money 1530 currency unit can materialize in any of the known money options such as, for example: crypto-currencies 1531; electronic money; paper money, metallic coins and combinations thereof. New Money 1530 in any of its materializations is always backed by investment vehicle 1630.

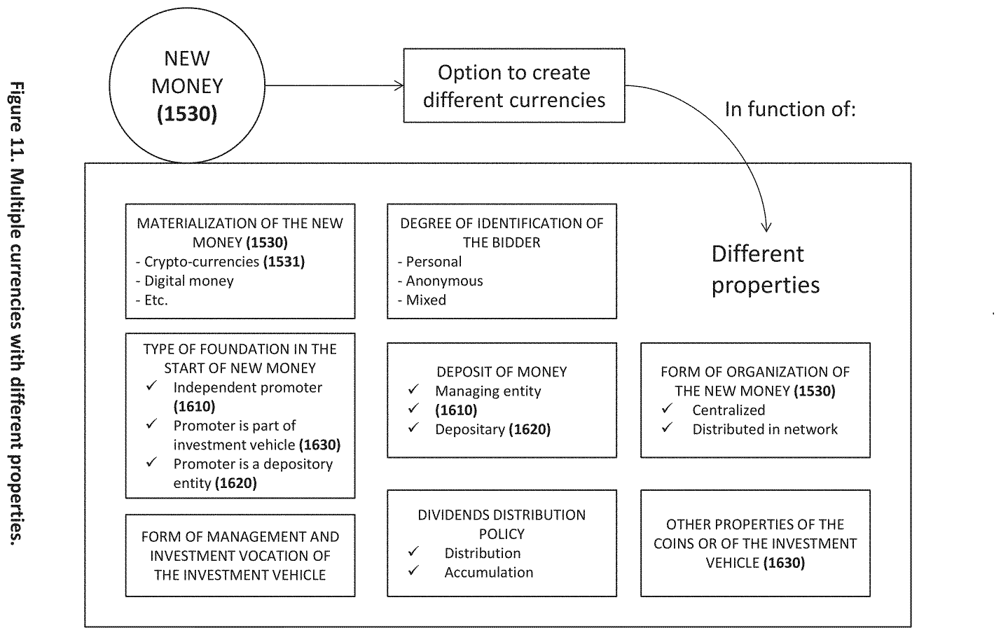

FIG. 11 is a schematic diagram of the use of the present invention with multiple currencies with different properties. Each of the types of currencies can coexist simultaneously, so that each of them is supported by its own investment vehicle 1630, which is managed by its corresponding professional investment vehicle managers 1611, and may or may not belong to the same managing entity 1610.

Generally speaking, the different currencies that can be created are quoted in relation to each other, depending on the type of investment vehicle 1630 and its particular characteristics. By comparing the theoretical valuation of the different currencies a theoretical quotation between them can be obtained. The actual price between them depends on the market, but the arbitration processes can make the actual prices tend to coincide with the theoretical ones as described in FIG. 8. New Money 1530 coins can also be quoted against fiat money 1532 and other crypto-currencies 1531 such as Bitcoin or Ethereum.

Several options shown in FIG. 11 that, when combined, result in different models of coin systems with different technical, financial and economic characteristics of the present invention include: materialization of new money 1530 to a type of currency unit including crypto-currencies 1531, electronic means used by cards, mobile devices and the like, paper money, metallic coins and combinations of one or more of the above; degree of identification of the possessor, for example the owner of the coin is known, personal coins in which the owner is identified at all times, anonymous currencies in which it is not possible to associate the currency with its holder and mixed coins in which the advantages of both types of coins are combined; form of organization of the management of the currency being centralized or decentralized and distributed in the network; founder of the currency including the promoter is one or more of investment vehicles 1630, the promoter in a depositary entity 1620, managing entity 1610 is an managing company that implements the system and is initially not linked to either investment vehicle 1630 or depository entity 1620, between where clients 1640 deliver their money 1531, 1532 and where the investment vehicle 1630 is deposited, an independent depositary entity 1620, for example a bank, managing entity 1610 or a mixed organization; and differences based on the investment vocation of the investment vehicle 1630. The present invention can have different classes of implementation depending on factors including: profitability and risk binomial; asset class and philosophy invested in; listing on official markets; class of instrument used; form of management of investment vehicle 1630: direct use in which a promoter is the one who manages the currency and delegate use in which the promoter does not manage the currency and commissions and another entity can carry out this activity. The dividends distribution can include distribution in which investment vehicles 1630 distributes dividends to coin holders and accumulation in which investment vehicles 1630 do not distribute dividends and the dividends are accumulated in existing equity. The dividends can also be distributed depending on other properties of both investment vehicle 1630 and the currency.

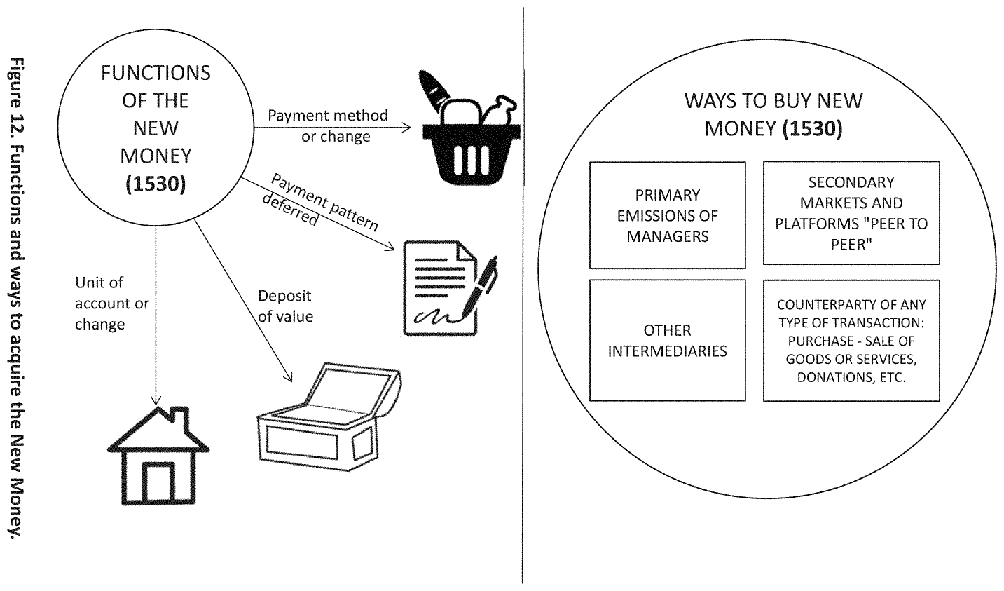

FIG. 12. is a schematic diagram of functions and ways to acquire New Money 1530 of the present invention. New Money 1530 can have common functions of conventional money. New Money 1530 can be used as a means of electronic payment, online, through the use of credit cards, mobile devices, and the like. New Money can be used as a crypto-currency, the use of New Money 1530 as a means of telematic payment can be enhanced, taking advantage of the characteristics of the present invention. New Money 1530 can be used as a unit of account or unit of exchange. Units of New Money 1530 can be used to express the prices of items. New Money 1530 can be used as a deferred payment pattern. New Money 1530 can be used when people enter into contracts that require future payments New Money 1530 can be specified for the monetary terms and in terms of debts. New Money 1530 can be used as a deposit of value money.

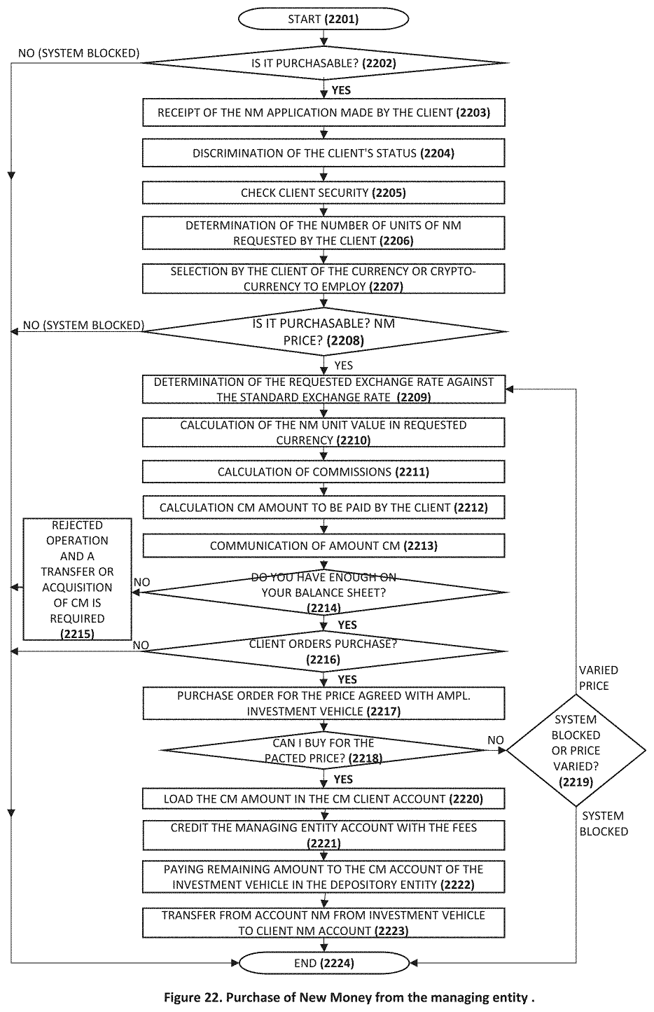

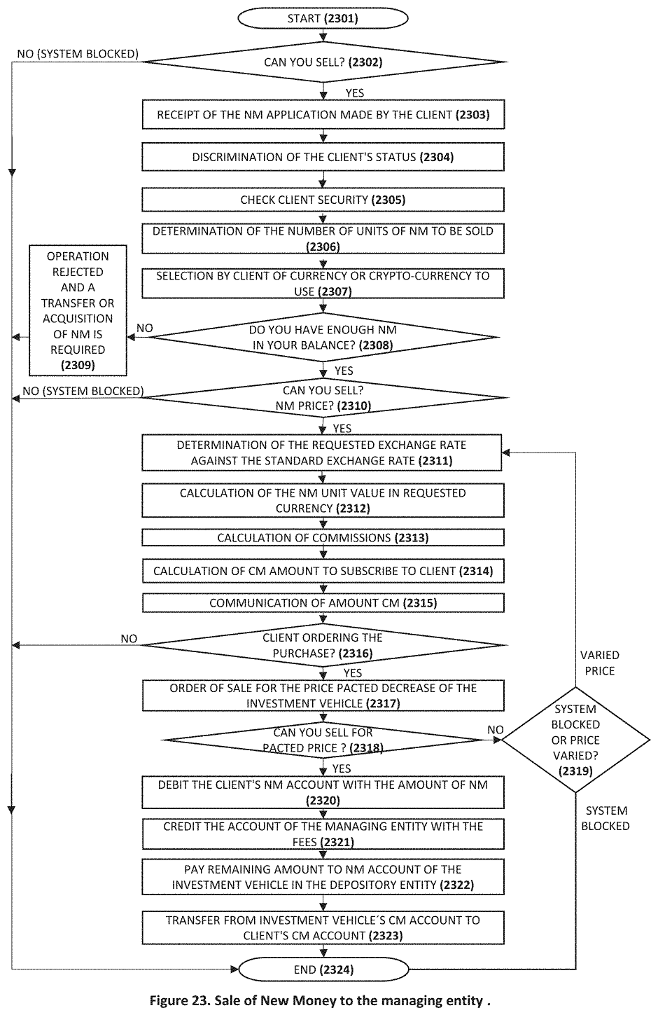

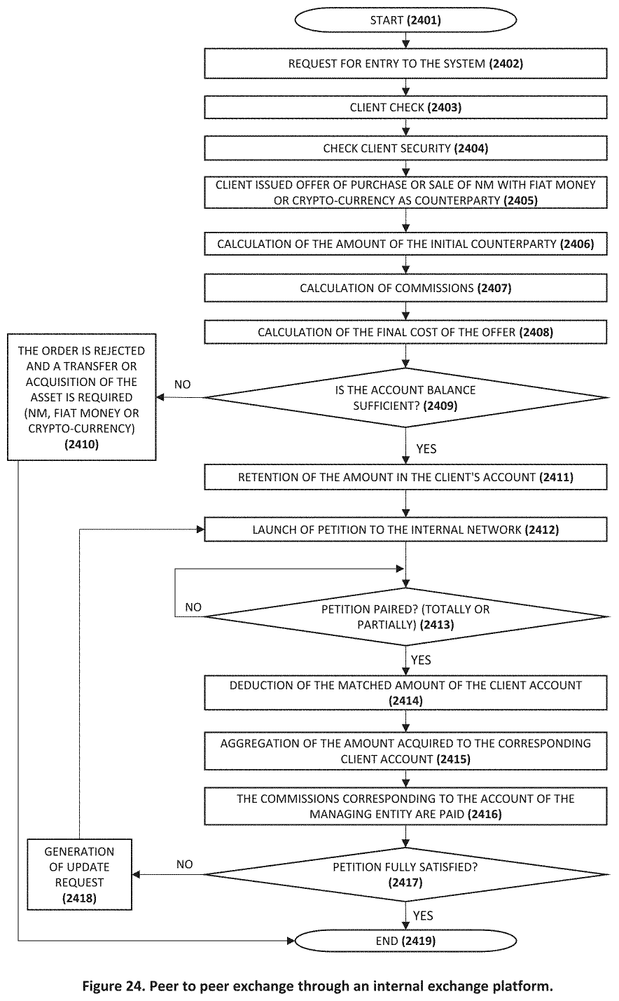

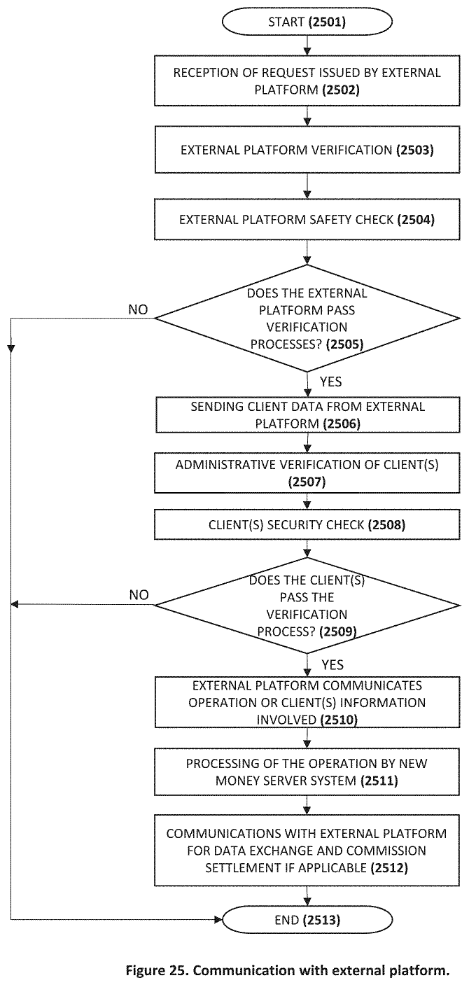

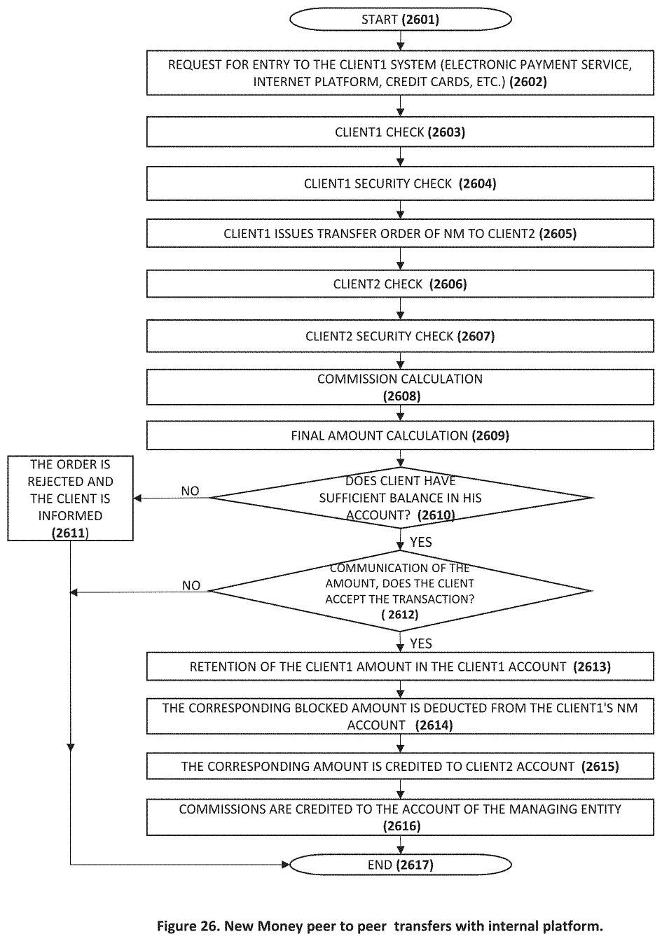

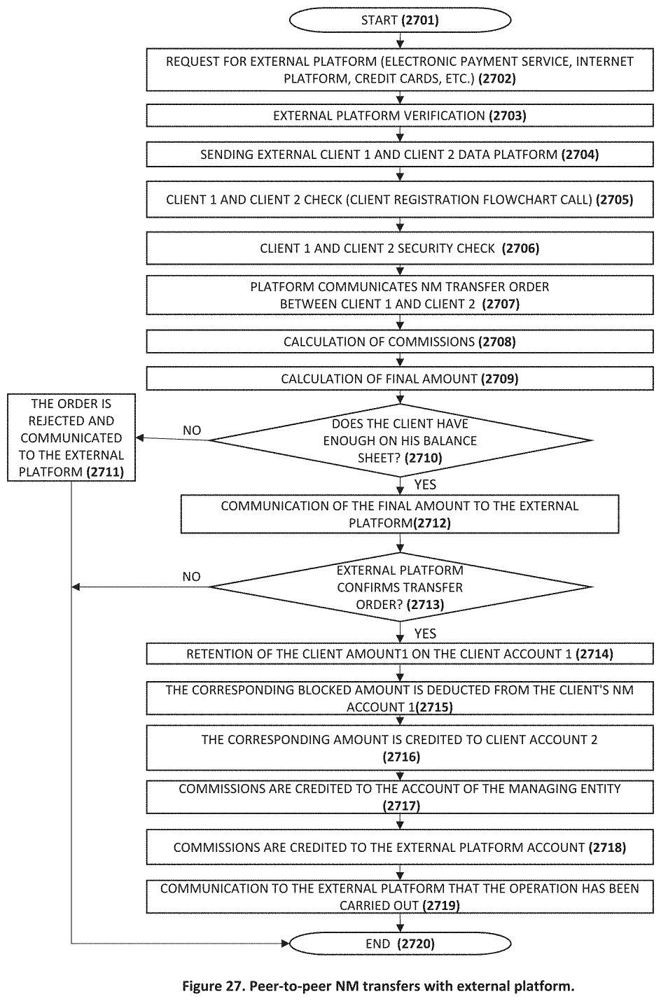

New Money 1530 can be acquired and disposed of in the following ways: buying or selling New Money 1530 to managing entity 1610, which will normally involve the generation or reduction of New Money 1530 units, usually using fiat money 1532 or crypto-currency 1531 as payment. This process can be implemented: by means of the direct services offered by the system operator (as shown in FIG. 22 and FIG. 23); by means of external platforms 1660 in which external platform 1660 acts as an intermediary between client 1640 and system manager (as shown in FIG. 25); by acquiring or selling New Money 1530 units in a peer to peer market, normally using fiat money 1532 or other crypto-currencies 1531 as payment; through the internal platform provided by the system operators (as shown in FIG. 24); by means of external exchange platforms (as shown in FIG. 25); by receiving or sending units of New Money 1530 in exchange for any type of transaction such as purchase and sale of goods or services, donations, and the like: by means of the internal platform provided by the system operators (as shown in FIG. 26); and by means of external exchange platforms 1660 (as shown in FIG. 27).

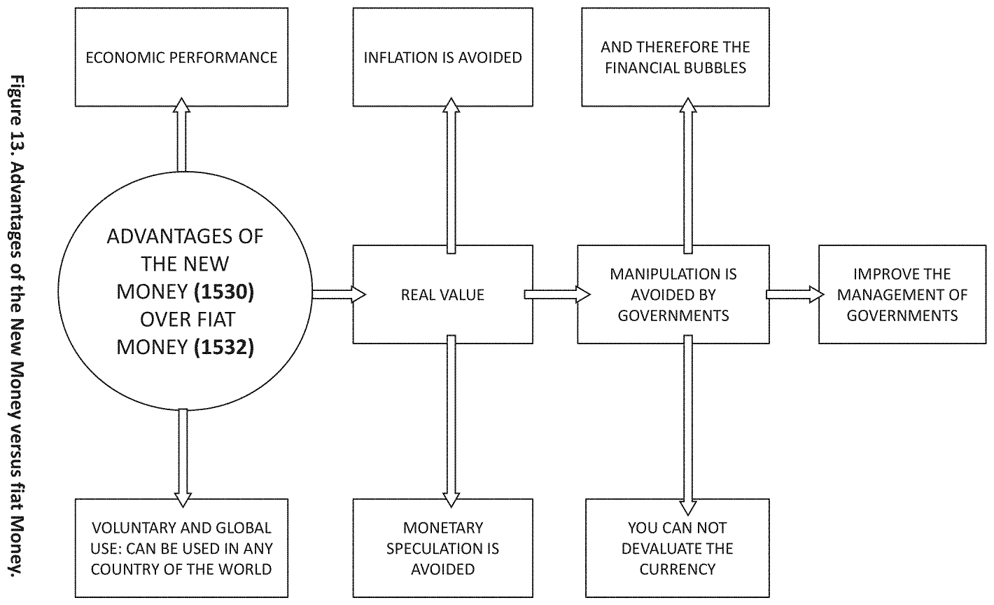

FIG. 13 is a schematic diagram showing advantages of New Money over conventional fiat money. New Money 1530 presents, among others, the following advantages over the fiat money 1532: New Money 1530 has an objective real value since it represents a participation in investment vehicle 1630, whereas conventional fiat money 1532 has no objective real value and its value resides in the trust placed by the community. Use of New Money 1530 is voluntary and not imposed by force as is the case with traditional coins. Management of New Money 1530 does not depend on any public entity and is conditioned by the value and evolution of investment vehicle 1630. New Money 1530 avoids the manipulation of money and, in particular, prevents governments from creating money without any material limit. Monetary speculation is limited since the real value of a currency unit of New Money 1530 can hardly deviate from the theoretical value of investment vehicle 1630 in which the investment is made. New Money 1530 encourages governments to manage in a measured manner, which means to spend resources to the best of a nation's ability. New Money 1530 prevents financing of goods and services from debts, which future generations must take care of. Currencies cannot be devalued since the value of New Money 1530 depends on the performance of investment vehicle 1630, thus avoiding the negative effects of devaluations on the population. The effects of inflation are avoided and the possibilities of generating financial bubbles are limited by using New Money 1530. New Money 1530 can be used in any country in the world. New Money 1530 has an economic return that is derived from investment vehicle 1630. The return is determined by the dividends and returns on the assets that make up investment vehicle 1630, as well as the increase in the price of these assets. By owning New Money 1530 inflation avoided and potentially has a return, which benefits the poorer classes as they are the ones who have more difficulties in making their investments profitable.

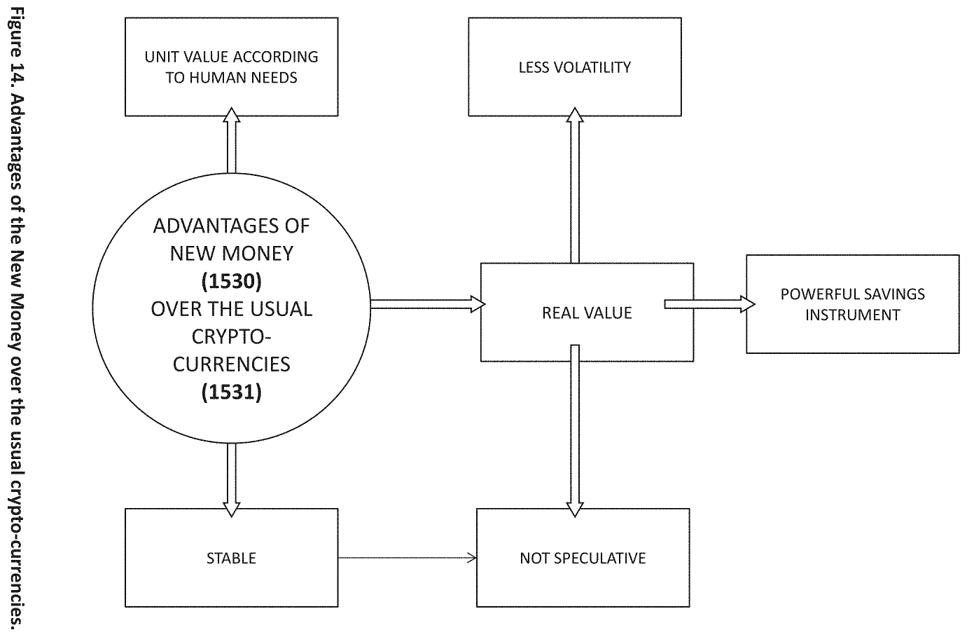

FIG. 14 is a schematic diagram of advantages of New Money 1530 over conventional crypto-currencies 1531. New Money 1530 presents, among others, the following advantages over the crypto-currencies 1531: New Money 1530 is a stable currency and volatility is limited because New Money 1530 is not speculative since the price will depend on the value of investment vehicle 1630, which in turn depends on the evolution of the investment portfolio, which will prevent sudden movements in its valuation. New Money 1530 has a real objective value since it represents a participation in investment vehicle 1630, whereas crypto-currencies 1531, similar to fiat money 1532, has no real objective value and its value lies in the trust placed by the community and in speculation. By means of splits and counter-splits, the unit value of New Money 1530 can be adapted to the needs of everyday use, which can encourage the use of New Money 1530 as a method of ordinary payment.

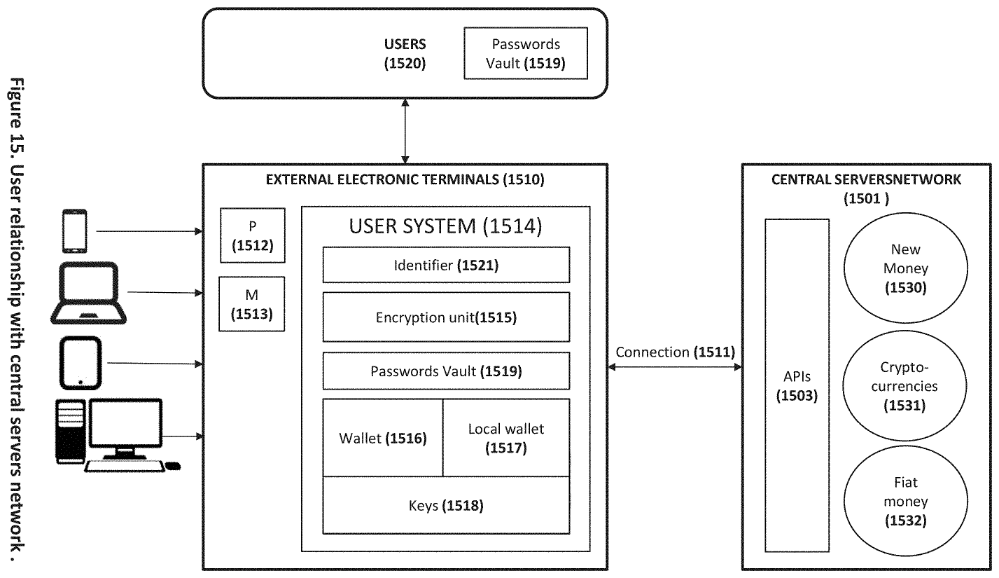

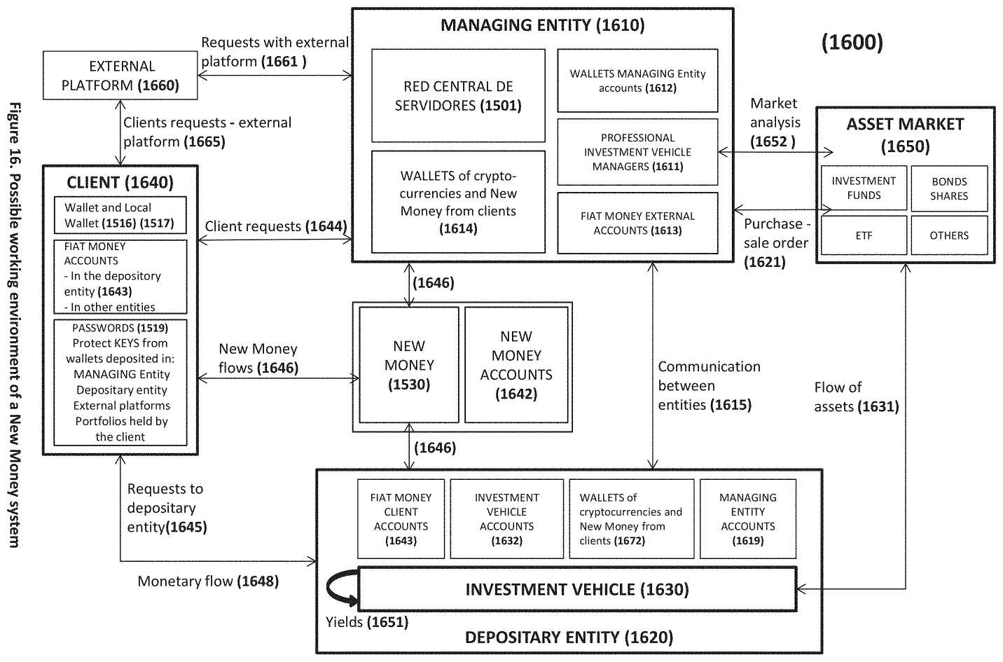

FIG. 15. is a schematic diagram of user 1520 relationship with central server network 1501. It will be appreciated that a plurality of users 1520 can access central server network 1501. System for the regulation of a digital currency 1500 can be used with assets such as New Money 1530, crypto-currency 1531 or fiat money 1532. Security systems can be implemented in external electronic terminal 1510. User 1520 is understood to be a natural person, entity, body or any other element or system with the capacity to carry out operations with central server network 1501 through the necessary means. User 1520 can be a client 1640 of the managing entity 1610 or external platforms 1660 that implement services from New Money 1600 working environment as shown in FIG. 16.

Referring to FIG. 15, users 1520 establish secure connections 1511 to central server network 1501 through external electronic terminals 1510. External electronic terminals 1510 can be a tablet, personal computer, personal digital assistant, mobile phone, laptop, or any other type of device that can establish secure connection 1511 to central server network 1501. Secure connections 1511 can be a telematic connection to central server network 1501, usually with wired or wireless communication. Each of external electronic terminals 1510 can contain one or more processors 1512, memories 1513 or any system that allows for proper communication with central server network 1501 or with any particular system in a possible New Money 1600 system working environment as shown in FIG. 16.

Referring to FIG. 15, external electronic terminal 1510 can maintain user system 1514. Normally, user system 1514 can be in charge of implementing certain functionalities for the correct development of the operation with central server network 1501, such as, but not limited to, connection management services, encryption services, or storage features. Generally, these services are supported by discrete external or internal devices such as one or more processors 1512, one or more memories 1513, encryption unit 1515, wallet 1516 or local wallet 1517.

User system 1514 can include encryption unit 1515 that can encrypt and decrypt required information, following one or more encryption methods such as asymmetric keys or symmetric keys. In one implementation, encryption unit 1515 can maintain one or more keys 1518 that can take the form of wallet 1516, local wallet 1517 or any other materialization that guarantees the storage and security of one or more keys 1518 according to the available technology. User 1520 can also maintain one or more passwords externally on external electronic terminal 1510 that can encrypt or decrypt one or more keys 1518 stored in wallet 1516 or local wallet 1517. In some embodiments, wallet 1516 or local wallet 1517 can maintain one or more passwords 1519 that normally allow access to one or more keys 1518 encrypted by user 1520 through the encryption unit 1515 or through the security engine 1760 of central server network 1501.

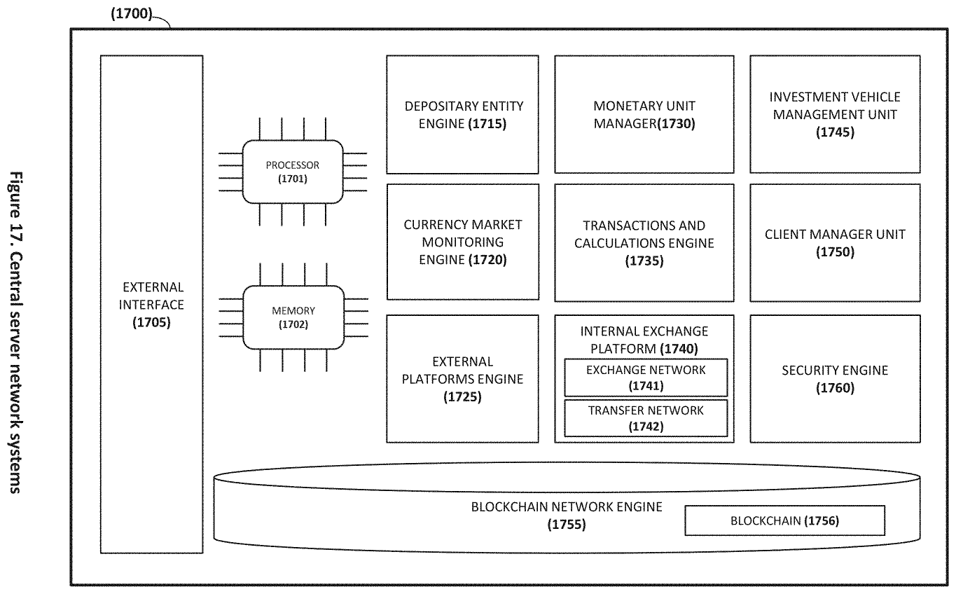

Users 1520 of New Money system 1600 shown in FIG. 16 receive identifier 1521 during the registration process as shown in FIG. 15. In one embodiment, user system 1514 is responsible for managing identifiers. In one embodiment, users 1520 can manage identification and encryption methods using external electronic terminals 1510 by establishing connection 1511 facilitated by APIs 1503 with security engine 1760 shown in FIG. 17 and defining encryption methods or parameters to be followed, for example, the establishment of a seed generation of a pair of keys 1518 (public-private), or a key generation protocol. In this way, user 1520 can choose various settings for the security of their operations as shown in FIG. 15.

System for the regulation of a digital currency 1500 has central server network 1501 from which part of New Money system management is performed. Central server network 1501 has computer resources including one or more processor modules 1701 that allow information management and implement a set of central server network systems 1700 shown in FIG. 17 to carry out the activities necessary for the proper functioning of New Money system 1600 shown in FIG. 16, so that a task can be carried out with the collaboration of a subset of systems. Central server network 1501 shown in FIG. 15, through one or more processor modules 1701 shown in FIG. 17, manages external communication of managing entity 1610 shown in FIG. 16 and can give instructions on communication between entities if required. For example, external electronic terminal 1510 can establish connection 1511 to central server network 1501 to warn of the methods of sending data with depository entity 1620 shown in FIG. 16. In general, users 1520 shown in FIG. 15 can access additional services from central server network systems 1700 shown in FIG. 17 through APIs 1503 shown in FIG. 15. These services may include, but are not limited to, access to restricted data from blockchain 1756 shown in FIG. 17 which can use encryption unit 1515 shown in FIG. 15, external calculation services or investment vehicle 1630 data queries, for example, fluctuations in the value of assets on asset market 1650 shown in FIG. 16. In general, data is in memory 1702 properly sorted and managed by blockchain network engine 1755 shown in FIG. 17 in any format suitable for its proper handling. In some cases, central server network 1501 shown in FIG. 15 can provide users 1520 with fundamental operations through APIs 1503, such as management of the connection between external electronic terminals 1510, procedures with managing entity 1610 shown in FIG. 16, in general related to New Money 1530, such as the sale of New Money 1530, fiat money 1532 or crypto-currency 1531, transfers of New Money 1530, placement of an offer to purchase or update the status of wallet 1516 or local wallet 1517 as shown in FIG. 15.

In some embodiments, processor modules 1701 may be necessary for the operation of other services carried out by the systems of central server network 1501, such as the subdivision by mathematical algorithms of the total value of investment vehicle 1630 shown in FIG. 16 into a plurality of equal and undifferentiated parts, the assignment of a unit value of digital currency, the implementation of intelligent contracts or any service relevant to the operation of the invention.

FIG. 16 is a schematic diagram of an implementation of system for New Money 1530 referred to as New Money System 1600. The teachings of FIGS. 1 to 14, can be implemented in many different ways. FIG. 11 lists, while not exhaustive, several options whose combination can result in different models with different technical, financial and economic characteristics. Within the range of options listed in FIG. 11, one possible implementation, by way of example, is New Money system 1600 illustrated in FIG. 16.

Managing entity 1610 can implement, administer and manage New Money system 1600. Managing entity 1610 can be responsible for the professional management of the investment vehicle 1630 using communication between entities 1615. In one embodiment, a unit of currency materialized in a digital currency is chosen and supported on a blockchain system that can also be used for electronic payments by cards, mobile terminals, along with others.

A centralized model is chosen, where there are no miners, thus reducing energy consumption and where the entire management is carried out by managing entity 1610 together with depository entity 1620 that will guarantee that both the investment vehicle 1630 and the money are guarded and at the disposal of clients 1640 until they decide to recover it. Managing entity 1610 will not have access to either the investment vehicle 1630 or the money deposited by clients 1640. The currency will be personal so that its owner is identified at all times, which makes it difficult to use for illicit purposes. The competent administrative bodies will have access to the amounts held by each natural or legal person and to the transactions they carry out. Likewise, the identification of the owner provides security against possible fraud and theft since New Money monetary unit is associated with a natural or legal person.

A policy of accumulation of dividends is chosen, which means that if investment vehicle 1630 generates yields 1651, yields 1651 are not distributed, but are added to the existing assets of investment vehicle 1630. In one embodiment, managing entity 1610, which is responsible for the administration of the system may also act as client 1640 to the extent that it contributes money to investment vehicle 1630. Depositary entity 1620 can be an institution that holds and exercises guarantee and surveillance functions over the assets of investment vehicle 1630 and over the assets of clients 1640. Both assets of investment vehicle 1630 and assets of clients 1640 can be deposited with depositary entity 1620. For example, depositary entity 1620 can hold, among others, fiat money 1532 in fiat money client accounts 1643, fiat money accounts in investment vehicle accounts 1632, assets purchased with money of client 1640 money that are part of investment vehicle 1630 and managing entity accounts 1619. Investment vehicle 1630, which is the assets made up of the contributions of clients 1640 which then materialize in the acquisition of assets on asset market 1650, although managing entity 1610 can also choose to maintain positions of liquidity when they deem it appropriate. Client 1640 can use external platforms 1660 which are entities outside managing entity 1610, which can channel client 1640 transactions to acquire, dispose of and transfer New Money 1530.

The present invention provides a new type of money referred to as New Money 1530, which has an objective real value as opposed to fiat money 1532 or crypto-currency 1531. In the present invention money and that of investment vehicles, are united in such a way that in order to give real objective value to money, investment vehicle 1630 is divided into equal undifferentiated parts and each of the resulting parts is associated with New Money 1530 monetary unit. A monetary unit of New Money 1530 can be the title deed of any participation in investment vehicle 1630. This means that the owner of a currency unit of New Money 1530 is also the owner of participation in investment vehicle 1630 and can exchange the currency unit for its value as a participation in investment vehicle 1630. If the currency unit is transferred, the percentage share that it represents in investment vehicle 1630 is necessarily transferred, so that the new holder of the currency holds the ownership title to the percentage that corresponds to the currency unit in investment vehicle 1630.

Investment vehicle 1630 can be managed by professional managers 1611 and the evolution of its value, and thus the value of the currency unit, depends on their expertise. The value of the monetary unit depends fundamentally on the skill of the professional managers 1611 of investment vehicle 1630.

New Money 1530 has yield 1651 corresponding to participation in investment vehicle 1630 and can be determined by the returns of the assets that form the vehicle as dividends or interests and by the variation of the price of these assets. New Money 1530 can be backed by an almost infinite base of goods because, in theory, it can be extended to all existing assets, which solves the problem of scarcity since it globalizes the support of currency and guarantees that the resources on which it is based will not be exhausted.

New Money 1530 has two kinds of prices: theoretical and real. The theoretical price is calculated by dividing the equity of investment vehicle 1630 by the number of units of New Money 1530 issued. The theoretical price is intrinsically linked to the change in the value of investment vehicle 1630. If the management of investment vehicle 1630 by professional managers 1611 is good and its value rises, the value of a currency unit of New Money 1530 also rises. The real price is the result of the price of New Money 1530 on the market, and generally tends to coincide with the theoretical price. For various reasons, there can be a deviation between the theoretical and the actual price, which is resolved through arbitration by managing entity 1610: if the real price is lower than the theoretical price, managing entity 1610 can buy units of New Money 1530 and sell the corresponding proportionate part of its assets, thus obtaining a profit. If the real price is higher than the theoretical price, managing entity 1610 can buy assets increasing its assets and sell New Money 1530 in exchange, thus obtaining a profit.

The use of New Money 1530 as a means of payment can be made both through the Internet and through the use of credit cards, mobile devices or any other money transfer mechanism. The unit value of New Money 1530 is adapted to the needs of everyday operations. Initially, its value can be approximate to a currency such as the US Dollar or Euro and depending on its evolution it can be adapted, if necessary, by means of splits or counter-splits. For example, the number of coins can be increased, without investment vehicle 1630 varying, so that they decrease in value proportionally. Alternatively, the number of coins can be grouped together, so that the value of the coins increases in the same proportion as that of the group.

In one embodiment, managing entity 1610 is responsible for management of New Money System 1600. Client 1640 can be anyone who contributes money to investment vehicle 1630. Managing entity 1610 has a central server network 1501 described in FIG. 15 that implements systems such as external interface 1705, depository entity engine 1715, currency market monitoring engine 1720, external platforms engine 1725, monetary unit manager 1730, transactions and calculations engine 1735, internal exchange platform 1740, exchange network 1741, transfer network 1742, investment vehicle management unit 1745, client management unit 1750, blockchain network engine 1755, blockchain 1756 and security engine 1760 as shown in FIG. 17.

Referring to FIG. 16, managing entity 1610 stores wallets of managing entity's accounts 1610 and wallets of other crypto-currencies 1531 held by the managing entity 1610. Generally, managing entity 1610 can maintain fiat money external accounts 1613 with both the depository entity 1620 and other entities, such as banks or savings banks. managing entity 1610 can offer a hosting and maintenance service for client wallets of crypto-currencies and New Money 1614 for those clients 1640 who do not have custody of wallets 1516 or local wallets 1517 as shown in FIG. 15 whether they are New Money 1530 or other crypto-currencies 1531. Alternatively, wallets of crypto-currencies and New Money 1672 can be held in depository entity 1620. Alternatively, client 1640 can have wallets of both New Money 1530 and other crypto-currencies 1531 be guarded by external platforms 1660.

In one embodiment, managing entity 1610 has professional managers 1611 who are in charge of administering and managing investment vehicle 1630. The evolution of the value of investment vehicle 1630, and thus the value of a money unit of New Money 1530 depends on the expertise of professional managers 1611. In the present invention the evolution of the value of the currency unit of New Money 1530 can depend fundamentally on the skill of the professional managers 1611 of investment vehicle 1630.

Generally, every time a sale or a transaction of New Money 1530 occurs such as the purchase of a good or service with New Money 1530 or a donation of New Money 1530 is made, a tax event occurs. In one embodiment, managing entity 1610 is responsible for providing both clients 1640 and the competent tax authorities with the necessary information to comply with tax obligations, providing summary and detailed information on the operations that have generated taxable income.

Depositary entity 1620 can hold the assets of clients 1640, performs guarantee and monitoring functions and assure client 1640 that the money delivered is only used for the stipulated purposes. Depository entity 1620 is normally a banking entity, in which investment vehicle 1630 is deposited. Depositary entity 1620 is also responsible for receiving and delivering to clients 1640 fiat money 1532 for the acquisition or disposal of monetary units of New Money 1530. Fiat money 1532 delivered by clients 1640 for the purchase of New Money 1530 or the money obtained from the sale of shares in investment vehicle 1630 can be deposited in a bank account of investment vehicle 1630. Fiat money 1532 can leave depositary entity 1620 for one of the following purposes. Acquisition of assets on asset market 1650, which may include, among others: shares in funds, ETFs, bonds, stocks or any other type of asset suitable for incorporation into investment vehicle 1630. To pay client 1640 the consideration due to him after having transferred all or part of his New Money 1530 units to managing entity 1610. For payment to managing entity 1610 or to external platforms 1660 of a commissions stipulated and which are public knowledge. For the return to client 1640, because this is required, of fiat money 1532 which was deposited in depository entity 1620.

Depositary entity 1620 can include, among others, investment vehicle accounts 1632, which are fiat money accounts that belong to investment vehicle 1630, fiat money client accounts 1643. In some cases, clients 1640 who do not have wallets 1516 or local wallets 1517 of either New Money 1530 or other crypto-currencies 1531 can host them in depositary entity 1620 in wallets of crypto-currencies and New Money form clients 1672. As stated above, there can be implementations in which these wallets may be held in the custody of the managing entity 1614. Client 1640 can also decide that wallets of both New Money 1530 and other crypto-currencies 1531 will be guarded by external platforms 1660.

Client 1640 is the user of New Money 1530. Generally client 1640 can have his fiat money 1532 both in fiat money client accounts 1643 in depository entity 1620 and in other accounts external to depository entity 1620. Client 1640 in addition to having New Money 1530 can own other crypto-currencies 1531. Wallets where the private keys 1518 of New Money 1530 and other crypto-currencies 1531 are stored can be guarded by client 1640 in local wallet 1517 or wallet 1516. Local wallet 1517 can be physical wallet. Wallet 1516 can be a software generated wallet installed in a terminal. Clients 1640 can also choose to use external services to host their wallets. In some implementations these wallets may be hosted in the depository entity 1672, in the managing entity 1614 or on external platforms 1660. Depending on the type of implementation, clients 1640, both when using external wallet hosting services and when using wallets guarded by themselves, can count on passwords 1519 for access to their wallet or wallets.

Investment vehicle 1630 is the equity constituted by the contributions of clients 1640 or the managing entity 1610, which then materializes in whole or in part in the acquisition of assets. Investment vehicle 1630 comprises a pool of assets with a tangible value on asset market 1650 and is subject to normal market fluctuation. Investment vehicle 1630 is managed by professional managers 1611. Investment vehicle 1630 can have one or more investment vehicle accounts 1632 that can be used to temporarily deposit fiat money 1532 or crypto-currency 1531 from clients 1640 who want to acquire New Money 1530 monetary units until such time as they materialize in the purchase of assets to then add them to the investment vehicle 1630.

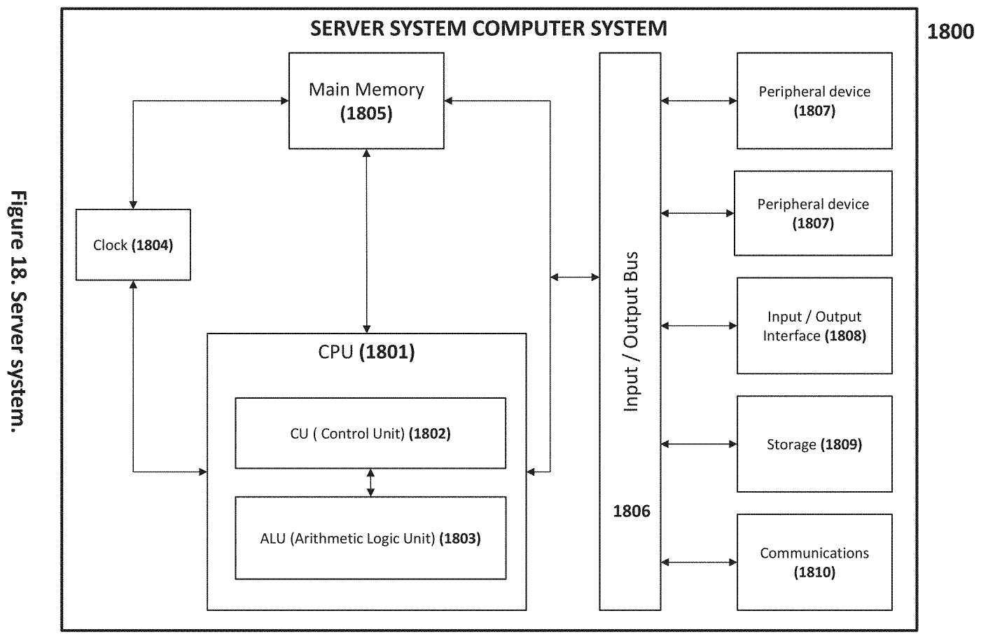

The blockchain network can have different meanings depending on the point of view. For example, central server network 1501, together with clients 1640 and external platforms, can form a blockchain network, understood as a distributed computer system, in which the computer systems of server system 1800 shown in FIG. 18 function as nodes and are responsible for the correct functioning of all network elements, as well as for the distribution of information in the relevant systems.

Blockchain network can refer to a network of blockchains 1756 shown in FIG. 17 in which all the information necessary for the correct functioning of the possible working environment of New Money system 1600 is stored. Generally, blockchain 1756 can be a database stored in each computer system of server system 1800 in which new information is added in a way that relates to the previous information. In this way, managing entity 1610 can update the necessary information in a secure way, preventing old data from being modified by any external attack, and even by managing entity 1610 itself, thus ensuring proper management of all data, such as client accounts or transactions. The entire distributed computer system, as well as the distributed database, is intended to serve as the basis for the operations of New Money 1530 and that in most implementations is materialized in a crypto-currency.

Referring to FIG. 16, external platforms 1660 are entities outside managing entity 1610 which act as intermediaries between clients 1640 and managing entity 1610 and which can offer clients 1640 the same services that managing entity 1610 can offer them. External platforms 1660 can provide clients 1640 with client 1640 registration services, the acquisition and disposal of New Money 1530 units that involve an expansion or reduction of the investment vehicle 1630, the acquisition or disposal of New Money 1530 units in the peer to peer market, generally using, as a counterpart, fiat money 1532 or other crypto-currency 1531, the transfer or reception of money units of New Money 1530 as a counterpart to any type of transaction such as the purchase and sale of goods or services or donations. Asset markets 1650 are the markets where shares of companies, ETF stocks, bonds, fund shares, money, futures, precious metals, real estate and other types of wealth are traded.

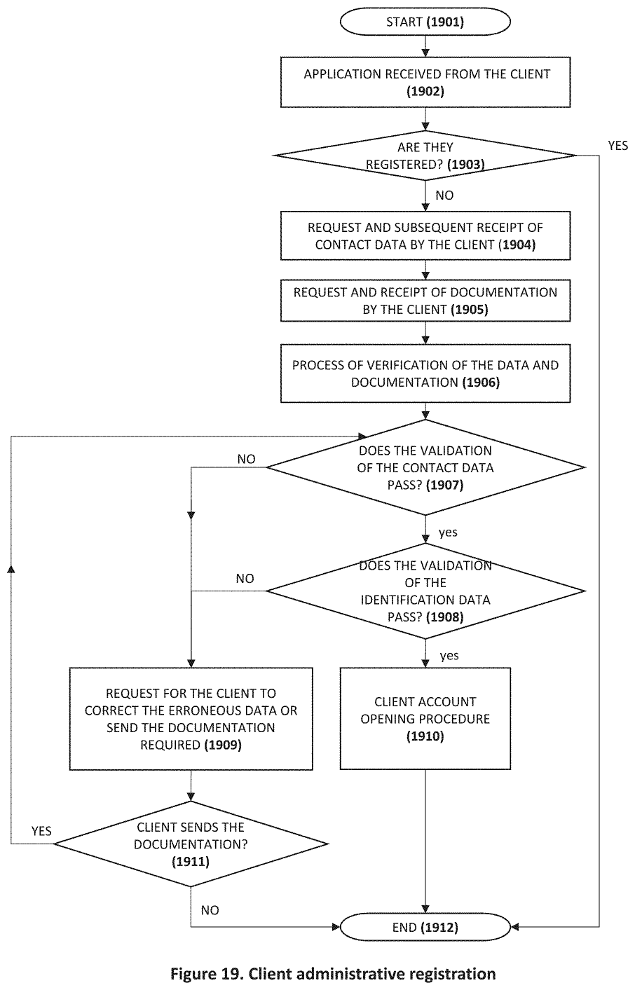

In some implementations, client requests 1644 to managing entity 1610 can be requests and communications that do not involve currency movements, such as the registration of client 1640 in the system (FIG. 19) or a request for tax information. Requests to managing entity 1610 can also be to dispose of or acquire New Money 1530 monetary units. Examples of this type of request are: the acquisition and disposal of units of New Money 1530 involving an extension or reduction of investment vehicle 1630 (FIG. 22), (FIG. 23), the acquisition or sale of New Money 1530 units in the peer to peer market, generally, using as counterpart fiat money 1532 or other 1531 crypto-currencies (FIG. 24), the transfer or receipt of New Money 1530 monetary units in exchange for any type of transaction: purchase and sale of goods or services or donations (FIG. 26). According to some implementations, client requests can also be directed to the management of wallets of crypto-currencies and New Money from clients 1614.

According to some implementations, client 1640 can have fiat money client accounts 1643 1620 and also in some cases wallets of crypto-currencies and New Money 1672 stored in depository entity. Generally, clients 1640 can send requests to depositary entity 1645 related to the management of their fiat money client accounts 1643 or their wallets of crypto-currency other than New Money 1530. (Wallet 1672 in FIG. 16 includes New Money/) Generally, requests related to New Money are channeled through the managing entity 1610.

Monetary flow requests 1648 from clients 1640 to depositary entity 1620 or managing entity 1610 can require a money flow of fiat money 1532 or crypto-currency 1648. Client 1640 can buy New Money 1530 with the balance of fiat money 1532 in fiat money client account 1643 or also with the amount of crypto-currencies 1531 if they are accepted by managing entity 1610. In the event that client 1640 does not have fiat money accounts 1643 with depositary entity 1620, client 1640 must transfer fiat money 1532 or crypto-currency 1531 to investment vehicle accounts 1632 with depositary entity 1620 in the amount necessary to cover the purchase of New Money 1530 money units to be purchased. Client 1640 can also make withdrawals from fiat money client accounts 1643 or from wallets of crypto-currencies and New Money 1672 or from client accounts in crypto-currencies 1531.

New Money flows 1646 are between client 1640, managing entity 1610 and depository entity 1620. Client 1640 besides being the owner of New Money 1530 can also own crypto-currencies 1531. Wallets where private keys 1518 of New Money 1530 and crypto-currencies 1531 are stored can be safeguarded by client 1640 in local wallet 1517 or wallet 1516. Clients 1640 can also choose to use external services to host their wallets. In some implementations these wallets may be hosted in depository entity 1620 in wallets of crypto-currencies and New Money from clients 1672 or by managing entity in wallets of crypto-currencies and New Money from clients 1614 or on external platforms 1660. In any case, as a result of client requests 1644 or requests to depository entity 1645 there can be movement of New Money 1530 between investment vehicle accounts 1632 with New Money flow 1646 or between Managing entity accounts 1612 and client 1640 with New Money flow 1646.

Investment vehicle 1630 can be managed by professional managers 1611. The expertise of professional managers 1611 in management can determine the evolution of the value of investment vehicle 1630, and accordingly the value of New Money 1530 currency unit. Professional managers 1611 can provide a market analysis 1652 of the asset markets 1652. Professional managers can maintain communication with the IT systems of the main market players, analyzing price trends, evaluating buying and selling opportunities to forecast the best conditions for future transactions and establishing short, medium and long term strategies for any product that is stipulated in the investment vocation of investment vehicle 1630 that supports the currency. Professional managers 1611 issue asset purchase orders 1621 in order to expand or reduce the size of investment vehicle 1630 which results in an asset flow 1631 between asset market 1650 and investment vehicle 1630.

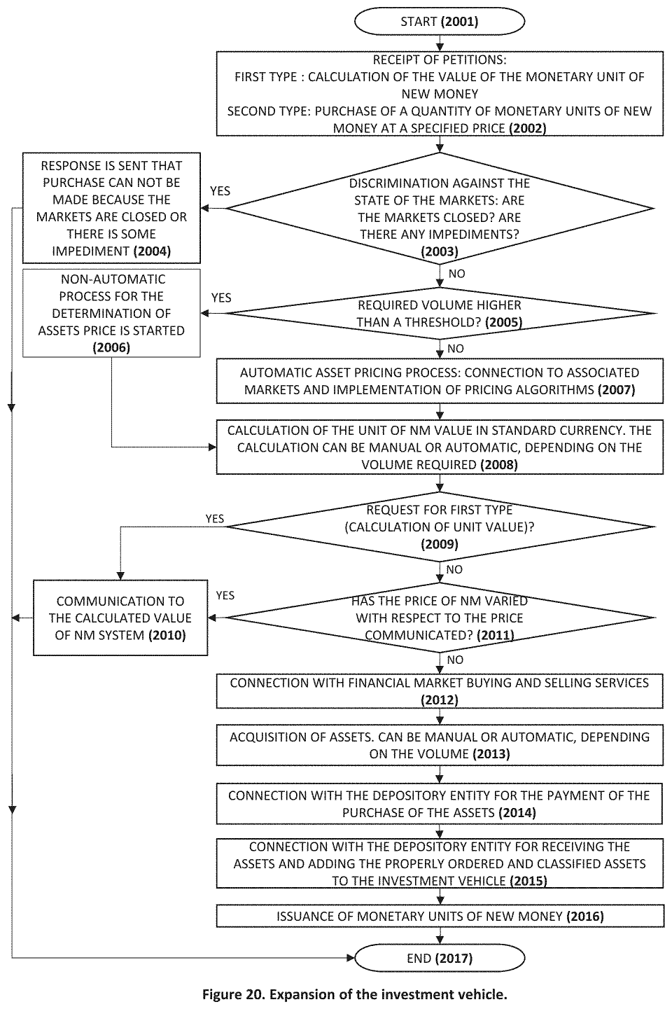

Communication between entities 1615 can be between managing entity 1610 and depository entity 1620. Managing entity 1610 and depositary entity 1620 can send different types of requests related to investment vehicle 1630, fiat money client accounts 1643, managing entity accounts 1619 or investment vehicle accounts 1632. Managing entity 1610 can, for example, request from depositary entity 1620 the updated client account records of fiat money client accounts 1643 with depositary entity 1620. Managing entity 1610 can send depositary entity 1620 instructions relating to the management of fiat money accounts 1643 or client crypto-currency accounts of client 1640, for example, blocking orders before a transaction is made, a certain amount of fiat money, crypto-currency or New Money 1530, to ensure that sufficient funds are available for the transaction. Managing entity 1610 can require depositary entity 1620 to credit or debit an account of client 1640 account with a specified amount of fiat money 1532, crypto-currency 1531 or New Money 1530 in exchange for a purchase or transfer of New Money 1530 or for a certain amount of commission to be paid for a purchase or transfer of New Money 1530 to be charged to an account of client 1640. Managing entity 1610 can communicate to depositary entity 1620 simultaneously an order for the acquisition of assets on asset market 1650 and an order for managing entity 1610 to pay the agreed amount to the seller and to receive and add to investment vehicle 1630 the assets properly organized and classified 2015 as shown in FIG. 20.

Referring to FIG. 16, managing entity 1610 can also notify depositary entity 1620, following an order to dispose of assets on asset market 1650, that it will subtract the assets disposed of from investment vehicle 1630 and deliver them to the purchaser who, in return, will transfer the agreed amount to depositary entity 1620 and depositary entity 1620 will deposit it in the investment vehicle account 1632.

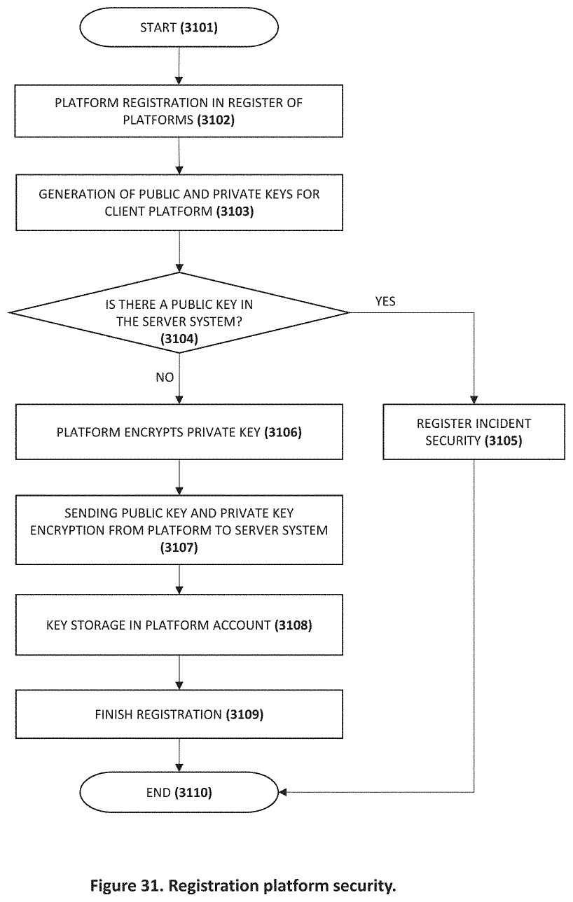

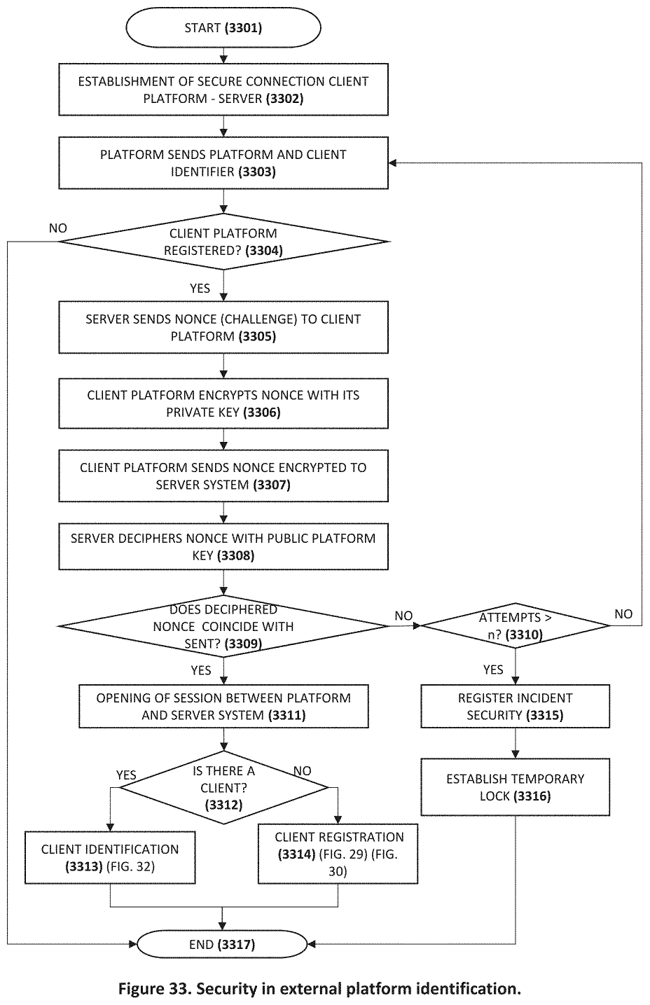

Requests with external platform 1161 can be made between external platforms 1160 and managing entity 1610. External platforms 1660 are entities outside the managing entity 1610 that can channel client 1640 transactions to acquire, dispose of and transfer New Money 1530. Client 1640 can carry out the acquisition, disposal and transfer of New Money 1530 using both the internal platform of managing entity 1610 and external platforms 1660 outside managing entity 1610. The processes for acquiring, disposing of or transferring New Money 1530 will be very similar whether client 1640 uses managing entity 1610 platform or external platforms 1660. Generally, if external platform 1660 wants to offer the services of acquisition, alienation and transfer of New Money 1530 it must first pass an approval process in managing entity 1610 (FIG. 31). Each time external platform 1660 requests access to the system for the acquisition, disposal and transfer of New Money 1530 (FIG. 25) it must pass a security protocol (FIG. 33). As consideration for the intermediation between client 1640 and managing entity 1610, client 1640 can send a request to depository entity 1620 for a payment of fees previously agreed with external platforms 1660.

In certain implementations, client 1640 can make client requests to external platform 1665 which requests are similar to requests client 1640 can make to managing entity 1610. Requests to external platform 1665 can be for example: requests and communications that do not involve monetary movements, such as the registration of client 1640 or a request for tax information. Requests to external platform 1665 can also be made to sell or acquire monetary units of New Money 1530 that involve an expansion or reduction of investment vehicle 1630, the acquisition or sale of monetary units of New Money 1530 in a peer to peer market, for example, using fiat money 1532 or crypto-currencies 1531 as a counterpart, the transfer or receipt of monetary units of New Money 1530 as a counterpart to any type of transaction: purchase and sale of goods or services or donations (FIG. 26).

As an illustrative example, client 1640 issues a request to managing entity 1610 for the acquisition of New Money 1644 (FIG. 22). Client 1640 transfers to fiat money client account 1643 at depository entity 1620 the amount necessary to cover the acquisition of New Money 1530. Depositary entity 1620 holds fiat money 1532 delivered by client 1640 until client 1640 invests in the purchase of shares of funds, ETFs, bonds, shares or any other relevant asset type in order to add them to investment vehicle 1630. Professional managers 1611 of investment vehicle 1630 decide how to invest fiat money 1532 delivered by client 1640 by purchasing an optimum product on asset market 1650 within the range of possibilities stipulated in an investment vocation of investment vehicle 1630 that supports monetary units of New Money (FIG. 20). Managing entity 1610 generates monetary units of New Money 1530 units and transfers them to New Money account 1642.

FIG. 17 is a schematic diagram that illustrates and embodiment of systems implemented by central server network 1501 of managing entity 1610. Central server network systems 1700 can be implemented through central server network 1501 as a whole, and in certain cases there can be an implementation of each system, such as for example external interface 1705, in server system computer system 1800 as shown in FIG. 18. Referring to FIG. 17, central server network systems 1700 can include processor 1701, memory 1702, external interface 1705, depository entity engine 1715, currency market monitoring engine 1720, external platforms engine 1725, monetary unit manager 1730, transactions and calculations engine 1735, internal exchange platform 1740, investment vehicle management unit 1745, client manager unit 1750, blockchain network engine 1755 and security engine 1760. The systems included can vary according to the type of implementation, and although the present invention is described following several implementations, a myriad of changes, new systems, variations or alterations of the systems described, transformations or modifications may be suggested by an expert in the field and it is intended that the systems of the present invention include such changes, variations, alterations, transformations and modifications to the extent that they are included in the claims accompanying this document.

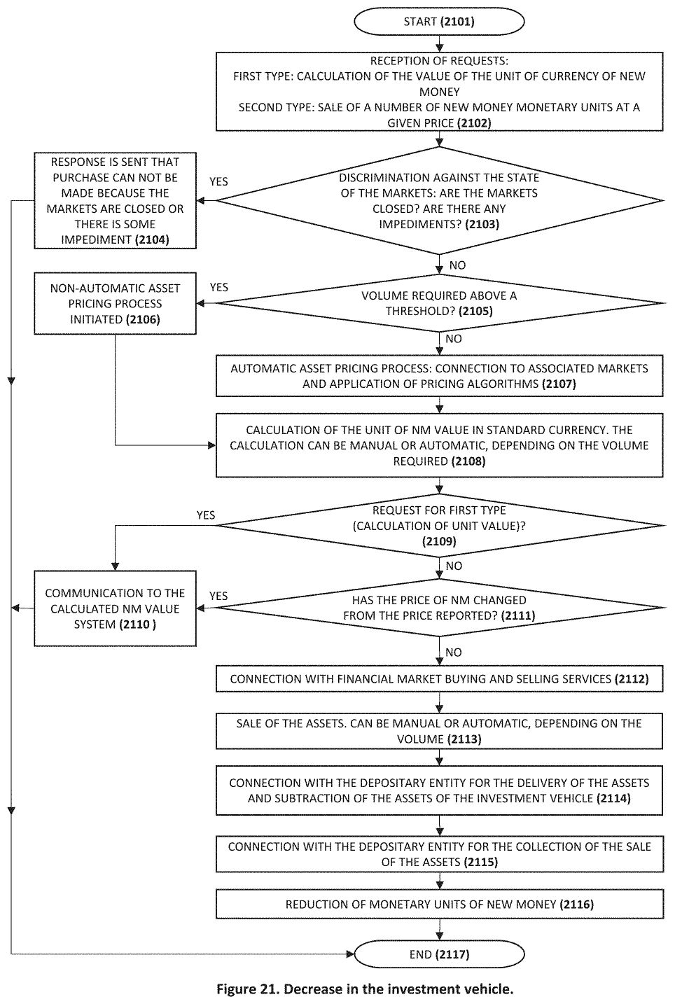

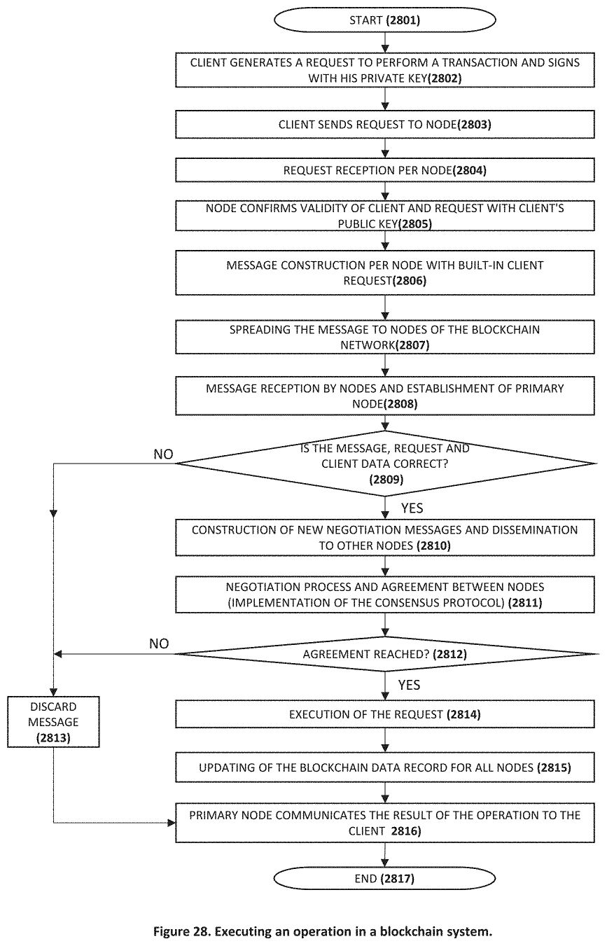

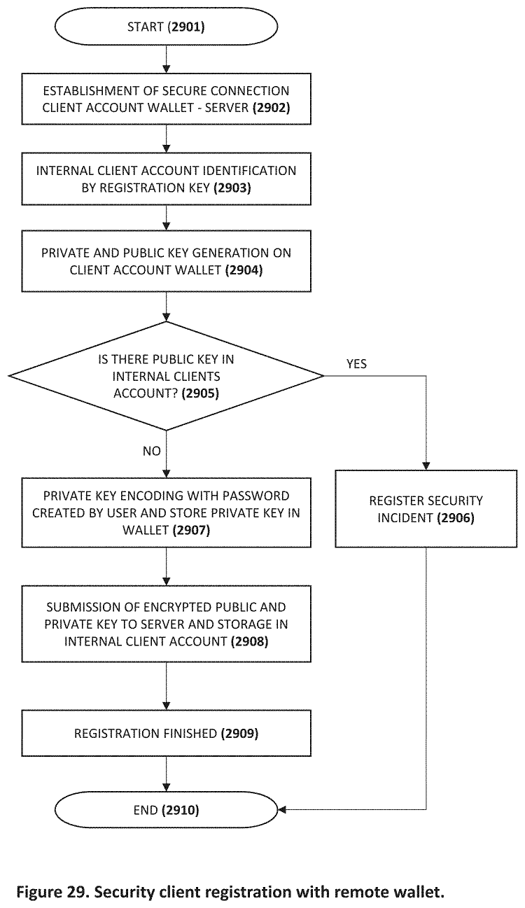

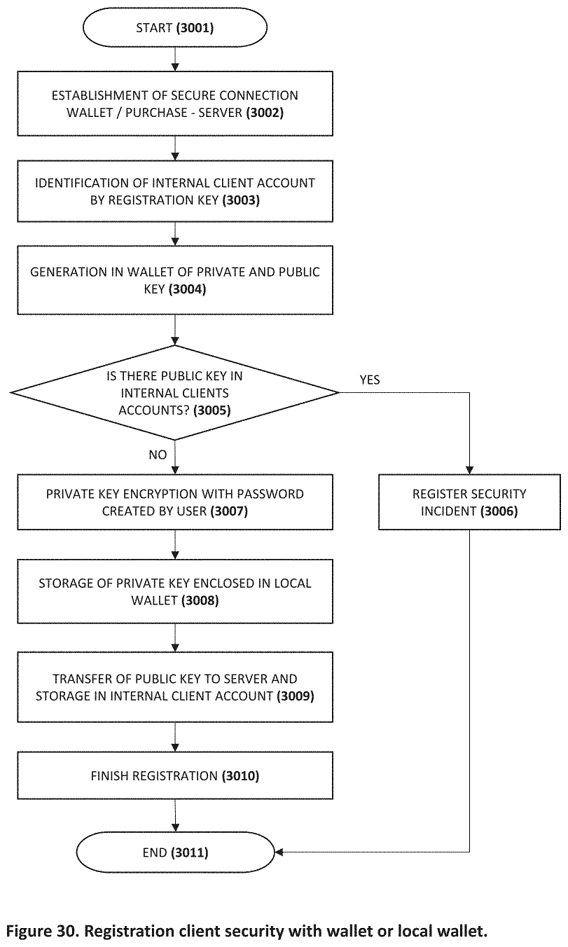

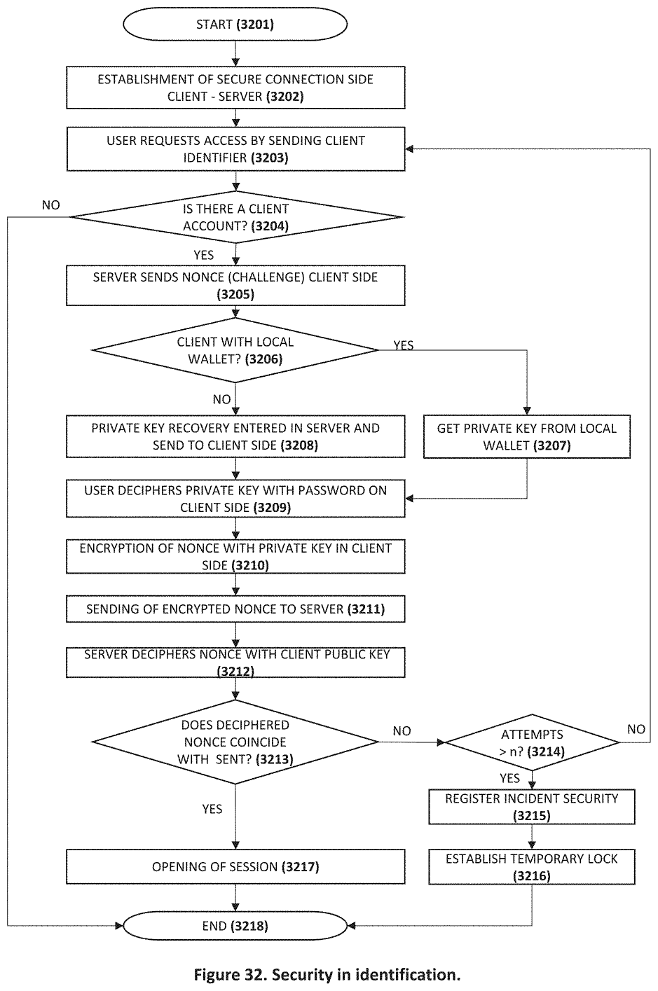

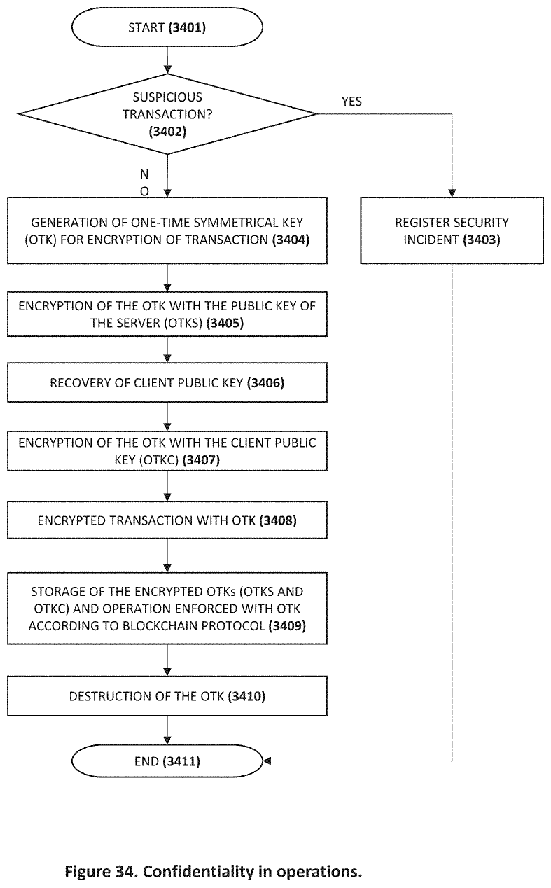

In one embodiment, processor 1701 can include one or more microprocessors, drivers or other computing devices or resources suitable for use in the present invention. Processor 1701 can work, either alone or in combination with other processors in a centralized or distributed environment or a combination of both with components of the environment, such as a plurality of external electronic terminals 1510 as shown in FIG. 15, to provide a subset or the full functionality of New Money system 1600 shown in FIG. 16, such as, but not limited to, administrative registration of clients (FIG. 19), expansion of investment vehicle 1630 (FIG. 20), decrease of investment vehicle 1630 (FIG. 21), purchase of New Money 1530 from managing entity 1610 (FIG. 22), sale of New Money 1530 to managing entity 1610 (FIG. 23), peer-to-peer currency exchange via internal exchange platform 1740 (FIG. 23), and the use of the internal exchange platform 1740 (FIG. 24), communication with external platforms 1660 (FIG. 25), peer to peer New Money 1530 transfers through an internal platform (FIG. 26), peer to peer New Money 1530 transfers through external platforms 1660 (FIG. 27), execution of operations in a blockchain system (FIG. 28), security in registration of client 1640 with a remote coin mechanism (FIG. 29), security when registering client 1640 with wallet 1516 or local wallet 1517 (FIG. 30), security when registering external platform 1660 (FIG. 31), security when identifying client 1640 (FIG. 32), security when identifying external platform 1660 (FIG. 33) or confidentiality during operations (FIG. 34). These functionalities are described without limitation, being able to perform any other task that may be necessary for the proper functioning of a working environment of New Money system 1600.

Referring to FIG. 17, in one embodiment, processor 1701 can communicate with memory 1702. Memory 1702 can take the form of volatile or non-volatile memory including, without limitation, magnetic media, optical media, RAM, ROM, removable media, or any other suitable memory component. Memory 1702 can be internal or external to processor 1701 and can include one or more instruction caches or one or more data caches. Instructions in instruction caches can be copies of instructions in memory 1702, and instruction caches can speed up the retrieval of those instructions by processor 1701. Data in caches can include any appropriate combination of data copies in memory 1702 such as instructions that are executed in processor 1701, results of previous instructions executed in processor 1701 necessary to access subsequent instructions that are executed in processor 1701, or to write to memory 1702 or other appropriate data. Data caches can speed up read or write operations per processor 1701.

A multitude of data can be stored in memory 1702, such as, but not limited to, data from requests managed by external interface 1705, temporary changes in exchange rates 1532 and crypto-currencies 1531 created by the currency market monitoring engine 1720, transaction logs edited by blockchain network engine 1755, security logs maintained by security engine 1760, New Money accounts 1642, as well as any other data necessary for the proper functioning of this implementation. Information can be stored in one or more files, tables in a relational database, distributed database with or without blockchain structure or any other suitable data structure capable of storing information. In one embodiment, implementation of the data storage structure is blockchain 1756, which can be any other structure with similar or different characteristics that fulfills the same task, which is none other than the correct storage, organization, classification and security of all information.

External interface 1705 of central server network systems 1700 can be used as an element for external communication of systems 1700. Generally, external interface 1705 uses processor 1701 and memory 1702 for external communications. External interface 1705 can be any software, hardware, firmware or combination thereof capable of communicating with external electronic terminals 1510. In some implementations, external interface can be a set of instructions stored in memory 1702 that can be executed by processor 1701. External interface 1705 can receive requests 1644 for client 1640, shown in FIG. 16, to log in with the system, as well as request and subsequent receipt of contact data 1904 and request and receipt of documentation by the client 1905, shown in FIG. 19, from client 1640. In the case of erroneous data received, external interface 1705 can send messages, requests and requests to client 1640 to request for the client to correct the erroneous data or send the documentation required 1909. External interface 1705 can also manage the connection with financial market buying and selling services 2012 and connection with financial market buying and selling services 2112, the connection with the depository entity for the payment of the purchase of the assets 2014 and the connection with the depositary entity for the delivery of the assets and subtraction of the assets of the investment vehicle 2114 or requests for New Money application made by the client 2203, shown in FIGS. 20-23, of New Money 1530. In a normal operation external interface 1705 can receive from client 1640 the selection of currency 1532 or crypto-currency 1531 to employ 2207 for the purchase of New Money 1530 and later, after receiving the necessary information from transactions and calculations engine 1735, the amount of fiat money 1532 or crypto-currency 1531 to be delivered as consideration 2213 of New Money 1530 can be communicated to client 1640. External interface 1705, in case of receiving a communication that client 1640 does not have enough money in 1643 account of 1620 custodian or in another type of external account, requires client 1640 to send a 2215 transfer, while in the event that client 1640 does not have in fiat money client account 1643 with depositary entity 1620, he or she is required to make a transfer directly to investment vehicle account 1632 with depositary entity 1620. External interface 1705 can send the request to client 1640 of a confirmation of a client order purchase 2216 in case of a decision of client having enough funds on a balance sheet 2214 as shown in FIG. 22.

Referring to FIG. 17 External interface 1705 can receive a New Money 1530 application made by a client 2303 as shown in FIG. 23. External interface 1705 can receive from client 1640 the selection of currency 1532 or crypto-currency 1531 to be used 2307. In the event that client 1640 does not have sufficient funds in his or her account 1642, client manager unit 1750 can send client 1640 a notice of insufficient funds via external interface 1705 and requires client 1640 to send a transfer 2309. Subsequently, after receiving the information from the transactions and calculations engine 1735, external interface 1705 generally communicates to client 1640 the amount of fiat money 1532 or crypto-currency 1531 that is given to it as consideration for New Money 1530 in a communication of amount 2315. External interface 1705 in case client 1640 orders the purchase sends the order to the transactions and calculations engine 1735.

External interface 1705 can receive requests for entry to the system 2403 from a client 1640 as shown in FIG. 24. External interface 1705 can receive an offer from a client 1640 to buy fiat money 1532 or crypto-currency 1531 to buy New Money 1530 as counterparty or vice versa 2405. External interface 1705 takes the information to transactions and calculations engine 1735 and can receive a reply if the balance on client account 1751 is sufficient to perform the operation as shown in FIG. 17. In case of a decision of is the account balance sufficient 2409 that there is an insufficient balance to make the purchase requires client 1640 a transfer New Money 1530 (sale of New Money) or fiat money 1532 or crypto-currencies 1531 (purchase of New Money) 2410.

External interface 1705 can receive request with external platform 1661 shown in FIG. 16 to use the services of the central server network systems 1700. Generally, external interface 1705 transfers the request to the security engine 1760 to be analyzed according to parameters such as physical addresses, IP addresses, digital signatures or any other type of data necessary to certify the security of the request. External interface 1705 can send a request to external platform engine 1725 to check the data 2503 concerning an external platform 1660 normally by accessing databases that can for example relational, centralized, distributed, with or without blockchain structure and generally using the services of the blockchain network engine 1755. Depending on the materialization of the system, external interface 1705 or external platform engine 1725 can send to the security engine 1760 the data necessary for the verification of the security aspects 2504 of an external platform 1660.

External interface 1705 can receive data 2506 from one or more clients 1640 involved in a New Money 1530 acquisition or transfer transaction and then transfer the necessary 2507 information to client manager unit 1750 that verifies the administrative status of client 1640.

In the most common implementations, external interface 1705 can receive a request to enter the system 2602 shown in FIG. 26 from client 1640, for example and without limitation, through an electronic payment service, internet platform or credit cards. Security engine 1760 together with client manager unit 1750 authorizes or denies the validity of client 1640. If client 1640 is rejected, external interface 1705 can inform client 1640. External interface 1705 can receive from client 1640 New Money 1530 transfer order 2605 to another client 1640, external interface 1705 can transfer the order to calculations and transactions engine 1735. In the event it is determined in does client have sufficient balance in account 2610 that client 1640 does not have enough balance, transaction and calculations engine 1735 can inform client 1640 via external interface 1705 that the order is rejected and the client is informed 2611. In the event it is determined in does client have sufficient balance in account 2610 the client 1640 has a sufficient balance, transactions and calculations engine 1735 can inform external interface 1705 that client 1640 has enough balance in a balance sheet to perform the operation and external interface 1705 sends client 1640 can communicate the amount as a request to the client to accept the transaction 2612. If client 1640 accepts the transaction, external interface 1705 communicates the transaction to calculations and transactions engine 1735.

Referring to FIGS. 16, 17 and 27, External interface 1705 can receive requests from external platforms 1661 which may come from for example, but not limited to, electronic payment services, internet platforms, credit cards or any other type of external platform 1660 for peer to peer transfer. External interface 1705 can receive from security engine 1760 or external platforms engine 1725 external platform verification 2703 of and request from external platform 1660 can send data to a first and second client 2704. In some cases, external interface 1705 sends client 1640 data to client manager unit 1750 and can be authorized by security engine 1760 or client manager unit 1750. External interface 1705 can receive from external platform 1660 New Money 1530 transfer order between client1 1640 and client2 1640. External interface 1705 can receive notification from transactions and calculations engine 1735 of does client have enough in his balance sheet 2710. In the case that there is insufficient funds, external interface 1705 can send client1 1640 a notification that that the order is rejected and the client is informed 2711. In the event it is determined in does client have sufficient balance in account 2710 that client 1640 has a sufficient balance, transactions and calculations engine 1735 sends a communication of the final amount to the external platform 2712. Transactions and calculations engine 1735 can inform external interface 1705 that client1 1640 does have enough balance in a balance sheet to perform the operation 2710. In this case, external interface 1705 prompts client1 1640 to confirm operation 2713. If client1 1640 accepts the operation via external platform 1660, external interface 1705 communicates this to transactions and calculations engine 1735.

Referring to FIGS. 15-18 and 28, in some implementations, external interface 1705 can receive requests, following the previously defined protocols, from client 1640 or external platform 1660 to perform a request to perform a transaction and sign in with a private key 2802. In general, external interface 1705 can transfer a request to confirm validity of a client and request with clients public key 2805 from client 1640 or external platform 1660 to security engine 1760 on relevant server system 1800 to, for example, check the request format, applicant addresses, client 1640 public key or any other element necessary to ensure security. External interface 1705 can also send request 2805 to the implementation of client manager unit 1750 or external platforms engine 1725 on relevant server system 1800 which, depending on certain implementations, can perform client 1640 security checks or external platforms 1660, typically related to the public key 1518, identification data or contact data. Depending on the implementation of external interface 1705, the result of the execution of a request is communicated to the client 2816 or external platform 1660.

Referring to FIGS. 15-18 and 29, external interface 1705 can receive a request for the establishment of secure connection 2902 over 1511 through a public network between user system 1514 belonging to a client 1640 and the central server network 1501, usually with a particular server system 1800 computer system. Once client 1640 has obtained the private key 1518 encrypted with a password 1519 known only to client 1640 and not stored on any of the systems, external interface 1705 can receive the public key 1518 and the private key 1518, encrypted 2908, from client 1640.

Referring to FIGS. 15-18 and 30, external interface 1705 can initiate the establishment of a secure 3002 connection 1511 through a public network between user system 1514 belonging to client 1640 and server system 1800. In one embodiment, connection 1511 employs communications security protocols that guarantee the identity of user system 1514 and server system 1800, the confidentiality, the integrity of the information exchanged between both parties and the non-repudiation at origin and destination. External interface 1705 can also receive public key 1518 from user 1520 which is stored by server system 1800 in client account 3009 for later use in various operations related to process security for that client 1640.

Referring to FIGS. 15-18 and 31, in certain embodiments, once connection 1511 is established as secure between user system 1514 and server system 1800, external interface 1705 can receive an asymmetric pair of keys 1518, public and private from generation of public and private keys for client platform 3103, which are normally generated by user system 1514 from external platform 1660, and which allow user system 1514 to be identified by the server system 1800 in subsequent operations. External interface 1705 can also receive the encrypted private key 1518 from user system 1514 and then send it to the server system 1800 along with the public key 3107. Both keys 1518 are stored by server system 1800 in external platform account 1642 in key storage in platform account 3108. Finally, server system 1800, via external interface 1705, returns to user system 1514 of external platform 1660 a confirmation that account 1642 has been successfully created.

Referring to FIGS. 15-19 and 32, external interface 1705 can initiate the establishment of secure connection side client server 3202 over connection 1511 over a public network between user system 1514 of client 1640 and central server network 1501. Depending on the type of implementation, connection 1511 can be made with one or more particular server systems 1800. In some embodiments, connection 1511 employs communications security protocols that guarantee the identity of user system 1514 and server system 1800, confidentiality, integrity of the information exchanged between both parties, and non-repudiation at origin and destination. Once external interface 1705 has established secure connection 1511 with client 1640, it can receive an access request from client using a user identifier 1521, which coincides with the identifier defined in client registration administrative process (FIG. 19).

According to some embodiments external interface 1705, when there is a client 1642 account with expected identifier 1521, can send user system 1514 a confirmation of the establishment of the session. External interface 1705 can also send user system a random single-use value such as a nonce 3205, normally generated by the implementation of client manager unit 1750 in relevant server system 1800, which serves as a challenge for the authentication process and makes it difficult to replay attacks.

If user system 1514 has wallet 1516 or local wallet 1517, user system 1514 can get private key from local wallet 3207 and encrypted key 1518 from wallet 1516 or local wallet 1517 and asks client 1640 for password 1519 in user deciphers private key with password on client side 3208 to decrypt it. If the decryption is correct, encryption unit 1515 can proceed to encrypt nonce in client side 3210 with the obtained private key 1518 and then send it to external interface 1705. If user system 1514 does not have a wallet 1516 or a local wallet 1517, server system 1800 can locate encrypted private key 1518 in client 1642 account and send it to user system 1514 via external interface 1705 by preloading client software onto the local system. Once encrypted private key 1518 has been received, user system processor 1512 generally asks client 1640 for password 1519 to decrypt the same encrypted private key 1518 and proceed to encrypt nonce 3211 with it and then send nonce encryption 3211 to external interface 1705.

External interface 1705 can initiate the establishment of a secure 3302 connection 1511 through a public network between user system 1514 of external platform 1660 and the central server network 1501. Depending on the type of materialization, connection 1511 can be made with one or more private server systems 1800. In the most common implementations, connection 1511 employs communications security protocols that can guarantee confidentiality, integrity of information exchanged between both parties and non-repudiation at origin and destination. Once external interface 1705 has established a secure connection 1511 with client 1640 of external platform 1660, it can receive a request for access to server system 1800, which normally includes a client identifier 1521 and an external platform identifier 1521.

Referring to FIGS. 15-19 and 33, external interface 1705 can send external platform 1660 a one-time random value, generated by server system 1800, for example, a nonce, which can serve as a challenge to the authentication process of external platform 1660 that makes it difficult for attacks known as replaying. Server system can send nonce to the client platform 3305 to user system 1514 of external platform 1660 via external interface 1705. Depending on type of implementation, user system 1514 can access private key 1518 either directly if it is stored in a wallet 1516 or local wallet 1517 or through server system 1800 which can retrieve private key 1518 from external platform account 1642. Once private key 1518 is known, user system 1514 can encrypt nonce 3306 and client platform sends nonce encrypted to server system 3307 with external interface 1705.

Referring to FIGS. 15-18 and 20, central server network systems 1700 can include depository entity engine 1715. In general, depository entity engine 1715 can receive or send requests to depository entity 1620.

In some implementations, depository entity engine 1715 can store, in memory 1702, request data managed by external interface 1705 along with other devices. Data can include, for example, periods of opening and closing of depository entity 1620, security protocols required for the transmission of data between depository entity 1620 and central server network 1501, updated records of client New Money accounts 1642 and fiat money client accounts 1643 in depositary entity 1620, temporary variations of asset reserves in the investment vehicle accounts 1632, as well as any data necessary for the proper functioning of the present invention. In certain implementations, some or all of the data handled by the depository entity engine 1715 can be stored in memory 1702 in the form of a relational database, distributed database with or without a blockchain structure, or any other suitable data structure capable of storing information. For example, in certain embodiments of the present invention, depository entity engine 1715 sends certain information through the links to blockchain network engine 1755 that can manage storage in the form of blockchain 1756.

Depositary entity engine 1715 generally manages and analyzes communications 1615 with 1620 depositary entity, and is also responsible for generating new requests normally addressed to depositary entity 1620 and transmitting them through external interface 1705. In general, depository entity engine 1715 can handle the acquisition of assets 2013 through depository entity 1620. Depositary entity engine 1715 can communicate with currency market monitoring engine 1720 to see if the acquisition of assets should be done automatically, manually or a combination of both. Depositary entity engine 1715 can also facilitate the connection to depositary entity 1620 to make the payment for purchase of assets 2014, for example, this transfer can be made directly by depositary entity 1620 from investment vehicle accounts 1632, or the assets in the accounts of the investment vehicle accounts 1632 can be transferred to an intermediate account specifically associated with asset market 1650, or an authorization can be required from managing entity 1610 to move the assets between several accounts. Generally, depositary entity engine 1715 communicates the mode of operation to calculations and transactions engine 1735 and security engine 1760, which can validate the mode of operation.

In some implementations, depository entity engine 1715 can manage the connection and communication 1615 with depository entity 1620 for the reception of assets and aggregation of assets to investment vehicle 1630 properly sorted and classified 2015. For example, depository entity engine 1715 can connect to the investment vehicle management unit 1745 and communicate that the assets are ready to be added to investment vehicle 1630. In addition, depository entity engine 1715 can communicate with blockchain network engine 1755 to update the status of investment vehicle 1630 in the relevant registries, usually in the form of a blockchain 1756, or any other necessary information. In some cases, depositary entity engine 1715 may give the order to unit manager 1730 to issue New Money 1530.

Referring to FIGS. 15-18 and 21, depository entity engine 1715 can connect to depository entity 1620 entity via external interface 1705 to for the delivery of the assets and the subtraction of the assets of the investment vehicle 2114. Generally, after the sale of the assets, depository entity engine 1715 exchanges information with investment vehicle management unit 1745, for example, it can transmit information on whether the transaction has been successful in whole or in part, which series of assets have been transferred to asset market 1650 or any other data necessary for the assets to be subtracted from investment vehicle 1630. In response to the subtraction of assets, depository entity engine 1715 can require depository entity 1620 to charge the sale of assets 2115 to an account or series of accounts recognized by managing entity 1610, such as accounts belonging to investment vehicle accounts 1632, intermediate accounts associated with asset market 1650, or any implementation that can perform the task. In certain cases, depository entity engine 1715 can check that the collection transaction for sale of assets 2115 is correct. In some materializations of the central server network systems 1700, depository entity engine 1715 can communicate to the monetary unit manager 1730 and blockchain network engine 1755 the status of asset 2114 subtraction and collection of assets 2115.

Referring to FIGS. 15-17, 22 and 23, in certain embodiments, depositary entity engine 1715 can receive commands from the calculations and transactions engine 1735 to see if a client has sufficient balance 2214 in a given account 1643. Depository entity engine 1715 can communicate with depository entity 1620 for client account 1643 status. In some implementations, depository entity engine 1715 can discern between the type of client account, depending on whether they are internal to depository entity 1620, external, or based on other parameters. Typically, depository entity engine 1715 communicates to the calculations and transactions engine 1735 the response received from depository entity 1620.

In the most common implementations, depository entity engine 1715 exchanges a series of instructions related to management of client New Money account 1642 and client fiat money account 1643 with depository entity 1620. This set of instructions includes, but is not limited to, transactions in a client's fiat money or crypto-currency account 2220, 2323 in which a certain amount is credited or debited which is generally calculated by the transactions and calculations engine 1735, credits of amounts to account(s) 1613, 1619, 1642 that are relevant 2221, 2321, 2416, 2616 of the managing entity 1610 usually for collection of management fees, credits or debits of amounts to account(s) 1632 of investment vehicle 2222, 2322 for the updating of available assets, transactions with New Money 1530 as counterpart 2223, 2320, 2614, 2615 in a client's account 1642, 1643 or retentions 2411, 2613 of a certain amount of fiat money 1532, crypto-currency 1531 or New Money 1530, normally as a pre-trading operation. client 1640 can make an offer to buy New Money 1530, crypto-currency 1531 or fiat money 1532, and before the transaction is carried out, the amount that will be the counterparty can be blocked to guarantee its existence.

In certain embodiments, depository entity engine 1715 can be implemented as a set of instructions stored in memory 1702 that can be executed by processor 1701. In addition, depository entity engine 1715 can follow a set of instructions stored in memory 1702 that can be executed by processor 1701.

Central server network systems 1700 of New Money 1530 can also include a currency market monitoring engine 1720. In certain implementations, the currency market monitoring engine 1720 can store in the memory 1702 request data managed by external interface 1705 along with other devices. These data can be for example opening and closing periods of the asset markets 1650, tables and text documents with descriptions of asset markets 1650, security required for data transmission with the depositary entity 1620, as well as any data necessary for the proper functioning of the present implementation.

In general, the currency market monitoring engine 1720 follows market rates to determine the market rate of the currencies 1531, 1532 requested by client 1640 in the process of purchasing New Money 1530 from the managing entity 1610. For example, the currency market monitoring engine 1720 can initiate a process in which it sends requests to the markets previously selected by the system for the exchange rate of fiat money 1532 or crypto-currency 1531, if applicable, against the standard currency used by managing entity 1610. Once the answer is obtained, the currency market monitoring engine 1720 sends the information to calculations and transactions engine 1735.

In one embodiment, currency market monitoring engine 1720 follows the market rates to determine a currency market rate requested by client 1640 when selling New Money 1530 to managing entity 1610. For example, currency market monitoring engine 1720 can initiate a process in which it demands information from individual markets about the rate of exchange of fiat money 1532 or crypto-currency 1531, if any, against the standard currency used by managing entity 1610. Once the response is received, currency market monitoring engine 1720 sends the necessary information to calculations and transactions engine 1735 to perform the conversion required to provide client 1640 information.

More specifically, currency market monitoring engine 1720 can be any software, hardware, firmware or combination of these capable of interacting, communicating, tracking and storing currency market information to obtain required fiat money 1532 and crypto-currency 1531 quote information. According to some materializations currency market monitoring engine 1720 can be a set of instructions stored in memory 1702 that can be executed by processor 1701.

Referring to FIGS. 15-18, 20 and 24, central server network systems 1700 can also include an external platforms engine 1725. In general, external platforms engine 1725 can perform all operations between external platforms 1660 and managing entity 1610.

External platforms engine 1725 generally communicates and interacts with external platforms 1660 through external interface 1705. External platforms engine 1725 can store in memory 1702 the available data of external platforms 1660 that are necessary for the correct operation of system 1600. This data can be for example a list of external system client types, commission settlements agreed between platforms, security protocols required for data transmission between external platforms 1660 and central server network 1501 of New Money 1530 system, updated records of external client accounts on external platforms 1660, tables with the exchange rate offered by the platforms and the relation with respect to the exchange rate in internal exchange platform 1740, temporary variations of the exchange rate, as well as any information necessary for the correct functioning of the present invention in any of its possible implementations.

Normally, external platforms engine 1725 can exchange information with external platforms 1660 adapting to the type of format supported by external platforms 1660. Thus, external platforms engine 1725 can maintain an up-to-date list in the form of any suitable data structure capable of storing information in the format of the data exchanged with each external entity 1660. In general, external platforms engine 1725 can collect any type of information in known formats and update it with the help of processor 1701 to generate data readable by internal systems. In addition, external platforms engine 1725 can collect data, commands, instructions or any type of information structure from the internal systems of the server system 1800 and adapt them for communications with external platforms 1660 via external interface 1705.

In certain embodiments, some or all of the data handled by external platforms engine 1725 can be stored in memory 1702 in the form of a relational database, distributed database with or without a blockchain structure or any other suitable data structure capable of storing information. For example, systems 1700, external platforms engine 1725 can send relevant information via links to blockchain network engine 1755 that manages storage, typically in the form of a blockchain 1756.

External platforms engine 1725 generally manages and analyzes communications with external platforms 1660, as well as being the decision maker according to a set of rules. External platforms engine 1725 can generate new requests and transmit them via external interface 1705. In certain implementations, external platforms engine 1725 can follow a set of instructions stored in memory 1702 that can be executed by processor 1701, and external platforms engine 1725 can also materialize as a set of instructions that can be executed by processor 1701. In certain implementations, external platforms engine 1725 can receive instructions from client manager unit 1750. For example, client manager unit 1750 can require that external platforms engine 1725 be able to connect to a reliable authentication service. In general, external platforms engine 1725 can transfer the information obtained from the authentication service to client manager unit 1750.

Referring to FIGS. 15-18, 20, 22 and 24, external platforms engine 1725 can also be used as a means of non-automatically determining the prices of certain assets, 2006, 2106. For example, and without limitation, when the required volume of New Money 1530, crypto-currency 1531 or fiat money 1532 is greater than a threshold of 2005, 2105, and one or more automatic asset price discovery processes cannot be initiated in 2007, 2107, in certain implementations external platforms engine 1725 initiates a non-automatic asset pricing process 2066, 2106 in which it can collect information from different asset pricing platforms 1660 and store it in memory 1702. External platforms engine 1725 can receive instructions from investment vehicle management unit 1745 to initiate the process described above. Generally, external platforms engine 1725 can also communicate with investment vehicle management unit 1745 to, for example, transfer the results of non-automatic asset pricing process 2006, 2016

In some embodiments, external platforms engine 1725 can collect and send information on the status of clients' external accounts. Normally, external platform engine can communicate with calculations and transactions engine 1735, client manager unit 1750 or blockchain network engine 1755 when performing this type of operation. For example, if the system needs to know the status of a client's external account, calculations and transactions engine 1735 can require from client manager unit 1750 account data of client, which in turn can communicate the status of the particular account to blockchain network engine 1755, If, for example, the account status is out of date, client manager unit 1750 can instruct external platforms engine 1725 to obtain the necessary information from the relevant external platform 1660. In turn, external platforms engine 1725 can transfer information directly to the blockchain network engine 1755, client manager unit 1750 or the calculations and transactions engine 1735. In certain implementations, the transactions and calculations engine 1735 can warn client 1640 that the transaction has been rejected and a transfer or acquisition of fiat money or crypto-currency 2215, 2410 is required, this requirement can be sent from external platforms engine 1725 for external platform 1660 to communicate to client 1640.

External platforms engine 1725 can receive incoming requests from external entities 2502, and in general external platforms engine 1725 sends information from external platforms 1660 to the security engine 1760 and receives the data needed to certify whether an external platform 1660 is secure. By way of example, a process carried out with an external platform 1660 can include initial communication with external platform 1660, security management, exchange of client data with the managing entity 1610 for any transaction, management of client security, communication of the transaction or information from external platform 1660, processing of the transaction and communication of the result or other data with external platform 1660. In general, external platforms engine 1725 can process the type of request received and determine to which internal element of system 1700 to transfer it to. For example, if external platforms engine 1725 receives a New Money 1530 purchase request from an external platform 1660, it can interpret, rewrite, and move a new readable request to calculations and transactions engine 1735.

External platforms engine 1725 can require blockchain network engine 1755 to register 3102 an external platform 1660 in the system, usually by opening a new account 1642. External platforms engine 1725 can generate an identifier 1521 for external platform engine 1725. Generally, external platforms engine 1725 keeps a list of identifiers 1521 of different external platforms 1660. External platforms engine 1725 can ask blockchain network engine 1755 to check 3104 the duplicity of a public key 1518 related to an external platform 1660. In a case where the pair of keys 1518 generated are valid, external platforms engine 1725 may require blockchain network engine 1755 to store 3108 the keys 1518, typically a public key 1518 and an encrypted private key 1518, in the corresponding account 1642 on external platform 1660.

External platforms engine 1725 can receive 3303 from an external platform engine 1725, through external interface 1705, identifiers 1521 from an external platform 1660 that wants to perform an operation and from clients 1640 that use external platform 1660. Once the identifiers 1521 have been received, in a common operation external platforms engine 1725 can send the identifier 1521 of external platform 1660 to blockchain network engine 1755 to check if external platform 1660 is registered 3304. In some implementations, external platforms engine 1725 can generate a nonce 3305 for the identification process and send it to external platform 1660 via external interface 1705. External platforms engine 1725 can receive the nonce 3307 encryption from external platform 1660. Normally, external platforms engine 1725 sends the nonce encryption along with the public key 1518 of external platform 1660 to the security engine 1760 for decryption 3308. Security engine 1760 generally transfers the nonce decryption to external platforms engine 1725 which can check whether the decryption result matches the initial nonce 3309. If so, external platforms engine 1725 can establish a secure 3311 session with external platform 1660. In certain implementations, external platforms engine 1725 can move client 1640 identifiers sent previously by external platform 1660 to client manager unit 1750.

In one embodiment, external platforms engine 1725 can maintain any suitable data structure capable of storing information on commissions agreed with various external platforms 1660. External platforms engine 1725 can update the data using blockchain network engine 1755.

In a variety of transactions, the managing entity 1610 may give or receive commissions from external platforms 1660. Payment of these fees can be made through another external platform such as a bank, savings bank, stock exchange, crypto-currency 1531 or any other agreed means. Generally, external platforms engine 1725 is in charge of managing these payments, previously informing the calculations and transactions engine 1735.

Monetary unit manager 1730 can also be included among the systems of the central server network systems 1700. In certain implementations, monetary unit manager 1730 can store in memory 1702 the data reported by the calculations and transactions engine 1735, depository entity engine 1715 or investment vehicle management unit 1745 for updating the status of investment vehicle 1630 and New MoneyNew Money 1530 unit register in circulation. This data can be used for example in the case of an extension of investment vehicle 1630 (FIG. 3), the increase in the value of investment vehicle 1630, the updated acquisition price of New Money 1530, the market value of investment vehicle 1630, the number of existing units of New Money 1530 ‘n’, the number of units to be increased of New Money 1530 ‘m’ or the final number of resulting New Money 1530 units (n+m). According to some materializations the data that can be stored in memory 1702 in the case of reduction of the investment vehicle 1630 (FIG. 4) may be, by way of example and without limitation, the reduction in the value of investment vehicle 1630, the market value of investment vehicle 1630, the number of existing units of New Money 1530 ‘n’, the number of units to be reduced by New Money 1530 ‘k’, or the number of resulting final New Money 1530 units (n-k).

In some implementations monetary unit manager 1730 can send the number of New Money 1530 units issued or withdrawn from circulation to the investment vehicle management unit 1745 for inclusion in investment vehicle accounts 1632. Also, monetary unit manager 1730 can communicate with blockchain network engine 1755 to validate and add New Money 1530 units to blockchain network.

In certain implementations, some or all of the data handled by monetary unit manager 1730 can be stored in memory 1702 in the form of a relational database, distributed database with or without a blockchain structure or any other suitable data structure capable of storing information. Ultimately, data management is usually performed by blockchain network engine 1755 and monetary unit manager 1730 sends the necessary information via links to blockchain network engine 1755 that manages storage for example in the form of a blockchain 1756.

In some implementations monetary unit manager 1730 may be any software, hardware, firmware or combination of these capable of communicating with an external and internal element to facilitate an exchange of information. According to some materializations monetary unit manager 1730 can be a set of instructions stored in memory 1702 that can be executed by processor 1701.

Central server network systems 1700 of New Money 1530 servers can introduce a calculations and transactions engine 1735. In certain implementations the calculations and transactions engine 1735 of central server network 1501 is the necessary element for the management of New Money 1530 transactions using processor 1701 and memory 1702. Calculations and transactions engine 1735 can be any software, hardware, firmware or combination thereof capable of communicating, supporting calculations, performing required transactions and making use of the services provided by depository entity engine 1715, currency market monitoring engine 1720, external platforms engine 1725, monetary unit manager 1730, internal exchange platform 1740, investment vehicle management unit 1745, client manager unit 1750, blockchain network engine 1755 and security engine 1760. According to some implementations transactions and calculations engine 1735 can be a set of instructions stored in memory 1702 that can be executed by processor 1701.

According to some embodiments transactions and calculations engine 1735 can receive requests both for the calculation of the purchase value to managing entity 1610 of monetary unit 2210 and for the calculation of the value of commissions 2211 to be charged to client 1640 as a consequence of the acquisition of New Money 1530 from managing entity 1610. Transactions and calculations engine 1735 can also facilitate the calculation of the amount of 2212 in currency 1531, 1532 in which client 1640 works and which is charged as a result of the purchase of New Money 1530 from managing entity 1610, whether it is fiat money 1532 or crypto-currency 1531 accepted by managing entity 1610. For example, if the counterpart is fiat money 1532, once the calculations and transactions engine 1735 has received information from currency market monitoring engine 1720 on the exchange rate of the standard currency used by the fund manager in respect of the currency in which client 1640 requests the transaction and has also received the value of investment vehicle 1630 from investment vehicle management unit 1745, transactions and calculations engine 1735 can easily calculate the value of the currency unit of New Money 1530 in the currency requested 2210 by client 1640 to later calculate the value of the commissions to be applied 2212.

In some implementations transactions and calculations engine 1735 can communicate to external interface 1705 whether client 1640 has in external accounts the sufficient amount of fiat money 1532 or other crypto-currencies 1531 to cover both the acquisition of New Money 1530 and the commissions to be paid to managing entity 1610. For example if New Money 1530 balance of client 1640 was not enough to cope with the transfer, calculations and transactions engine 1735 can send client 1640 notification via external interface 1705 that New Money 1530 purchase order cannot be executed because their account 1643 or external accounts do not have enough balance requiring him or her to either increase their balance by means of a fiat money 1532 or other crypto-currency 1531 transfer or their order is rejected for not having enough balance 2215.

In some implementations transactions and calculations engine 1735 can receive from external interface 1705 the communication from client 1640 in which it accepts the calculated amount 2216 to make the purchase of New Money 1530. Generally, after receiving an affirmative response from the transactions and calculations engine 1735, the calculated amount of fiat money 1532 or other crypto-currencies 1531 is debited to the corresponding account of client 2220, and the corresponding commissions 2221 are credited to the accounts of the managing entity 1619. Generally the transactions and calculations engine 1735 credits the remaining amount of fiat money 1532 or other client 1640 crypto-currencies 1531 into the accounts of the same nature of the investment vehicle accounts 1632, transferring the purchased amount 2223 to client 1640 New Money account 1642.

Referring to FIGS. 15-18 and 23-27, in some central server network systems 1700 implementations, calculations and transactions engine 1735 can communicate to monetary unit manager 1730 and blockchain network engine 1755 the transfer of New Money 1530 between clients 1640 and the payment of the corresponding fees to managing entity 1610. In one embodiment, transactions and calculations engine 1735 can receive requests both for the calculation of the sales value to managing entity 1610 of monetary unit 2312 and for the calculation of the value of commissions 2313 to be charged to client 1640 as a consequence of the sale of New Money 1530 to managing entity 1610.

Transactions and calculations engine 1735 can also facilitate the calculation of the amount of fiat money 1532 or crypto-currency 2314 to be paid to client 1640 as a result of the sale of New Money 1530 to managing entity 1610. For example, if the counterpart is fiat money 1532, once transactions and calculations engine 1735 has received information from currency market monitoring engine 1720 on the standard currency rate used by managing entity 1610 for the currency in which client 1640 requests the transaction and has also received the value of investment vehicle 1630 from investment vehicle management unit 1745, transaction and calculation engine can calculate the value of New Money 1530 unit in the requested currency 2312 from client 1640 and then calculate the value of the commissions to be applied 2313 to client 1640.

In some implementations transactions and calculations engine 1735 can receive from external interface 1705 the communication from a client 1640 in which it accepts the amount calculated to carry out 2316 the sale of New Money 1530. Generally, after receiving an affirmative response from transactions and calculations engine 1735, it charges the calculated amount of 2320 New Money 1530 to client's account 1642, crediting the account of managing entity 1610 with corresponding fees 2321. Generally, transactions and calculations engine 1735 debits the remaining amount of fiat money 1532 or other crypto-currency 1531 into the accounts of investment vehicle accounts 1632 of the same nature and credits it to the corresponding accounts of client 1640.

In some central server network systems 1700 implementations, calculations and transactions engine 1735 can communicate to monetary unit manager 1730 and blockchain network engine 1755 the sale of New Money 1530 from client 1640 to managing entity 1610.

Transactions and calculations engine 1735 can receive requests from internal exchange platform 1740 for the calculation of the amount of the initial counterpart 2406 of fiat money 1532 or crypto-currency 1531 that corresponds to pay a client 1640 for a peer to peer transaction in which one of the currencies involved 2400 is New Money 1530. In addition, transactions and calculations engine 1735 can also calculate the amount of commissions 2407 to be charged to a peer to peer trader performing a transaction with New Money 1530. For example, transactions and calculations engine 1735 can, when a client 1640 offers the purchase or sale of New Money 1530 using as counterpart 2405 fiat money 1532 or other 1531 crypto-currency, calculate the initial counterpart of amount to be paid 2406 and then calculate the commissions 2407 and the amount of the final offer 2408.

According to some embodiments, transactions and calculations engine 1735 can receive communication from internal exchange platform 1740 to retain in client's 1640 account the exchange offer issued either of fiat money 1532 or crypto-currency 1531 for the purchase of New Money 1530 or vice versa 2411. According to some embodiments once a request for the exchange of New Money 1530 for fiat money 1532 or crypto-currency 1531 or vice versa has been matched totally or partially 2413, the transactions and calculations engine 1735 deducts from client's account 1642 the amount of New Money 1530 that is the subject of transaction 2414 by adding this amount to client's account 1642 receiving New Money transfer 2415 and deducting from each client the commissions corresponding to managing entity 1610. Generally, transactions and calculations engine 1735 credits the commissions deducted 2416 from clients 1640 to managing entity accounts 1619. In certain materializations, calculations and transactions engine 1735 can communicate to monetary unit manager 1730 and blockchain network engine 1755 the transfer of New Money 1530 from one client 1640 to another client 1640.

In most common implementations, calculations and transactions engine 1735 can connect to internal exchange platform 1740 to receive commission calculation 2608 request when two clients 1640 make a transfer from one New Money 1530 to another via the transfer network 1742. Once the commissions have been calculated, the transactions and calculations engine 1735 can calculate the final amount of transaction 2609 charged to client 1640 issuing the transfer and that receiving client 1640 receives minus 2608 commissions. In certain materializations transactions and calculations engine 1735 can communicate to the internal exchange platform 1740 whether client 1640 issuing the transfer has in their account 1642 the sufficient amount of New Money 1530 to cover both the transfer to be received by receiving client 1640 and the fees paid to managing entity 1610. For example, if client 1640 does not have enough New Money 1530 balance to handle the transfer, calculations and transactions engine 1735 can send client 1640 via external interface 1705 a notification that their New Money 1530 transfer order cannot be executed because their account 1642 does not have enough balance, requiring them to either increase their balance by a New Money 1530 transfer or previously purchase New Money 1530 from managing entity 1610 or their order is rejected for not having sufficient balance 2611.

n some implementations transactions and calculations engine 1735 can receive from external interface 1705 the communication from a client 1640 in which it accepts the calculated amount to make a New Money 1530 transfer to another client 2612. Generally, after receiving an affirmative response from the transactions and calculations engine 1735, it debits the amount calculated on the account of client 1642 issuing transfer 2613 by crediting the amount of the transfer ordered to the account of client 1642 receiving transfer 2615 and crediting the account of managing entity 1610 with the corresponding fees 2616.

For certain embodiments, calculations and transactions engine 1735 may communicate to the monetary unit manager 1730 and blockchain network engine 1755 the transfer of New Money 1530 from one client to another 1640 and the payment of the corresponding fees to managing entity 1610.

In certain embodiments, calculations and transactions engine 1735 can be connected to external platforms engine 1725 to receive the request for commission calculation 2708 when two clients 1640 make a transfer from one New Money 1530 to another via external exchange platform 2700. Once the commissions have been calculated, transactions and calculations engine 1735 can calculate the final amount of the transaction 2709 charged to client 1640 issuing the transfer and to be received by receiving client 1640 minus 2708 commissions. For certain embodiments, calculations and transactions engine 1735 can tell external platforms engine 1725 whether client 1640 issuing the transfer has enough New Money 1530 in their account 1642 to cover both the transfer to be received by receiving client 1640 and the fees to be paid to managing entity 1610 and external platform 1660. For example, if client 1640 does not have enough New Money 1530 balance to handle the transfer, the calculations and transactions engine 1735 may instruct external platforms engine 1725 to instruct external interface 1705 to contact external platform 1660 to inform them that client 1640 issuing the transfer does not have enough balance and therefore their New Money 1530 transfer order cannot be executed. In certain materializations, external interface 1705 may require external platform 1660 to request one of the following actions from client 1640: either to increase their balance by means of a New Money 1530 transfer or to previously acquire New Money 1530 from the managing entity 1610 or to reject their order because it does not have a sufficient balance of 2711.

In some implementations, calculations and transactions engine 1735 may receive from external interface 1705 the communication from an external platform 1660 that a client 1640 accepts the amount calculated to make a New Money 1530 transfer to another client 2713. Generally, after receiving an affirmative answer, transactions and calculations engine 1735 retains the amount calculated in the account of client 1642 issuing the transfer 2714, and then withdraws it 2715 and credits the amount of the transfer ordered to client's 1642 account who receives the transfer 2716 and credits on the one hand the account of managing entity 1610 with the corresponding fees 2617 and on the other hand credits the account of external platform 1660 with the amount of the fees corresponding to it for operation 2718. In some system 1600 implementations, calculations and transactions engine 1735 can communicate to the monetary unit manager 1730 and blockchain network engine 1755 the transfer of New Money 1530 from one client to another 1640 and the payment of the corresponding fees to the managing entity 1610 and to external platform 1660.

Central server network systems 1700 may also include an internal exchange platform 1740. In general, internal exchange platform 1740 can manage and carry out all the currency exchange operations that exist within the working environment of New Money system 1600.

Internal exchange platform 1740 generally communicates with a variety of systems and interacts with external exchange platforms 1660 via external interface 1705. Internal exchange platform 1740 can store in memory 1702 the available data related to the offers and demands of clients 1640 that are necessary for the correct functioning of New Money system 1600. These data can be, for example, a list of the historical transactions between clients 1640, variations in the price quotation of crypto-currency 1531 on internal platform 1740 or on external platforms 1660, degree of correspondence between the supply and demand of each crypto-currency 1531, offers and demands of clients 1640 generally classified in an exchange network 1741, security limits required by clients 1640, volume of fiat money 1532, crypto-currencies 1531 and New Money 1530 exchanged in exchange network 1741, security of transactions and asset requests, historical commissions stipulated by managing entity 1610, security protocols required for the placement of orders, as well as any information necessary for the proper functioning of the present invention in any of its possible implementations.

In certain materializations, some or all of the data handled by internal exchange platform 1740 may be stored in memory 1702 in the form of a relational database, distributed database with or without a blockchain structure or any other suitable data structure capable of storing information. For example, in certain materializations of systems 1800, the internal exchange platform 1740 sends certain information via links to blockchain network engine 1755 that manages the storage in the form of a blockchain 1756. In certain implementations, internal exchange platform 1740 may receive instructions from transactions and calculations engine 1735. For example, transactions and calculations engine 1735 can certify that a client 1640 has sufficient amount in his balance sheet to launch a bid to internal network 2409, transactions and calculations engine 1735 can send the bid to internal exchange platform 1740 that creates, modifies or deposits the bid to exchange network 1741. Internal exchange platform 1740 can write offer 2412 to memory 1702 in any suitable data structure capable of storing the offer. Normally internal exchange platform 1740 launches a write and update request to blockchain network engine 1755.

In some central server network systems 1700 implementations, internal exchange platform 1740 can access the offers and demands deposited by clients 1640 on the exchange network 1741. In general, internal exchange platform 1740 can edit, delete and create existing information on exchange network 1741 via blockchain network engine 1755. Internal exchange platform 1740 can match the buy and sell bids of different crypto-currencies 2413 according to previously established parameters. Normally, once two or more requests have been matched, internal exchange platform 1740 removes the requests from the 1741 network by updating the corresponding records via blockchain network engine 1755. The internal exchange platform 1740 can notify transactions and calculations engine 1735 that the transaction has been matched, in response, transactions and calculations engine 1735 normally notifies the internal exchange platform 1740 if the transaction log has been updated correctly. Generally in the matching process New Money 1530 is present as a counterpart, however, internal exchange platform 1740 can manage transactions of fiat money 1532 or external crypto-currencies 1531 in which New Money 1530 is not present. Internal exchange platform 1740 can exchange quote data with other external platforms 1660 via external platforms engine 1725. In general, depending on the implementation, calculations and transactions engine 1735 or client manager unit 1750 will inform internal exchange platform 1740 if a previously matched request is successful. If not, internal exchange platform 1740 normally updates the record of offers and requests on exchange network 1741 and adds the offers that had been matched. If so, internal exchange platform 1740 can discern whether the matched request is partially or fully matched 2417 and carry out different processes. For example, if the request has been fully satisfied, internal exchange platform 1740 can remove the offers from the offers and demands on exchange network 1741 and update the information related to the bid history, if the request has not been fully satisfied, internal exchange platform 1740 can generate a new request following rules or algorithms and add it to the bid and ask record on exchange network 1741, as well as update any relevant records accordingly.

In certain implementations, internal exchange platform 1740 can serve as a means to perform New Money 1530 transfers between peers, generally through the transfer network 1742. External interface 1705 can transmit a transfer order to internal exchange platform 1740, which can update the transfer tables or transfer logs of transfer network 1742 normally using blockchain network engine 1755. In certain cases, once all the necessary records are updated, internal exchange platform 1740 can transfer the transfer order to transactions and calculations engine 1735 for the transaction to take place. In response, transactions and calculations engine 1735 communicates to internal exchange platform 1740 whether or not the transfer is possible and depending on the response internal exchange platform 1740 can conveniently update transfer network 1742.

Internal exchange platform 1740 can manage all the necessary information for the correct functioning of the present invention, particularly the exchange of currencies between users 1520 of the system. internal exchange platform 1740 generally manages and analyzes client 1640 orders, as well as being responsible for decision-making according to a set of rules. Internal exchange platform 1740 can build new data structures and transmit them via external interface 1705, usually to clients 1640. In certain implementations, Internal exchange platform 1740 may follow a set of instructions stored in memory 1702 that can be executed by processor 1701, and internal exchange platform 1740 may also materialize as a set of instructions that can be executed by processor 1701.

In some implementations, central server network systems 1700 can also include an investment vehicle management unit 1745 that generally manages the operations related to investment vehicle 1630, acquiring assets on asset market 1650 by increasing the volume of investment vehicle 1630, or reducing the volume of the investment vehicle by selling assets on asset market 1650. According to some materializations, investment vehicle management unit 1745 communicates and interacts with a variety of systems such as depository entity engine 1715, currency market monitoring engine 1720, monetary unit manager 1730 or calculations and transactions engine 1735.

According to some materializations, management unit of investment vehicle 1745 can store in memory 1702 the data available on asset markets 1650 that are necessary for the correct functioning of environment and system of New Money 1600. These data can be the subject of big data analysis and include, for example and without limitation, asset prices, historical asset returns, market fluctuation indices, active traders, commissions applied by the different operators, developments occurring in companies: mergers, acquisitions, suspension of dividends, development or approval of an innovative new product, hiring or firing of company executives and allegations of fraud or negligence, global events, riots, natural disasters, terrorism, social uncertainty, fear, inflation, interest rates, advertising campaigns for a company, the launch of new products or services, as well as any information necessary for the proper functioning of the present invention in any of its possible implementations. In certain materializations, some or all of the data handled by investment vehicle management unit 1745 may be stored in memory 1702 in the form of a relational database, a distributed database with or without a blockchain structure or any other suitable data structure capable of storing information. For example, according to some materializations of central server network systems 1700, the management investment vehicle management unit 1745 can communicate with blockchain network engine 1755 so that it can update the status of investment vehicle 1630, for example in a blockchain 1756.

According to some implementations investment vehicle management unit 1745 can receive two types of requests from a variety of systems such as the internal exchange platform 1740 or external platforms engine 1725, one for calculating the value of a New Money 1530 currency unit 2002 and the other for providing a client 1640 with New Money 1530 units at a previously reported price. Depending on certain materializations, investment vehicle management unit 1745 may discriminate between whether the markets are closed or whether there is a critical situation which makes it advisable not to make any asset acquisitions on asset market 1650. For example, it may happen that an event causes a sudden movement in markets 2003, which makes it advisable, temporarily, not to acquire assets in assets market 1650 and thus avoid speculations that could harm clients 1640 who have New Money 1530 monetary units and who therefore own a proportional percentage of investment vehicle 1630.

According to some implementations investment vehicle management unit 1745 can send orders to transaction and calculation engine 1735 to launch an automatic asset price calculation process for 2007. Generally, external interface 1705 obtains information from asset markets 1650 that allows calculations and transactions engine 1735 to apply a series of algorithms to determine the optimal price and type of assets to buy in 2007 based on the type of investment established by investment vehicle 1630.

Investment vehicle management unit 1745 can also provide internal exchange platform 1740 or external platform engine 1725 with information on the calculation of the unit value of a New Money 1530 unit. Investment vehicle management unit 1745 can also provide the internal exchange platform 1740 or external platforms engine 1725 with information on the current price of New Money 1530 currency unit and its variation from the price previously reported in 2012. In some investment vehicle management unit 1745 implementations you can start an automatic asset purchase process in 2013 to increase the volume of investment vehicle 1630. Generally, after the acquisition of assets, investment vehicle management unit 1745 notifies depository entity engine 1715 of the acquisition of the aforementioned assets, which are deposited with depository entity 1620 and are added to investment vehicle 1630 in appropriate order and classification 2015. Investment vehicle management unit 1745 may also communicate to the manager of investment unit 1730 the increase in investment vehicle in order for the monetary unit manager 1730 to proceed to issue new units 2016 of New Money 1530 to be made available to clients 1640 requesting New Money 1530. In some materializations of central server network systems 1700, investment vehicle management unit 1745 can communicate to blockchain network engine 1755 the increase in the number of New Money 1530 units made as a result of the extension of investment vehicle 1630 by the acquisition of new assets on asset market 1650.

In some implementations investment vehicle management unit 1745 can automatically start a process of selling assets 2113 and thus reduce the volume of investment vehicle 1630. Generally, after the sale of assets, investment vehicle management unit 1745 notifies depository entity engine 1715 of the sale of the aforementioned assets, which are delivered by depository entity 1620 to asset market 1650, thus reducing 2114 investment vehicle 1630. Investment vehicle management unit 1745 may also communicate to monetary unit manager 1730 the reduction of investment vehicle 1630 so that monetary unit manager 1730 can reduce the number of New Money 1530 units 2116 delivered by clients 1640. In certain materializations, investment vehicle management unit 1745 may communicate to blockchain network engine 1755 the reduction in the number of New Money 1530 units made as a result of the reduction in investment vehicle 1630 due to the sale of assets.

In some implementations investment vehicle management unit 1745 may receive queries from calculations and transactions engine 1735 to see if it is possible to extend investment vehicle 1630 in order to meet a client's 1640 demand to purchase 2202 New Money 1530 units. Generally, investment vehicle management unit 1745 responds to transactions and calculations engine 1735, either because the system is blocked because the markets are closed or because a critical situation exists or because it is possible to meet client 1640 demand. Also, according to some implementations, investment vehicle management unit 1745 can receive a query from transaction engine and calculation 1735 to know the unit price 2208 of New Money 1530 in order to satisfy the demand of a client 1640 to purchase units of New Money 1530. According to some materializations the investment vehicle management unit 1745 refers to transaction engine and calculation 1735 the value of New Money 1530 currency unit 2208 in the standard currency in which managing entity 1610 works so that transactions and calculations engine 1735 calculates the value of New Money 1530 currency unit in the currency or crypto-currency 2210 chosen by client 1640.

According to some materializations, transactions and calculations engine 1735 can issue queries to investment vehicle management unit 1745 as to whether the price previously communicated by investment vehicle management unit 1745 to the transactions and calculations engine 1735 is still valid 2218. In response, the investment vehicle management unit 1745 can communicate that the circumstances or the price have changed 2219 or that the agreed price is still valid, so that client 1640 can continue with the process of acquiring New Money 1530.

In some implementations the investment vehicle management unit 1745 may receive queries from the calculations and transactions engine 1735 to see if it is possible to reduce the investment vehicle 1630 in order to satisfy a clients 1640 demand to sell units 2302 of New Money 1530. In the most common implementations, the investment vehicle management unit 1745 informs the calculation engine that the system is blocked either because the markets are closed or because a critical situation exists or because it is possible to meet client 1640 demand. According to certain materializations the investment vehicle management unit 1745 can receive a query from the transactions and calculations engine 1735 to know the sale price 2310 of the units of New Money 1530. According to some materializations the investment vehicle management unit 1745 can refer to the transactions and calculations engine 1735 the value of the currency unit 2310 of New Money 1530 in the standard currency in which the managing entity 1610 works.

According to some materializations, the transactions and calculations engine 1735 can transfer demands to the investment vehicle management unit 1745 to find out whether the price previously communicated by the investment vehicle management unit 1745 to the transactions and calculations engine 1735 is still valid 2318. In response, the investment vehicle management unit 1745 can communicate that the circumstances or the price have changed 2319 or that the agreed price is still valid, so that client 1640 can continue with the process of selling New Money 1530. In some materializations of the system, the investment vehicle management unit 1745 can communicate to the blockchain network engine 1755 the decrease in the number of New Money 1530 units made as a result of the reduction of the investment vehicle 1630 by the sale of assets on the asset market 1650.

In certain implementations, the investment vehicle management unit 1745 may materialize as a set of instructions stored in memory 1702 that can be executed by processor 1701. In addition, the investment vehicle management unit may follow a collection of instructions and commands stored in memory 1702 to carry out the tasks necessary for the proper functioning of the present invention.

A client manager unit 1750 may be included in the systems of the central server network systems 1700. In general, client manager unit 1750 manages and carries out all operations relating to clients 1640, from the updating of their accounts 1642 to the securitization of their operations.

Client manager unit 1750 interacts with a variety of systems, both internally via internal links or connections and externally, usually via external interface 1705. Client manager unit 1750 can store in the memory 1702 the information related to clients 1640, a majority of the information can be found in clients' 1642 accounts. In addition, client manager unit 1750 can manage various directories and client security records, as well as any information necessary for the proper functioning of the present invention in any of its possible implementations. As an example, client manager unit 1750 can maintain data on the different communication protocols with a client 1640 depending on the type of connection 1511, the status of keys 1518 in New Money accounts 1642, lists of identifiers 1521 of clients 1640, most common users 1520 in the operations or balance of each account 1642. In addition, depending on the type of implementation, client manager unit 1750 may have access to records or data belonging to a client 1640 even if it has partial control or another system maintains them, such as incident logs, key 1518 management evolution, most common IP addresses, physical or historical transaction addresses.

In certain materializations, some or all of the data handled by client manager unit 1750 may be stored in memory 1702 in the form of a relational database, distributed database with or without a blockchain structure or any other suitable data structure capable of storing information. In the most common implementations, the blockchain network engine 1755 can assist client manager unit 1750 in these tasks. For example, client manager unit 1750 may need to update the information within a client 1642 account and generate an instruction for the blockchain network engine 1755 to replace the corresponding records, which are normally stored in the form of a blockchain 1756.

Client manager unit 1750 is generally involved in client's administrative registration process (FIG. 19). Once a request from a client 1640 has passed the security processes, client manager unit 1750 together with the security engine 1760 can check if there is an account 1642 associated with client 1903 normally through an identifier 1521, in this operation client manager unit 1750 usually sends an instruction to the blockchain network engine 1755 to obtain the information from the relevant logs. If there is no account 1642 associated with a client 1640, once client manager unit 1750 has received the necessary data from client 1640, it verifies and checks the data and documentation 1906. In the most common implementations, client manager unit 1750 can send instructions to external platforms engine 1725 to obtain information needed for the verification process 1906. Client manager unit 1750 is responsible for initiating the opening procedure 1910 of a client account 1642, usually by creating a new account 1642 in the corresponding records, particularly a blockchain 1756. Other systems can intervene in the account opening process, such as the blockchain network engine 1755 or the security engine 1760. In the most common implementations, client management unit can generate a registration key or identifier 1521 to recognize client 1640.

In an embodiment, client manager unit 1750 can receive calls from external interface 1705 in order to discriminate the status of 2204, 2304, 2403, 2603, 2606, 2705, 3312 of a client 1640 in a New Money 1530 purchase and sale process, Forex trading on the internal exchange platform 1740, transfer New Money 1530 through the internal exchange platform 1740, transfer New Money 1530 peer to peer through an external platform 1660 or secure identification of an external platform 1660. Normally, client manager unit 1750 checks whether a client 1640 is registered as an administrative client. If client 1640 is not registered in the system, client manager unit 1750 can generate a request for registration (FIG. 19) and send it to external interface 1705. Afterwards, the processes of buying and selling New Money 1530, placing an offer, transfer of New Money 1530 through internal platform 1740, transfer of New Money 1530 through external platform 1660 or identification of an external platform 1660 can be completed. If client 1640 is already registered, the process can be continued in step 2205, 2305, 2404, 2604, 2607, 2706, 3313 where client manager unit 1750 sends a request to the security engine 1760 to check client 1640 security parameters (FIG. 29), (FIG. 30). Depending on certain results, client manager unit 1750 can receive commands from the transactions and calculations engine 1735 to know if a client 1640 has enough funds in a given account 2214, 2308, 2409.

In a currency exchange process on the internal exchange platform 1740, normally if client 1640 has sufficient balance in their corresponding accounts to deal with the transaction, the transaction can continue in step 2411 where according to some materializations the calculations and transactions engine 1735 can instruct client manager unit 1750 or external platforms engine 1725 to perform the currency retention transaction. In certain cases, if the offer is fully or partially matched, the internal exchange platform 1740 can make a request 2414 to client manager unit 1750 for the deduction in clients' 1640 accounts, of the proportional amount corresponding to the amount that has been matched. The internal exchange platform 1740 then requests depository entity engine 1715 or client manager unit 1750 to add to the corresponding accounts of clients 1640 the amount proportional to the amount that has been matched 2415.

In a majority of implementations, client manager unit 1750 may receive the necessary information 2507 from external interface 1705 to verify the administrative status of client (s) 1640 in a communication with an external platform 1660. The process generally continues with step 2508 where client manager unit 1750 can use the security engine 1760 to perform the relevant security procedures (FIG. 29), (FIG. 30), (FIG. 32). Client manager unit 1750 can check the result 2509 of the processes related to the safety of client 1640. If the safety tests have not been passed, client manager unit 1750 can inform external platforms engine 1725 that clients 1640 could not be verified. In general, in the event that clients 1640 do pass the testing process, client manager unit 1750 reports the success of the transaction to external platforms engine 1725.

In a New Money 1530 transfer through the internal exchange platform 1740, in certain implementations, client manager unit 1750 may receive requests from the calculations and transactions engine 1735 to check whether client1 6401 has sufficient balance 2610 in his account 1642. If client1 1640 confirms New Money 1530 transfer order to client2 1640, depending on the type of materialization, the internal exchange platform 1740 may send instructions to client manager unit 1750 to initiate the retention process 2613 on client1's 1640 account 1642 of the amount of New Money 1530 transfer to be made to client2 1640. In accordance with certain materializations, internal exchange platform 1740 together with depositary entity engine 1715 can send instructions to client manager unit 1750 to make the deduction 2614 from client1's account 1642 of the amount of New Money 1530 that has been previously withheld. In some culminations, client manager unit 1750 may accept requests from the internal exchange platform 1740, depositary entity engine 1715 or both, for the amount of New Money 1530 transferred to it by client1 1640 to be added 2615 to client2's corresponding account 1642. In certain cases, internal exchange platform 1740 may require an update of client's account 1642 statement to client manager unit 1750.

In certain implementations, the implementation of client manager unit 1750 on relevant server system 1800 may receive request 2805 from a user 1520 from external interface 1705. Based on certain implementations, client manager unit 1750 may perform security checks on clients 1640, typically relating to the public key 1518, identification data or contact data. Client manager unit 1750 can assist in checking the integrity of received messages 2809, for example, by checking the security of a request encapsulated by another server system 1800.

In the most common implementations, client manager unit 1750 participates in client 1640 registration process with remote wallet (FIG. 28), wallet or local wallet (FIG. 29). Once connection 1511 between a user system 1514 and a server system 1800 is established as a continuation of the registration administrative process (FIG. 19), the implementation of client manager unit 1750 in the relevant server system 1800 proceeds to the location of client 1642 account created in the registration administrative process (FIG. 19). In most implementations, client manager unit 1750 performs the localization by identifying a data linked 1521 to client 1640 and acting as a reference to uniquely identify 2903, 3003, 3204 to client account 1642.

In certain implementations, during a registration process (FIG. 29), (FIG. 30) a user system 1514 can send a public key 1518 to client manager unit 1750 in order to check whether the key 1518 previously generated by user system 1514 matches any of the keys linked to an existing 2905, 3005 client 1640. In the event that public key 1518 is unique, once private key 1518 is obtained and encrypted with a password 1519 that is known only to client 1640 and is not stored on any of the systems, client side can send public key 1518, encrypted private key 1518 or both 2908, 3009 to client manager unit 1750. Generally, both data points are stored by client manager unit 1750 in client account 1642.

With regard to the identification of a client 1640, in the event that user system 1514 does not contain a wallet 1516 or a local wallet 1517, client manager unit 1750 can generally locate encrypted private key 1518 in client 1642 account and send it 3208 to user system 1514. Client manager unit 1750 can also generate a nonce and send it to user system 1514, usually via external interface 1705. In a common operation, the user system 1514 sends the nonce encrypted with client's 1640 private key 1518, and client manager unit 1750, usually through security engine 1760, performs decryption tests 3212 with client's 1640 public key 1518 retrieved from their account 1642. If decryption is successful, client manager unit 1750 can compare the nonce decryption with the nonce initially sent to user system 1514. In the case of a match, client manager unit 1750 generally determines that the correct authentication of client 1640 has occurred and proceeds to the opening of a session.

In a majority of implementations, client manager unit 1750 can retrieve public key 1518 from an external platform account or a client 1642 to, normally, move it to security engine for the encryption operation of a single-use symmetric key with retrieved 3407 public key 1518.

Client manager unit 1750 can manage all the information necessary for the correct functioning of the present invention, particularly the data of all clients 1640. Client manager unit 1750 typically manages and analyzes incoming system transactions involving a client 1640 status update, as well as performing relevant data security checks to ensure the identity of a client 1640. In general, client manager unit 1750 is present in a variety of system processes and can carry out a variety of operations, usually at a high level. Client manager unit 1750 can build new data structures and transmit them to other systems usually via internal links, or via external interface 1705.

In a majority of culminations, client manager unit 1750 can follow a set of instructions stored in memory 1702 that can be executed by processor 1701, and client manager unit 1750 can be specified as a set of instructions that can be executed by processor 1701.

In certain embodiments, central server network systems 1700 may also include a blockchain network engine 1755. In general, blockchain network engine 1755 is the element in charge of all the operations related to the management of blockchain 1756. In some cases, the mission of blockchain network engine 1755 may be to manage other databases such as a relational database, a centralized database, a distributed database without a blockchain structure or any other suitable data structure capable of storing information. In general, blockchain network engine 1755 can manage all information processing and store data securely in memory 1702.

Blockchain network engine 1755 normally has access to the data records stored in memory 1702 via processor 1701. Blockchain network engine 1755 can store in memory 1702 any information structure that is necessary for the correct functioning of central server network system 1700, this data can be for example, but not limited to, contact information of clients 1640, identification information of clients 1640, data necessary for the authentication of external platforms 1660, client account status 1642, purchase offers, transaction history, transactions in confirmation status, communication protocols, standards in transaction formats or any other data necessary for the proper functioning of the present invention. Blockchain network engine 1755 can be used in one or more server systems 1800. Depending on the implementation, blockchain network engine 1755 may require different types of consensus methods depending on the distribution and management of server systems 1800, such as, but not limited to, proof of work, proof of stake, proof of importance or BFT systems. Blockchain network engine 1755 can use various information security systems such as data distribution, encryption, authentication of server systems 1800, structuring or sequencing of information or any other method capable of achieving the necessary security for New Money system 1600. In certain implementations, client manager unit 1750 may require a clients 1640 status 1903; in response, blockchain network engine 1755 may access memory 1702 to check client 1640 status and communicate it to client manager unit 1750. If client 1640 is registered, client manager unit 1750 may request data from client to update their profile or multiple profiles. Blockchain network engine 1755 can update client 1640 information within Blockchain 1756 stored on each server system 1800. In some cases, client manager unit 1750 may require client contact or identification information 1906; if blockchain network engine 1755 does not have access to certain data, blockchain network engine 1755 may request it from external platforms engine 1725. In the event that client 1640 data has been verified 1907, 1908, client manager unit 1750 may request blockchain network engine 1755 to open a new client 1642 account in 1910, generally blockchain network engine 1755 edits and updates all records that are necessary to open a new client 1642 account in 1910.

In general, the blockchain network engine 1755 has the ability to store in memory 1702 all requests that arrive or are sent to the central server network systems 1700. More specifically, there are certain commands that should be kept in memory 1702 such as the calls received by investment vehicle management unit 1745 to either increase or decrease the investment vehicle, or to know the value of the monetary unit of New Money 1530. Normally, the investment vehicle management unit 1745 sends these commands to blockchain network engine 1755 so that they can be stored temporarily, so that investment vehicle management unit 1745 can access the commands received and operate accordingly. In certain materializations, monetary unit manager 1730 may transmit to blockchain network engine 1755 an update order for the available funds 2016, 2116 of New Money 1530 currency units.

In some implementations, external interface 1705 can send client 1640 requests to blockchain network engine 1755 for storage. For example, after receiving a request from a client 1640 for purchase and sale of 2203, 2303 New Money 1530, a security process may be carried out, if there is confirmation of client's 1640 security, calculations and transactions engine 1735 can access memory 1702 through the blockchain network engine 1755 to analyze the type of request, the amount of counterparty offered by 2206, 2306 or any data needed to continue the sale. Generally, depending on the type of implementation, transactions and calculations engine 1735 or client manager unit 1750 can request balance sheet information of a client account 2214, 2308, and in response the blockchain network engine 1755 is able to query the required data and transmit it to the appropriate system. Also, when a sale is made, calculations and transactions engine 1735 can update the 2223, 2320 status of client's 1642 accounts that are involved, through blockchain network engine 1755. Generally, the status of internal New Money client 1642 accounts, normally stored in blockchain 1756, have an intrinsic validity. Depending on the type of materialization, calculations and transactions engine 1735 may or may not update the account statement of managing entity 1610 at the time of payment of the 2221 commissions in New Money 1530 purchase process. Generally, in the process of selling New Money 1530, calculations and transactions engine 1735 updates the status of the account 2321 of the managing entity 1610 in the blockchain 1756. In certain cases, investment vehicle management unit 1745 or the transactions and calculations engine 1735 sends an order to blockchain network engine 1755 to change the status 2222, 2322 of the relevant accounts of the investment vehicle 1632. The calculations and transactions engine 1735 and depository entity engine 1715 can also send instructions for updating client 1640 balances on external or internal accounts 1642, 1643.

Generally, transactions and calculations engine 1735 together with client manager unit 1750 can block or retain a certain amount 2411 from a client's account 1642. Transactions and calculations engine 1735 can send blockchain network engine 1755 the blocking order along with the necessary permissions for the blockchain network engine 1755 to perform the operation. In certain cases, when a request is matched within exchange network 1741, internal exchange platform 1740 can transmit to calculations and transactions engine 1735 or directly to blockchain network engine 1755 that the matched blocked amount 2414 is definitively deducted from client 1642 account. In general, after matching a request, either partially or fully, internal exchange platform 1740 updates the status of exchange network 1741 and the required records using blockchain network engine 1755. External platforms engine 1725 may require that requests sent and received from external platforms 1660 be temporarily stored in intermediate logs, the blockchain network engine 1755 can communicate with external platforms engine 1725 to handle any such requests, for example an external platform 1660 can send a request in its own format with the operation to be performed, external platform engine 1725 can send the request to the blockchain network engine 1755 to store it in memory 1702 in, for example, an intermediate buffer, external platform engine 1725 can access this request if necessary.

Blockchain network engine 1755 is generally responsible for maintaining the homogeneity of blockchain 1756 on all server systems 1800. Blockchain network engine 1755 can implement different methods to control that the information retained in the internal records of each server system 1800 is uniform. Generally, blockchain network engine 1755 can receive incoming requests via external interface 1705, encapsulate them in different data structures 2806, and implement different protocols for requests to reach 2807 all server systems 1800. In addition, blockchain network engine 1755 can handle message security, analyzing parameters such as format, sequence number, time stamp, message source, or any parameters necessary to ensure the security of system 2809, and can discard messages that do not successfully pass security processes 2813. In certain implementations blockchain network engine 1755 can handle a machine of blockchain network states and their different copies on different server systems 1800. Generally, blockchain network engine 1755 handles the execution of operations at a lower level, and can edit blockchain 1756 based on the execution results. In some materializations blockchain network engine 1755 can assign a primary 2808 server system 1800 that can maintain authoritative information regarding a group of requests. In addition, blockchain network engine 1755 can generate new data 2810 structures to achieve consensus among server systems 1800, and can initiate and manage negotiation processes to reach a minimum consensus 2811. In certain implementations, blockchain network engine 1755 communicates the result of the requested operation to the applicant through primary node 2816. In certain cases, blockchain network engine 1755 can move the operation result through non-primary 1800 nodes.

In most implementations, blockchain network engine 1755 can receive requests from client manager unit 1750 or external platforms engine 1725 to retrieve from the relevant logs the necessary information relating to a client 1642 account or external platform 1660, typically blockchain network engine 1755 scans existing client 1642 accounts 2903, 3003 through one or more identifiers 1521. In certain cases, client management unit 1750 or external platform engine 1725 may call the security engine 1760 in duplicate public key 1518 detection operations 2905, 3005, 3104. In the case of a defective key 1518, blockchain network engine 1755 is usually notified and can note a security incident in the appropriate registers 2906, 3006, 3105, usually in the form of a blockchain 1756.

In most common implementations, client manager unit 1750 or external platforms engine 1725 may require blockchain network engine 1755 to add information to a client 1642 account or external platform, such as a public key 1518 storage 2908, 3009, 3108, a private encrypted user 1520 key 1518, or both. In certain culminations, blockchain network engine 1755 can receive instructions from external platform engine 1725 motor for registering 3102 of an external platform 1660.

Typically, client manager unit 1750 or external platform engine 1725 can send a request to blockchain network engine 1755 to search for a client 1642 account or external platforms 1642 in the required records, 3204, 3304, 3312 normally client manager unit 1750 or external platform engine 1725 encapsulate client 1640 identifier 1521 in the request or external platform 1660. In certain implementations, blockchain network engine 1755 can extract from accounts 1642 the necessary public keys 1518 for nonce 3212, 3308 decryption process or retrieve 3406 a public key 1518 for symmetric key 1518 encryption operations. If the identification of a client 1640 is erroneous a sufficient number of times, client manager unit 1750 or external platforms engine 1725 may require blockchain network engine 1755 to log a security incident 3215, 3315 in authentication. In some materializations, the security engine 1760 may send instructions to blockchain network engine 1755 for storage 3409 of symmetric keys 1518 encrypted in a confidentiality provisioning process.

Blockchain network engine 1755 can manage all the operations related to the management of the information necessary for the correct functioning of the present invention, particularly and without limitation, the updating and maintenance of a database distributed in the form of a blockchain 1756. Blockchain network engine 1755 generally receives and manages incoming requests to central server network systems 1700 and is responsible for homogenizing the information across all server systems 1800. Blockchain network engine 1755 can build new data structures and transmit them via external interface 1705. Blockchain network engine 1755 can also be used to update information in blockchain 1756 or other forms of storage. In some materializations, blockchain network engine 1755 can be implemented as a set of instructions that can be executed by processor 1701. In certain cases, blockchain network engine 1755 can follow a set of instructions stored in memory 1702 that can be executed by processor 1701.

Security engine 1760 can be included in the systems of central server network systems 1700. In general, security engine 1760 manages and carries out all operations related to the implementation of security for the proper functioning of central server network systems 1700, from the security of requests at the lowest level, to the security of users 1520 of New Money system 1600 working environment.

Security engine 1760 generally communicates with a variety of systems and interacts with them via internal connections or external interface 1705. Security engine 1760 can store in memory 1702 the security related information of New Money system 1600. Also, security engine 1760 can manage various directories and security logs, as well as any information necessary for the proper functioning of the present invention in any of its possible implementations. As an example, security engine 1760 can maintain data on communication protocols, both with other systems in central server network systems 1700 and with external platforms 1660, request standards, server system 1800 listings or standard message generation formats. Similarly, security engine 1760 may have partial control over certain data, such as directories with authorized external platforms 1660 next to external platforms engine 1725 or client 1640 incident logs next to client manager unit 1750.

In certain materializations, some or all of the data handled by security engine 1760 may be stored in memory 1702 in the form of a relational database, distributed database with or without a blockchain structure or any other suitable data structure capable of storing information. In the most common implementations, the blockchain network engine 1755 can assist security engine 1760 in these tasks. For example, client manager unit 1750 can generate instructions and transfer them to security engine 1760 to update an incident log. In a common operation, security engine 1760 sends the necessary information via links to blockchain network engine 1755 that manages the storage, usually in the form of a blockchain 1756.

Depending on the type of materialization, security engine 1760 may receive a request from external platforms engine 1725 to assist in the process of verifying identification data 2503 relating to external platform 1660 normally by accessing internal or external databases generally using the services of blockchain network engine 1755. Generally, security engine 1760 can receive from external interface 1705 or external platforms engine 1725 the data necessary for the verification of the 2504 safety aspects 2504 of external platform 1660.

The security engine 1760 can receive information from external interface 1705 or client manager unit 1750 to perform the necessary security checks related to clients 1640 such as client registration check (FIG. 19) or client identification (FIG. 32). The security engine 1760 can transfer the result 2509 to client manager unit 1750.

Following this revelation, security engine 1760 can perform a multitude of tasks related to the reliable and secure management of all existing and transported information both in the working environment of a New Money system 1600 and between central server network systems 1700. For example, the implementation of security engine 1760 in a particular server system 1800 may receive a request 2805 from a user 1520 from external interface 1705 to, for example, check the request format, applicant addresses, client public key, or anything else necessary to ensure security.

In some materializations, the implementation of the security engine 1760 in an server system 1800 may test the integrity of received message 2809. Security engine 1760 can request certain services from blockchain network engine 1755, client manager unit 1750 or external platforms engine 1725, such as checking the security of the encapsulated request.

In general, security engine 1760 in conjunction with blockchain network engine 1755 can build new negotiation messages and deliver them to the network's server systems 1800 using a variety of methods such as point-to-point communications or multicast between nodes. In addition, normally both engines 1755, 1760 can implement any consensus algorithms 2811 necessary to ensure that the existing information in the records of each server system 1800 is homogeneous. In certain cases, security engine 1760 and blockchain network engine 1755 can ensure that other parameters relative to each server system 1800 are correct, such as the status of each server system 1800 that replicates to a state machine. In addition, depending on the implementation, both engines 1755, 1760 are able to discern when an agreement between the nodes has or has not been reached 2812, generally based on a number of iterations, messages of agreement or time elapsed since the beginning of the consensus process. In the event that no consensus is reached, the message can be discarded 2813 by the central server network systems 1700, normally via one of these engines 1755, 1760.

Normally, security engine 1760 performs necessary tasks in processes related to ensuring the security and confidentiality of a user 1520 or operation, such as registration processes (FIG. 29), (FIG. 30), (FIG. 31), identification processes (FIG. 32), (FIG. 33) or confidentiality processes (FIG. 34). Security engine 1760 can receive public key 1518 from a client 1640 or external platform 1660 from external interface 1705. Security engine 1760 together with client manager unit 1750 or external platforms engine 1725 can check whether key 1518 matches any of the keys linked to an existing client 1640 or external platform 1660, 2905, 3005, 3104. If the answer is yes, security engine 1760 can make an annotation of the event in relevant security logs 2906, 3006, 3105 and generate an error message. Security engine 1760 can create a data structure reporting the error and requesting the destruction by client 1640 or external platform 1660 of the information associated with the current registration process and transfer it to external interface 1705 for delivery. Security engine 1760 can then destroy the information associated with the current registration process.

In the event that the key 1518 does not match any of the keys linked to a client 1640 or external platform 1660, that is, generated keys 1518 are unique, depending on the type of materialization, client 1640 or external platform 1660 can encrypt its private key 1518, 2907, 3007, 3106 and normally transfer it to central server network 1501 along with its public key 1518, 2908, 3107. Security engine 1760 together with client manager unit 1750 or external platforms engine 1725 stores the keys 1518 in client account 1642 or external platform account 1642 created 2908, 3009, 3108.

In certain culminations, security engine 1760 in conjunction with external platforms engine 1725 can register an external platform on a platform register 3102. Depending on the type of materialization, it may be the implementation of security engine 1760 that establishes a secure connection 1511 between external platform 1660 and a particular server system 1800 that in turn establishes a secure connection 1511 via a public network between external platform 1660 and central server network 1501.

In the identification processes (FIG. 32), (FIG. 33), security engine 1760 can receive requests with an encapsulated identifier 1521 from client manager unit 1750 or external platforms engine 1725 to locate a client 1642 account or an external platform account 1642 respectively 3204, 3304. In certain materializations, in the identification of an external platform 1660 (FIG. 33), security engine 1760 may receive identifiers 1521 from both external platform 1660 and client 1640 who wants to perform an operation.

Generally, once requested account 1642 has been located, security engine 1760 forms a single-use random value such as a nonce 3205, 3305, which serves as a challenge to the authentication process. Normally, security engine 1760 sends a message with the nonce encapsulated to client 1640 or external platform 1660 via external interface 1705 that handles the shipment 3205, 3305.

In most implementations, client manager unit 1750 can check whether client 1640 has a wallet 1516 or a local wallet 1517. If this is not the case, client manager unit 1750 asks the security engine 1760 for the private key 1518 encrypted in client account 1642. In general, the security engine 1760 retrieves the encrypted private key 1518 and transfers it to client manager unit 1750.

Client manager unit 1750 or external platform engine 1725 can forward the nonce encryption with client's 1640 private key 1518 or external platform 1660 respectively to the security engine 1760. Typically, the security engine 1760 retrieves client's 1640 public key 1518 or external platform 1660 from your account s 1642 and performs 3212, 3308 decryption tests. The security engine 1760 can check if the nonce decryption is successful 3213, 3309.

In the event that the data sent by client 1640 or external platform 1660 cannot be decrypted or, even if the data is decrypted, does not match the nonce sent, security engine 1760 can report the security incident to client manager unit 1750 or external platforms engine 1725. Generally, the security engine 1760 can allow the process to be repeated a maximum of n attempts 3214, 3310. Once this threshold is exceeded, the identification process is interrupted and the security engine 1760 can note the incident in the relevant security logs 3215, 3315 and generate a message to client manager unit 1750 or external platforms engine 1725 that the authentication has not been successful. In some implementations security engine 1760 blocks client 1642 account or external platform account 1642 temporarily or permanently depending on the risk control rules established in the 3216, 3316 system.

Based on this implementation, if decryption is successful, the security engine 1760 determines that successful authentication of client 1640 or external platform 1660 has occurred and proceeds to the opening of a session 3217, 3311. In the case of identification of an external platform 1660, security engine 1760 can check whether client ID 1521 sent from external platform 1660 at the request of client 1640 matches 3312 with that of one of its New Money accounts 1642 and start a registration process (FIG. 19), (FIG. 29), (FIG. 30) or an identification process (FIG. 32).

In a majority of executions, security engine 1760 performs tasks relating to the confidentiality of operations (FIG. 34). External interface 1705 can send the security engine 1760 an operation that a user 1520 wishes to perform. Security engine 1760 can initiate the testing of a number of operation-related parameters to determine whether a suspicious transaction 3402 is for example, but not limited to, an abnormally large amount transferred or transactions from a location not recognized by the user 1520. In the event of an anomaly being detected, security engine 1760 will normally record the event in the appropriate safety logs 3403.

Otherwise, the securitization process of the operation begins, normally security engine 1760 generates a symmetric single-use key 3404. Security engine 1760 then retrieves the relevant server system 1800 public key 1518 and encrypts 3405 the single-use symmetric key with this public key 1518. In most implementations, the security engine 1760 performs a similar process by retrieving 3406 the public key 1518 from client account 1642 or external platform account 1642 and encrypting the one-time symmetric key with the recovered 3407 public key 1518. Security engine 1760 then encrypts the operation with the symmetric key 3408.

For certain materializations, the set of encryptions of the symmetric key is linked to the operation encrypted in the corresponding register 3409 and the symmetric key is destroyed without encryption 3410.

Security engine 1760 can manage all the information necessary for the proper functioning of this invention, particularly the safety of all central server network systems 1700. Security engine 1760 generally handles and analyzes incoming requests to the system, as well as security checks according to a number of rules. In general, security engine 1760 is present in a majority of system processes and can carry out various operations at different levels. Security engine 1760 can build new data structures and transmit them to other systems usually via internal links, or via external interface 1705. In a majority of culminations, security engine 1760 can follow a set of instructions stored in the memory 1702 that can be executed by processor 1701, and security engine 1760 can be defined as a set of instructions that can be executed by processor 1701.

FIG. 18 shows, as an example, the architecture of a computer calculation system of a server system 1800. The calculation system can be used independently or in multiprocessor systems to perform the necessary calculations according to the algorithms required.

Computing system of the server system 1800 can take any suitable physical or virtual form. For example, and without limitation, it can be an integrated computer system, a system on chip (SOC), a single board computer system (SBC), such as a desktop computer system (PC), or a modular system (SOM), a laptop or notebook computer system, an interactive kiosk, a central computer, a network of computer systems, a mobile phone, a desktop computer, a virtual server or any other system suitable for the proper functioning of the invention. Also, in some implementations the system may be based on a quantum computing architecture.

When required, the computer calculation system of server system 1800 may include one or more computing systems, be single or distributed, span multiple locations, run on physical or virtual servers, span multiple machines or multiple data centers, or reside in a server cloud, which may include one or more cloud components on one or more networks. When required, one or more computer calculation systems of server system 1800 may perform without substantial spatial or temporal limitation one or more steps of one or more methods described or illustrated in this document. One or more computer calculation systems of server system 1800 can perform one or more steps of one or more of the described methods in real time or in batches. Typically, one or more computer calculation systems of the server system 1800 can perform at different times or different locations one or more steps of one or more of the methods described or illustrated in this technical note.

In some implementations the computer calculation system of server system 1800 may include a CPU 1801, memory 1805, storage unit 1809, I/O interface 1808, communication interface 1810, and I/O bus or peripheral bus 1806. This particular materialization describes and illustrates a particular computer calculation system of server system 1800, which has a particular number of components, yet it contemplates and supports any usable computer system that has an appropriate number of components, in any configuration that is usable for the calculations described.

In particular, CPU 1801 includes hardware and software elements for executing instructions written in a computer program. As an example and without limitation, the calculation system may retrieve instructions from an internal registry, cache memory register, RAM memory register or any storage system 1809, decode them, run them and then write one or more results to a file, internal registry, cache memory, memory or storage system 1809.

In certain materializations, CPU 1801 may include one or more internal cache memories for data, instructions or addresses. Data caches can speed up read or write operations by CPU 1801. There may be Translation Lookaside Buffers (TLBs), which can speed up the translation of virtual addresses for CPU 1801 processor. In particular, CPU 1801 may include one or more of the following items, data records, instructions, or addresses.

Typically, the CPU can include one or more arithmetic logic units (ALUs) 1803, be a multi-core process, or include one or more CPUs 1801. Although a particular processor is described and illustrated, this technical note considers any processor that is appropriate for the required computing needs.

The main memory 1805 includes the necessary memory that stores the instructions for processor to run, storing data for CPU 1801. The computer calculation system of server system 1800 can load instructions from the storage system 1809 or any other source, such as another computer calculation system of server system 1800, into the main memory 1805.

Normally, CPU 1801 can then load instructions from the main memory 1805 into an internal register, or cache. In some cases, to execute instructions, CPU 1801 can retrieve the instructions from its own internal registry and decode them. During or after the execution of instructions, CPU 1801 can write, one or more results which may be intermediate or final results, to the registry or internal or cache. CPU 1801 can then write one or more of these results to main memory 1805. In particular, CPU 1801 executes only instructions in one or more internal instructions, registers, internal caches or in main memory 1805.

The input/output bus 1806 can include one or more memory buses 1806, which individually can include an address bus and a data bus, and can associate to CPU 1801 to main memory 1805.

In some designs, one or more control units 1802 such as memory management units (MMUs) reside in CPU 1801 and provide easy access to main memory 1805. Normally, access is requested by CPU 1801 processor. Main memory 1805 can include one or more random access memories (RAMs). Depending on the type of implementation, this RAM can be either Dynamic RAM (DRAM) or Static RAM (SRAM). In addition, where applicable, this RAM may be single-port or multi-port. Any RAM suitable for the need is considered, and compatible with the rest of the components of the computer calculation system of server system 1800.

Storage system 1809 includes mass storage of data or instructions. As an example and without limitation, storage system 1809 may include a hard disk drive (HDD), solid state drive (SSD), RAID storage systems, a flash memory, an optical disk, a magneto optical disk, a magnetic tape, or a universal serial bus (USB) drive or a combination of two or more of these storage devices.

Depending on the material, storage system 1809 may be removable or non-removable. Storage system 1809 may contain caches where applicable, which may be implemented in other parts of the computer calculation system of server system 1800. As an example and without limitation, CPU 1801 may include one or more instruction caches, one or more data caches and one or more translation buffers (TLBs). Instructions in the instruction caches can be copies of the instructions in the main memory 1805 or storage system 1809, and the instruction caches can speed up the retrieval of those instructions by CPU 1801. Data stored in the data cache may be copies of data in main memory 1805 or storage system 1809 for instructions running on CPU 1801, results of previous instructions may run on the CPU 1801, for access via subsequent instructions running on CPU 1801 or for writing to main memory 1805 or storage system 1809. Depending on the type of implementation, storage system 1809 may be internal or external to the computer calculation system of the server system 1800. Normally storage system 1809 is a non-volatile solid-state memory. Storage system 1809 may contain a read-only memory (ROM) which may be ROM with mask, programmable ROM (PROM), erasable PROM (EPROM), electrically erasable PROM (EEPROM), electrically modifiable ROM (EAROM), or flash memory or a combination of two or more memory units. A storage system 1809 or computer-readable non-transient media may include one or more semiconductor-based integrated circuits or other integrated circuits (ICs) such as, for example, Field programmable gateway arrays (FPGAs) or application specific integrated circuits (ASICs), hard disk drives (HDDs), hybrid hard disk drives (HHDs), optical disks, optical disk drives (ODDs), magnetos or magnetic-optical disks.

This revelation contemplates a storage system 1809 that can be of great capacity taking any usable physical or virtual form. Storage system 1809 may include one or more storage control units to facilitate communication between CPU 1801 and storage system 1809. A particular storage system 1809 is described and illustrated in this disclosure, although any proper storage is contemplated in the invention.

Typically, Input/Output 1808 interface (I/O interface) consists of hardware, software, or a combination of both, providing one or more interfaces for communication between the computer calculation system of server system 1800 and one or more input/output devices. The computer calculation system of server system 1800 generally includes one or more of these input/output devices if applicable. One or more of these I/O devices may allow communication with a particular computer calculation system of server system 1800. As an example and without limitation, the I/O device may include a keyboard, keyboard, microphone, microphone, monitor, monitor, mouse, printer, scanner, speaker, still camera, camera, pen, tablet, touch screen, trackball, video camera, biometric device, other suitable I/O device or a combination of two or more of these devices. An I/O device may include one or more sensors. In this invention, all suitable I/O devices and input/output 1808 interfaces suitable for them are covered. In some cases, I/O interface 1808 may include one or more device drivers or software that allow CPU 1801 to control one or more of these I/O devices. Input/output interface 1808 can include one or more input/output interfaces 1808 when required. Although this technical note describes and illustrates a particular input/output interface 1808, the invention contemplates any input/output interface 1808 suitable for the needs of the server system's computing system 1801.

In some implementations, communication interface 1810 includes hardware, software or a combination of both that provide one or more interfaces for communication 1810, for example, but not limited to, packet-based communications between the computer calculation system of server system 1800 and one or more computer calculation system of the server systems or another network. As an example, communication interface 1810 may include a network interface driver (NIC) or a network adapter to communicate with an Ethernet or other wired network or a wireless NIC adapter (WNIC) or a wireless adapter to communicate with a wireless network, such as a WI-FI network. This implementation contemplates any suitable network and any suitable communication interface for it. As an example, a low number of contacts bus (LPC), a memory bus, a Micro Channel Architecture (MCA) bus, a Peripheral Component Interconnect (PCI) bus, a PCI-Express (PCie) bus, an advanced technology attachment (SATA) serial bus or a Video Electronics Bus (VLB) from the Standards Association, VESA or other suitable bus or a combination of two or more of these. In general, communications interface 1810 may include one or more communications buses. Although this technical note describes and illustrates an communications interface 1810 with one or more particular bus(s), it covers any communications interface 1810 with any bus or interconnection suitable for the need and compatible with the rest of the components of the computer calculation system of server system 1800.

FIG. 19 shows a flowchart of client 1640 administrative registration process 1900, in order to access the services provided by central server network systems 1700. A variety of systems such as client management unit 1750, network engine blockchain 1755 or the security engine 1760 can be involved in administrative registration process 1900.

For most materializations, the process begins with the receipt of a request from client 1902 at external interface 1705. External interface 1705 can analyze the content of the request and transfer it to blockchain network engine 1755 which, in general, together with security engine 1760, carries out the request security processes and coordinates the request between the different computer systems of central server network 1501. Following this disclosure, if the request has passed the security processes, client management unit 1750 together with security engine 1760 can check whether there is an account 1642 associated with client 1903 normally through a identifier 1521, in this operation client management unit 1750 generally sends an instruction to blockchain network engine 1755 to obtain the information from the relevant records, particularly from blockchain 1756. If a client 1640 is registered, the process ends in 1912. If client 1640 is not registered, client management unit 1750 can request that client 1640 via external interface 1705, send their contact information. According to the disclosure, client 1640 can transmit the contact data 1904 to server backbone 1501 and external interface 1705 can transfer it to client management unit 1750. Client management unit 1750 can require client 1640 to send the necessary documentation via external interface 1705. According to this disclosure, client 1640 can transmit the documentation 1905 to the server backbone 1501 and external interface 1705 can transfer it to client management unit 1750. Generally, external interface 1705 previously sends this data securely to network engine blockchain 1755 which together with security engine 1760 manages the homogeneous transfer of all information through the different server systems 1800.

In this particular process, once client management unit 1750 has received the necessary data from client 1640, data and documentation 1906 are verified and contrasted. In the most common implementations, client management unit 1750 may send instructions to external platform engine 1725 to obtain information necessary for verification process 1906, these operations may require connections with external entities. Normally external platform engine 1725 can send requirements to external entities through external interface 1705. Once external platform engine 1725 retrieves the necessary information, it communicates it to client management unit 1750.

Following administrative registration process 1900, client management unit 1750 can validate the contact details 1907. Normally client management unit 1750 compares the contact data provided by client 1640 with that obtained by external platform engine 1725. Other systems in central server network 1700, such as blockchain network motor 1755 or security motor 1760, can be involved in this process. If the contact details do not pass the validation tests, client management unit 1750 can build requests in a suitable format to request client 1640 to correct incorrect data 1909. In most cases, client management unit 1750 sends the request via external interface 1705.

If the contact details of client 1640 do pass the validation process 1907, the flow continues with the validation of identification data 1908. Generally, the identification data can be validated by client management unit 1750. In a common process, client management unit 1750 compares the identification data provided by client 1640 with that obtained by external platform engine 1725. Other systems in central server network 1700, such as blockchain network motor 1755 or security motor 1760, can be involved in this process. If the identification data does not pass the validation tests, client management unit 1750 can form requests in a suitable format to request client 1640 to forward required documentation 1909. In most cases, client management unit 1750 sends the request via external interface 1705.

If both contact data and identification data have passed the validation process, the administrative registration process is deemed to have been passed, and the systems of central servers network 1700 already have all the necessary information. In this particular case, opening procedure 1910 for a client account 1642 is started, usually by creating a new account 1642 in the corresponding records, particularly a blockchain 1756. Several systems can be involved in the account opening process, such as client management unit 1750, blockchain network engine 1755 or security engine 1760. In most implementations, procedure for opening a client account 1910 is linked to the generation of a registration key or identifier 1521. Generally, client management unit 1750 manages and forms these identifiers 1521, and is responsible for sending them to client 1640 via external interface 1705 so that they can be identified in future operations.

If either the contact data or identification data do not pass the validation process and a request is sent to client 1640 to correct the errors found in 1909, client management unit 1750 can normally wait for a certain period of time to receive new data corrected 1911 by client 1640 via external interface. Depending on the type of materialization, if client 1640 sends new documentation, the process can return to step 1907, where client management unit 1750 checks the contact details. According to this disclosure, if client 1640 does not send any documentation within the established time frame, administrative discharge process 1900 ends 1912.

Modifications, additions or omissions may be made to the methods described herein without deviating from the scope of the invention. For example, the steps can be combined, changed or deleted where appropriate, and additional steps can be added. In addition, the steps may be carried out in any order that is appropriate without deviating from the scope of the present invention.

Although the present invention has been described with several implementations, a myriad of changes, variations, alterations, transformations and modifications may be suggested by an expert in this field, and it is intended that the present invention encompasses such changes, variations, alterations, transformations and modifications to the extent that they are contained in the claims accompanying the present document.

FIG. 20 illustrates an example of a flowchart for the expansion of investment vehicle 1630 as a result of the need to issue new units of New Money 1530. In some implementations the operations are mostly managed by the management unit of investment vehicle 1745 which is the one that normally performs the operations related to investment vehicle 1630, acquiring assets on asset market 1650 which generally implies that the volume of investment vehicle 1630 is increased, or volume of the investment vehicle 1630 is reduced by the sale of assets on asset market 1650.

The process starts in step 2002 where the management unit of investment vehicle 1745 receives a request that normally comes from either transaction and calculation engine 1735, internal trading platform 1740 or external platform engine 1725 and that in this illustration can be of two types 2002, type 1 which is a request for calculating the value of a New Money 1530 currency unit, and type 2 which is a purchase order.

Once the request has been received, regardless of whether it is type 1 or type 2, it is checked in step 2003 as to whether it is possible to calculate the price of New Money 1530 currency unit or whether it is feasible to acquire assets on asset market 1650. This task is generally carried out by the management unit of investment vehicle 1745 and neither of the two operations can be carried out when the market is closed, when there is a critical situation where it is recommended that no assets be acquired on asset market 1650, when the evolution of the aggregate balance of supply and demand of New Money 1530 so advises or for any technical, economic or other circumstance that would inspire it not to acquire assets in market for assets 1650. Thus, for example, it may be the case that certain circumstances may cause a sudden movement in the markets, so that, temporarily, it is not advisable to acquire assets on asset market 1650, since otherwise clients 1640 who already own New Money 1530 units may be adversely affected.

In some implementations in step 2004 investment vehicle management unit 1745 usually reports, depending on the case, either to transaction and calculation engine 1735 or to investment vehicle 1745, either internal exchange platform 1740 or external platform engine 1725 that the request cannot be answered whether it be type 1 or type 2 because the system is blocked because the markets are closed, because a critical situation exists or because of any circumstance that could condition the development of the process. In this case, the process is completed in 2017 and the investment vehicle's management unit can communicate the reasons for this. Otherwise, when the markets are neither closed, nor are there any critical situations, nor are there any conditioning factors that prevent the acquisition of assets or prevent the determination of the unit price, the process generally continues in the 2005 step, where the management unit of the investment vehicle 1745 interacts with transaction and calculation engine 1735 in order to discriminate if the required demand for New Money 1530 money units is below a security threshold that the system has established. If the demand is above the security threshold, according to some implementations, a non-automatic asset price determination process may be initiated in 2006, while if the demand for New Money 1530 monetary units is below the threshold, the investment vehicle's management unit 1745 may, depending on the implementations, either directly or by sending an order to transaction and calculation engine 1735, launch an automatic process so that, applying the established calculation algorithms and depending on the type of investment established by the investment vehicle 1630 and the situation of asset market 1650, seek the best possible combination of assets in order to optimize the acquisition of these assets 2007. According to some implementations, external interface 1705 is the one in charge of obtaining asset market 1650 information required by the system by means of a connection with the associated markets.

Generally, once the assets to be purchased are selected and the price of these is known in 2008, transaction and calculation engine 1735 determines the price, in the standard currency of managing entity 1610, of New Money 1530 units that can be generated to satisfy the demand of a client 1640. This calculation is not automatic if the number of units of New Money 1530 is above the threshold set in step 2005.

According to some materializations in step 2009, there is discrimination whether the request is of type 1: which consists of determining the price of additional units of New Money 1530, or of type 2: which consists of the acquisition of new assets to be added to investment vehicle 1630. If the request is for type 1, the managing unit of investment vehicle 1745 refers, in step 2010, to transaction and calculation engine 1735 the value of New Money 1530 monetary unit in the standard currency in which the managing entity 1610 works, the process being completed in 2017. If the request is type 2, the process of acquiring assets to be incorporated into the investment vehicle 1630 is generally initiated to allow additional units of New Money 1530 to be generated.

According to some implementations the process can continue with step 2011 where investment vehicle management unit 1745 checks whether the price of a New Money 1530 unit has changed from the one previously communicated to the system. This verification is necessary because from the time client 1640 is notified of the cost of purchasing New Money 1530 until the time client 1640 decides to order the purchase, the prices and circumstances of asset market 1650 may vary. For example, there may be circumstances in which markets have closed during this time. If the price changes the process may be started again because the new cost of the purchase of New Money 1530 has to be again communicated to client 1640. In some cases, certain engines or system operators 1700, or directly investment vehicle management unit 1745, can communicate to client 1640 via external interface 1705 if new circumstances on asset market 1650 prevent the acquisition. If the price has not changed and market circumstances do not prevent or discourage the acquisition of assets, the management unit of investment vehicle 1745 may be connected to the financial markets' trading services in 2012 in order to carry out the required asset purchase. In step 2013, the acquisition of the assets is specified, which may be automatic or non-automatic depending on whether the required volume is lower or higher than the threshold established by the system.

In certain implementations the process continues with step 2014 where investment vehicle management unit 1745 connects to depository entity engine 1715 to require it to manage the payment of the assets to be acquired on the asset market 1650. Once the assets have been paid, the management unit of investment vehicle 1745 can be reconnected to depository entity engine 1715 to receive the new assets and add them, properly sorted and classified 2015, to the investment vehicle 1630.

In some implementations the process continues with step 2016 where the investment vehicle management unit 1745 may require the money unit manager 1730 to issue New Money 1530 units corresponding to the acquisition of assets made and then deliver them to client 1640. The money unit manager 1730 may require the calculation and transaction engine 1735 to create a specific transaction for the generation of the established New Money 1530 units. In some cases, the currency unit manager 1730 may communicate such an operation to the blockchain network engine 1755 for updating New Money 1530 accounts.

FIG. 21 illustrates an example of a flowchart for the decrease in the investment vehicle as a result of the need to reduce the number of existing New Money 1530 units. In some implementations the operations are mostly managed by the management unit of the investment vehicle 1745 which is the one that normally carries out the operations related to the investment vehicle 1630, either by acquiring assets on the asset market 1650 which generally implies that the volume of the investment vehicle 1630 is increased, or by reducing the volume of the investment vehicle 1630 through the sale of assets on the asset market 1650.

The process starts in step 2102 where the managing unit of investment vehicle 1745 receives a request normally coming from either the trading and calculation engine 1735, the internal trading platform 1740 or external platform engine 1725, which can generally be of two types 2102, type 1 which is a request for calculating the value of a New Money currency unit 1530, and type 2 which is an order for the sale of assets.

Once the request is received, whether it is type 1 or type 2, step 2103 checks whether it is possible to calculate the price of New Money 1530 currency unit or whether it is feasible to sell assets on the asset market 1650. It is generally the management unit of the investment vehicle 1745 that is responsible for this task and neither of the two operations can be carried out when the market is closed, when there is a critical situation where no sale of assets on the asset market 1650 is recommended, when the evolution of the aggregate balance of supply and demand of New Money 1530 so advises or for any technical, economic or other circumstance that would inspire not to dispose of assets on the asset market 1650. Thus, for example, it may be the case that certain circumstances cause a sudden movement in the markets so that, temporarily, it is not advisable to sell assets on the asset market 1650 because otherwise it may be detrimental to clients 1640 who own New Money 1530 units.

In some implementations in step 2104, the management unit of investment vehicle 1745 can inform either the transaction and calculation engine 1735, if applicable, the internal exchange platform 1740 or external platform engine 1725 which cannot respond to the request, either type 1 or type 2, because the system is blocked because the markets are closed, because a critical situation exists or because there is a circumstance which hinders or conditions the process. In this case, the process is terminated 2117, and the investment vehicle management unit 1745 may communicate the reason for termination. Otherwise, when the markets are neither closed nor in a critical situation, nor are there circumstances that could condition or block the development of the process, it generally continues in step 2105, where the management unit of the investment vehicle 1745 interacts with the transaction and calculation engine 1735 in order to discriminate whether the volume of the order for the sale of New Money 1530 monetary units is below a security threshold that the system has established. In the case of the volume being above the security threshold, according to some implementations, a non-automatic process of determining the sale price of assets 2106 can be initiated, while if the volume of monetary units of New Money 1530 is below the established threshold, the management unit of the investment vehicle 1745, either directly or by sending an order to the transaction and calculation engine 1735, can launch an automatic process so that, by applying the established calculation algorithms and depending on the asset market 1650 situation, those assets of the investment vehicle 1630 whose sale optimizes the value and performance of the investment vehicle 2107 are selected. According to some implementations it is external interface 1705, through connection with the associated markets, that obtains the information from the asset market 1650 that the system requires.

Generally, once the assets to be sold have been selected and the price of these is known, the process continues with step 2108, where the transaction and calculation engine 1735 can determine the price, in the standard currency of the managing entity 1610, of New Money 1530 units to be eliminated. This calculation may be non-automatic if the number of New Money 1530 units is above the threshold set in step 2105.

According to some materializations in step 2109, there is discrimination whether the request is of type 1: which consists of determining the price of New Money 1530 units to be eliminated, or of type 2: which consists of the sale of assets to reduce the volume of the investment vehicle 1630. If the request is for type 1, in step 2110 the investment vehicle management unit 1745 can refer to the transaction and calculation engine 1735 the value of New Money 1530 currency unit in the standard currency in which the managing entity 1610 works, and the process is completed in 2117. If the request is type 2, the process of selling the assets to be subtracted from the investment vehicle 1630 is generally initiated in order to generate fiat money 1532 or crypto-currency 1531 to compensate client 1640 for New Money 1530 units it delivers to the managing entity 1610.

According to some implementations the process can proceed to step 2111 where the investment vehicle management unit 1745 verifies whether the price of New Money 1530 unit has changed from the one previously reported to the system. This verification is necessary because from the time client 1640 is notified of the amount he was going to obtain from the sale of his New Money 1530 units to the time client decides to order the sale, prices and circumstances of the asset market 1650 may vary. For example, there may be circumstances in which markets have closed during this time. If the price changes, the process is started again, as the new amount to be received as consideration for the sale of New Money 1530 must be communicated to client 1640. In some implementations, certain engines or system managers 1700, or the investment vehicle management unit 1745 directly, can communicate to client via external interface 1705 if new circumstances arise on the asset market 1650 that prevent the sale from taking place. In the event that the price has not changed, and market circumstances permit the sale of assets, the management unit of the investment vehicle 1745 can be connected to the purchase and sale services of the financial markets 2112 in order to materialize the required sale of assets. Step 2113 specifies the sale of assets, which may be automatic or non-automatic depending on whether the volume required is lower or higher than the threshold set by the system.

In certain implementations the process may continue with step 2114 where the management unit of the investment vehicle 1745 connects to depository entity's engine 1715 to require it to remove the assets to be disposed of from the investment vehicle 1630 and deliver them to the asset market 1650.

Generally, once the assets have been delivered, the management unit of the investment vehicle 1745 is connected again to depository entity's engine 1715 to manage the collection of the assets that have been sold and to add the amount to the fiat money 1532 or crypto-currency accounts of the investment vehicle 2115.

In some materializations, the process continues with step 2116 where the management unit of the investment vehicle 1745 may require the manager of the monetary unit 1730 to eliminate New Money 1530 units that correspond to the sale of assets made and that have previously been delivered by client 1640 to the managing entity 1610. The money unit manager 1730 may require the calculation and transaction engine 1735 to create a specific transaction for the destruction of the established New Money 1530 units. In some cases, the currency unit manager 1730 may communicate such an operation to the blockchain network engine 1755 to update New Money 1530 accounts.

Modifications, additions or omissions may be made to the methods described herein without deviating from the scope of the invention. For example, the steps can be combined, changed or deleted where appropriate, and additional steps can be added. In addition, the steps may be carried out in any order that is appropriate without deviating from the scope of the present invention.

Although the present invention has been described with several implementations, a myriad of changes, variations, alterations, transformations and modifications may be suggested by an expert in the field, and it is intended that the present invention will encompass such changes, variations, alterations, transformations and modifications to the extent that they are contained in the claims accompanying the present document.

According to some implementations, New Money 1530 can be acquired and sold in the following ways, among others: buying it or selling it to the system's managing entity 1610, which will normally involve the generation or reduction of New Money 1530 units, usually using fiat money 1532 or crypto-currency 1531 as payment, this process can in turn be implemented by means of the direct services offered by the managing entity 1610, by means of external platforms 1660, so that it is external platform 1660 that acts as an intermediary between client 1640 and the managing entity 1610; acquiring or selling New Money 1530 units in the pair to pair market, normally using fiat money 1532 or other crypto-currencies 1531 as payment through the internal platform provided by the managing entity 1610 and by means of external exchange platforms 1660; receiving or sending units of New Money 1530 in exchange for any type of transaction: purchase and sale of goods or services, donations, etc., by means of the internal platform provided by the managing entity 1610 and by means of external exchange platforms 1660.

FIG. 22 illustrates an example of a flowchart of a purchase of New Money 1530 by a client 1640, from the managing entity 1610, using the services provided by the managing entity 1610. Client 1640 may use for the acquisition of New Money 1530 both fiat money 1532 currencies and crypto-currencies 1531 as long as they appear in the list of currencies accepted by the managing entity 1610.

According to some implementations the process is started in step 2202 where the transaction and calculation engine 1735 issues a query to the investment vehicle management unit 1745 to see if it is possible to extend the investment vehicle 1630 in order to meet a possible demand from a client 1640 to purchase New Money 1530 units. The management unit of the investment vehicle 1745 may reply that the system is blocked because the market is closed or there is a critical situation where it is recommended that no asset purchases be made on the asset market 1650, or the evolution of the aggregate balance of supply and demand of New Money 1530 due to advice or for any technical, economic or other circumstance that inspires not to acquire assets on the asset market 1650, so that the purchase operation cannot be carried out by client 1640 and the process ends 2224. The management unit of the investment vehicle 1745 can also answer that the system is not blocked and that it is possible to meet client's 1640 demand and therefore the process can continue with the next step.

In certain materializations, once it is verified that it is possible to acquire assets on the asset market 1650 in order to expand the investment vehicle 1630, in step 2203 external interface 1705 can manage the reception of requests 1644 by a client who wishes to acquire new New Money 1530 units.

According to some implementations the process continues with step 2204 where, generally, external interface 1705 makes a call to client management unit 1750 in order to discriminate the status of client 1640. In certain cases, external interface 1705 can transfer the request 1644 to the security engine 1760, so that it can handle the necessary management of the request 1644, usually next to the blockchain network engine 1755. If client 1640 is not registered in the system, he or she may be asked to register (FIG. 19) and New Money 1530 purchase process may be completed. If client 1640 is already registered, the process can be continued in step 2205 where client management unit 1750 sends a request to the security engine 1760 to check the security parameters of client 1640 (FIGS. 29 and 30). Once the security engine 1760 conforms to client 1640 security the process can continue to step 2206 where client management unit 1750 determines the number of New Money 1530 units that client 1640 wishes to purchase. In step 2207 client management unit 1750, normally via external interface 1705, can receive the selection of the currency or crypto-currency that client 1640 wishes to use for the acquisition of New Money 1530. Client 1640 may use for the acquisition of New Money 1530 both fiat money 1532 currencies and crypto-currencies 1531 to the extent that they appear in the list of currencies accepted by the managing entity 1610.

Depending on certain materializations the process continues with step 2208 where the transaction and calculation engine 1735 can re-issue a query to the management unit of the investment vehicle 1745 to see if it is possible to extend the investment vehicle 1630 in order to satisfy client demand 1640 to purchase units of New Money 1530. This check is necessary because from the time the system is verified as operational until the time client 1640 decides to order, the circumstances of the asset market 1650 may have changed. For example, there may be circumstances in which markets have closed during this time. The management unit of the investment vehicle 1745 may reply that the system is blocked because the market is closed or there is a critical situation where it is recommended that no asset purchases be made on the asset market 1650, or the evolution of the aggregate balance of supply and demand of New Money 1530 so advises or for any technical, economic or other circumstance that inspires not to acquire assets on the asset market 1650, so that the purchase operation cannot be carried out by client 1640 and the process ends 2224. The management unit of the investment vehicle 1745 can also answer that the system is not blocked and that it is possible to meet client demand 1640. In this case, according to some implementations, the transaction and calculation engine 1735 normally issues a request to the management unit of the investment vehicle 1745 or the manager of the monetary unit 1730 to provide the value of New Money 1530 monetary unit in the standard currency in which the managing entity 1610 works.

In some implementations, once it has been verified that it is possible to acquire assets on the asset market 1650 and that the price of New Money 1530 currency unit has already been calculated in the standard currency of the managing entity 1610, in step 2209 the transaction and calculation engine 1735 can send a request to the FX Market Tracking Engine 1720 to provide the quote for the currency or crypto-currency in which client 1640 wants to pay for the transaction against the standard currency in which the FX managing entity 1640 operates. In step 2210 the transaction and calculation engine 1735 calculates the value of New Money 1530 unit in the currency requested by client 1640. The process can be continued with step 2211 where the transaction and calculation engine 1735 can calculate the value of the commissions to be charged to client 1640 as a consequence of the acquisition of New Money 1530 from the managing entity 1610, so that later in step 2212, the transaction and calculation engine 1735 can compute the amount in client's 1640 currency that client 1640 must pay for the acquisition of New Money 1530 units. The process can be continued with step 2213 where the transaction and calculation engine 1735 sends to external interface 1705 the amount of fiat money 1532 or crypto-currency 1531 that client 1640 has to deliver as consideration for New Money 1530 that he wants to acquire so that later, in general, external interface 1705 communicates to client 1640 the mentioned amount.

Depending on certain materializations, the process continues with step 2214 where the depositary entity engine 1715 or client management unit 1750 can receive commands from the transaction and calculation engine 1735 to see if a client 1640 has enough money in a given account. Step 2215 illustrates the case where client 1640 does not have sufficient balance. In this case, the transaction and Calculation Engine 1735 may generally require external interface 1705 to notify client 1640 that their New Money 1530 purchase order cannot be executed because their account does not have sufficient balance, informing them that either they increase their balance by the transfer of fiat money 1532 or other crypto-currency 1531 or their order may be rejected for not having sufficient balance. If client does not have an account with the depositary entity 1620, he or she is required to make a transfer directly to the account of the investment vehicle 1632 with the depositary entity 1620.

According to some statements, once client 1640 has sufficient balance in his account or has made the necessary transfer to the investment vehicle account 1632 with depository institution 1620, the process continues with step 2216 where external interface 1705 requires client 1640 to confirm the purchase order. If client 1640 does not confirm the purchase then the process ends 2224. Otherwise, this is when client 1640 confirms the purchase, in certain materializations the process can continue with step 2217, in which the transaction and calculation engine 1735 issues a query to the investment vehicle's management unit to see if it is possible to extend the investment vehicle 1630 in order to satisfy client's 1640 demand to purchase New Money units. This verification is necessary because from the time the system is verified as operational until the time client 1640 decides to order, the circumstances of the asset market 1650 may have changed. The investment vehicle management unit 1745 may respond that New Money 1530 money units cannot be sold at the agreed price, so the process can continue with step 2219 where the investment vehicle management unit 1745 discriminates against the reason that New Money 1530 money units cannot be purchased at the agreed price. If the reason for this is because prices have changed on the asset market 1650, the process takes us back to step 2209 where the market rate for the currency or crypto-currency requested by client 1640 is recalculated in relation to the standard currency of the managing entity 1610. If the cause is that the system is blocked, because the market is closed or there is a critical situation that recommends not making any acquisition of assets on the asset market 1650, or the evolution of the aggregate balance of supply and demand of New Money 1530 advise against it or for any technical reason, economic or other nature that inspires not to acquire assets on the asset market 1650, the purchase transaction by client 1640 cannot be made and the process ends 2224.

The management unit of the investment vehicle 1745 can also answer that the system is not blocked and that it is possible to meet client 1640 demand. In this case the process continues with step 2220, where in the event that client 1640 maintains a fiat money account with depository institution 1643, or has crypto-currency wallets in depository entity 1672 or in the managing entity 1614 the transaction and calculation engine 1735 issues a request to depository entity engine 1715 ordering it to debit client's account with the calculated amount of fiat money 1532 or crypto-currency 1531. Generally, in the event that client 1640 does not have a fiat money account 1643 with the depositary entity or does not have a crypto-currency wallet with the depositary entity 1672 or the managing institution 1614, step 2220 is not necessary, as client 1640 usually transfers the fiat money 1532 or crypto-currency 1531 to the investment vehicle account 1632 with the depositary entity 1620 beforehand.

In general, the process continues with step 2221 where depository entity's engine 1715 credits the account of the managing entity 1619 with the corresponding fees for the transaction carried out. If client 1640 has accounts with client 1640, the process continues with step 2222 where the depositary entity engine 1715 credits the investment vehicle account 1632 with the depositary entity 1620 with the amount resulting from the difference between the amount charged to client 1640 and the fees paid to the managing entity 1610. Generally in the case of client 1640 not having accounts with depository institution 1620, step 2222 is not necessary as client 1640 transfers the fiat money 1532 or crypto-currency 1531 money to the investment vehicle account 1632 at depository institution 1620.

According to some implementations, the process ends with step 2223 where, in general, the depositary entity engine 1715, the transaction and calculation engine 1735 or both transfer the acquired New Money 1530 monetary units to client 1640 account.

Modifications, additions or omissions may be made to the methods described herein without deviating from the scope of the invention. For example, the steps can be combined, changed or deleted where appropriate, and additional steps can be added. In addition, the steps may be carried out in any order that is appropriate without deviating from the scope of the present invention.

Although the present invention has been described with several implementations, a myriad of changes, variations, alterations, transformations and modifications may be suggested by an expert in the field, and it is intended that the present invention will encompass such changes, variations, alterations, transformations and modifications to the extent that they are contained in the claims accompanying the present document.

According to some implementations, New Money 1530 can be acquired and sold in the following ways, among others: buying it or selling it to the system's managing entity 1610, which will normally involve the generation or reduction of New Money 1530 units, usually using fiat money 1532 or crypto-currency 1531 as payment, this process can in turn be implemented: by means of the direct services offered by the managing entity 1610 and by means of external platforms 1660, so that it is external platform 1660 that acts as an intermediary between client 1640 and the managing entity 1610; acquiring or selling New Money 1530 units in the pair to pair market, normally using fiat money 1532 or other crypto-currencies 1531 as payment; through the internal platform provided by the managing entity 1610; by means of external exchange platforms 1660; receiving or sending units of New Money 1530 in exchange for any type of transaction: purchase and sale of goods or services, donations, etc., by means of the internal platform provided by the managing entity 1610 and by means of external exchange platforms 1660.

FIG. 23 illustrates an example of a New Money 1530 sale flowchart from a client 1640 to the managing entity 1610 using the services provided by the managing entity 1610. Client 1640 may receive for the sale of New Money 1530 both fiat money 1532 currencies and crypto-currencies 1531 to the extent that they appear in the list of currencies accepted by the managing entity 1610.

According to some implementations the process is initiated in step 2302 where the transaction and calculation engine 1735 issues a query to the investment vehicle management unit 1745 to check whether it is possible to make a partial sale of the investment vehicle 1640 in order to satisfy a possible request from a client 1640 to dispose of New Money 1530 units. The management unit of the investment vehicle 1745 may respond that the system is blocked because either the markets are closed or there is a critical situation where it is recommended that no sale of assets be made on the asset market 1650, or the evolution of the aggregate balance of supply and demand of New Money 1530 so advises or for any technical, economic or other circumstance that inspires not to sell assets on the asset market 1650, so that the sale operation cannot be carried out by client 1640 and the process ends 2324. The management unit of the investment vehicle 1745 can also answer that the system is not blocked and that it is possible to meet client 1640 demand and therefore the process can continue with the next step.

In certain implementations, once it is verified that it is possible to sell assets on the asset market 1650 with the consequent reduction of the investment vehicle 1630, in step 2303 external interface 1705 can manage the reception of requests 1644 by a client 1640 who wants to sell New Money 1530 units.

According to some implementations the process continues with step 2304 where generally external interface 1705 makes a call to client management unit 1750 in order to discriminate the status of client 1640. In certain cases, external interface 1705 can transfer the request 1644 to the security engine 1760, so that it can handle the necessary request management, usually next to the blockchain network engine 1755. If client 1640 is not registered in the system, he or she may be asked to register (FIG. 19) and the process of selling New Money 1530 may be completed. If client 1640 is already registered, the process can be continued in step 2305 where client management unit 1750 sends a request to the security engine 1760 to check the security parameters of client 1640 (FIGS. 29 and 30). Once the security engine 1760 complies with client 1640 security the process can continue to step 2306 where client management unit 1750 determines the number of New Money 1530 units that client 1640 wants to sell. In step 2307 client management unit 1750, normally via external interface 1705, can receive the selection of the currency or crypto-currency that client 1640 wishes to obtain as consideration for the sale of New Money 1530. Client 1640 may receive for the sale of New Money 1530 both fiat money 1532 currencies and crypto-currencies 1531 as long as they are included in the currency ratio accepted by the managing agent 1610.

Depending on certain materializations, the process continues with step 2308 where the depositary entity engine 1715 or client management unit 1750 can receive commands from the transaction and calculation engine 1735 so that in the event that client 1640 has New Money wallets in the depositary entity 1672 or managing entity 1614 they know if they have enough New Money 1530 balance to deal with the transaction. Step 2309 can illustrate the case where client 1640 does not have sufficient balance or New Money wallets in depository entity 1672 or managing entity 1614. In this case, the transaction and calculation engine 1735 may generally require external interface 1705 to notify client 1640 that their New Money 1530 sale order cannot be executed because their account does not have sufficient balance by informing them that they either increase their balance by a transfer or make a New Money 1530 transfer to the investment vehicle accounts 1632 or their order may be rejected for not having sufficient balance.

In some implementations, once client 1640 has sufficient balance in his account or has made the necessary transfer to face the sale, the process continues with step 2310 where the transaction and calculation engine 1735 can reissue a query to the management unit of the investment vehicle 1745 to see if it is possible to dispose of part of the investment vehicle 1630 in order to satisfy client's 1640 requirement to sell New Money units 1530. This verification is necessary because from the moment the system is verified as operational until the moment client 1640 decides to order the sale, the circumstances of the asset market 1650 may have changed. For example, there may be circumstances in which markets have closed during this time. The management unit of the investment vehicle 1745 may respond that the system is blocked because either the markets are closed or there is a critical situation where it is recommended that no sale of assets be made on the asset market 1650, o the evolution of the aggregate balance of supply and demand of New Money 1530 so advises or for any technical, economic or other circumstance that inspires not to sell assets on the asset market 1650, with which the operation of sale on the part of client 1640 cannot be carried out and the process ends 2324. The management unit of the investment vehicle 1745 can also answer that the system is not blocked and that it is possible to meet client's 1640 demand. In this case, depending on some implementations, the transaction and calculation engine 1735 issues a request to the management unit of the investment vehicle 1745 or to the manager of the monetary unit 1730 to provide the value of New Money 1530 monetary unit in the standard currency in which the managing entity 1610 works.

In some implementations, once it has been verified that it is possible to acquire assets on the asset market 1650 and that the price of New Money 1530 currency unit has already been calculated in the standard currency of the managing entity 1610, in step 2311 the calculation and transaction engine 1735 can send a request to the FX Market Tracking Engine 1720 to provide the quote for the currency or crypto-currency that client 1640 has selected in step 2307 in relation to the standard currency in which client 1640 operates. In step 2312 the transaction and calculation engine 1735 calculates the value of New Money 1530 unit in the currency requested by client 1640. The process can continue with step 2313 where the transaction and calculation engine 1735 can calculate the value of the commissions to be charged to client 1640 as a result of the sale of New Money 1530, and then in step 2314, the transaction and calculation engine 1735 can compute the amount in client's 1640 currency to be paid to it for the sale of New Money 1530 units. The process can be continued with step 2315 where the transaction and calculation engine 1735 sends to external interface 1705 the amount of fiat money 1532 or crypto-currency 1531 that client will receive as consideration for the sale of New Money 1530, to be communicated to client 1640 in a suitable format.

According to certain implementations the process continues with step 2316 where external interface 1705 requires client 1640 to confirm the divestiture order. If client 1640 does not confirm the sales order then the process ends 2324. Otherwise, when client 1640 confirms the sale, the process can continue with step 2317 in which external interface 1705 transmits New Money 1530 sales order issued by client 1640 to the transaction and calculation engine 1735 at the price previously determined. Depending on some materializations the process may continue with step 2318, in which the transaction and calculation engine 1735 issues a query to the management unit of the investment vehicle 1745 to check whether it is possible to sell the monetary units of New Money 1530 for the price agreed upon in order to satisfy client's request 1640. This verification is necessary because from the time the system is verified as operational until the time client decides to order the sale, the circumstances of the asset market 1650 may have changed. The management unit of the investment vehicle 1745 can answer that the monetary units of New Money 1530 cannot be sold at the agreed price, so the process can continue with step 2319 where the management unit of the investment vehicle 1745 discriminates the reason why the monetary units of New Money 1530 cannot be sold at the agreed price. If the reason for this is because prices have changed on the asset market, the process takes us back to step 2311 where the exchange rate or crypto-currency market rate of the currency or crypto-currency requested by client 1640 is recalculated in relation to the standard currency of the managing entity 1610. If the cause is that the system is blocked, because either the markets are closed, or there is a critical situation that recommends not to sell assets on the asset market 1650, or the evolution of the aggregate balance of supply and demand of New Money 1530 so advises or for any technical, economic or other circumstance that inspires not to sell assets on the asset market 1650, then the sale operation cannot be carried out by client 1640 and the process ends 2324.

The management unit of the investment vehicle 1745 can also answer that the price has not changed and that it is possible to meet client's request 1640 at the price previously communicated. In this case the process can continue in step 2320 where the transaction and calculation engine 1735 issues a request to depository entity engine 1715 ordering it to debit client's account 1672 or 1614 with the divested amount of New Money 1530. This step is generally not necessary if client 1640 has previously transferred to the investment vehicle accounts 1632 the amount of New Money 1530 that he wishes to sell. In general, the process can continue with step 2321 where the depositary entity engine 1715 credits the account of the managing entity 1619 with the corresponding fees for the transaction carried out.

The process can be continued with step 2322 where depository entity engine 1715 credits the investment vehicle account 1632 in depository entity 1620 the amount resulting from the difference between the amount charged to client 1640 and the fees paid to the managing entity 1610. This step is generally not necessary if client 1640 has previously transferred the amount of New Money 1530 that he wishes to sell, to the accounts of the investment vehicle 1632. According to some implementations the process ends with step 2323 where, in the event that client maintains an account with the fiat money depositary entity 1643 or has crypto-currency wallets in depository 1672 or the managing entity 1614, the transaction and calculation engine 1735 issues a request to depository entity engine 1715 ordering it to credit the account 1643 with the calculated amount of fiat money 1532 or crypto-currency 1531 corresponding to the sale of New Money. Generally in case client 1640 does not even have a fiat money account with depository entity 1643, nor does he have any crypto-currency wallets in depository entity 1672 or in the managing entity 1614 the transaction and calculation engine 1735 issues a request to depository entity engine 1715 ordering that the calculated amount of fiat money 1532 or crypto-currency 1531 corresponding to the sale of New Money 1530 be credited to external account of client 1640.

According to some implementations, New Money 1530 can be acquired and sold in the following ways, among others: buying it or selling it from the system's managing entity 1610, which will normally involve the generation or reduction of New Money 1530 units, usually using fiat money 1532 or crypto-currency 1531 as payment. This process can in turn be implemented: by means of the direct services offered by the managing entity 1610 and by means of external platforms 1660, so that it is external platform 1660 that acts as an intermediary between client 1640 and the managing entity 1610; acquiring or selling New Money 1530 units in the pair to pair market, normally using fiat money 1532 or other crypto-currencies 1531 as payment; through the internal platform provided by the managing entity 1610; by means of external exchange platforms 1660; receiving or sending units of New Money 1530 in exchange for any type of transaction: purchase and sale of goods or services, donations, and the like by means of the internal platform provided by the managing entity 1610 and by means of external exchange platforms 1660.

FIG. 24 illustrates an example of a flowchart for exchanging New Money 1530 for fiat money 1532 or other crypto-currencies 1531 using the managing entity 1610's internal exchange platform 1740.

According to some implementations the process starts in step 2402 where external interface 1705 receives a request from a client 1640 to make use of services offered by the system 1700. External interface 1705 may determine that the request is intended to place an offer on the internal exchange platform 1740 and, according to some implementations, the process continues with step 2403 where external interface 1705 makes a call to client manager unit 1750 in order to discriminate the status of client 1640. In certain cases, external interface 1705 can transfer the request 1644 to the security engine 1760, so that it can perform the necessary management of the request 1644, usually next to the blockchain network engine 1755. If client 1640 is not registered in the system, he or she may be asked to register (FIG. 19) and the process of placing an offer is usually completed. If client 1640 is already registered, the process continues in step 2404 where client manager unit 1750 sends a request to the security engine 1760 to check the security parameters of client 1640 (FIGS. 29 and 30).

Once the security engine 1760 complies with client 1640 security the process can continue with step 2405 where external interface 1705 can receive an offer to buy or sell a certain amount of New Money 1530 on behalf of a client 1640, offering in return fiat money 1532 or other crypto-currencies 1531 with a specific exchange ratio. For example, a client 1640 wants to buy “N” units of New Money 1530 by offering in return “X” units of dollar for each unit of New Money 1530.

Depending on certain materializations the process can continue with step 2406 where the transaction and calculation engine 1735 can receive requests from the internal exchange platform 1740 for the calculation of the value of the fiat money 1532 counterparty, of crypto-currencies or New Money 1530 corresponding to the amount of New Money 1530 or fiat money 1532 or crypto-currencies that client 1640 wishes to buy or sell with the exchange ratio that client 1640 has determined. The process can be continued with step 2407 where the transaction and calculation engine 1735 performs the calculation of the commissions that client 1640 must pay for the purchase or sale operation of New Money 1530 or fiat money 1532 or 1531 crypto-currencies. Generally the process continues with step 2408 where the transaction and calculation engine 1735 performs the final cost calculation of the final offer of client 1640 for the purchase or sale of New Money, fiat money 1532 or other crypto-currencies 1531.

In certain implementations the process may continue in step 2409 where depending on the type of client account 1643, or wallet if applicable, 1672, 1614, 1516, 1517, the transaction and calculation engine 1735 can send a request to client manager unit 1750, depository entity engine 1715 or external platform engine 1725 in order to check whether client 1640 has enough money in his account. If the answer received is that the balance in client's account is insufficient to make the purchase and sale the process can continue with step 2410 where the transaction and calculation engine 1735 can request through external interface 1705 that client 1640 make a transfer or acquisition of the missing asset that depending on the case may be New Money 1530, fiat money 1532 or other crypto-currencies 1531. If client 1640 has enough balance in his account to deal with the transaction, the operation can continue in step 2411 where according to some materializations the transaction and calculation engine 1735 can receive instructions from the internal exchange platform 1740 to initiate the process of retention in client's 1640 account of the exchange offer issued either of fiat money 1532 or crypto-currencies 1531 for the purchase of New Money 1530 or vice versa. The calculation and transaction engine 1735 can instruct client manager unit 1750 or external platform engine 1725 to perform the currency hold operation.

According to certain materializations the process continues in step 2412 where the transaction and calculation engine 1735 can send commands to the internal exchange platform 1740 to create the offer issued by client 1640 in the internal exchange network 1741

According to some materializations the operation continues with step 2413 where the internal exchange platform 1740 tries to match the exchange offer of New Money 1530 for fiat money 1532 or crypto-currencies 1531 or vice versa with other offers issued by other clients 1640. In the event that the offer is not matched in whole or in part, the internal exchange platform 1740 may re-launch the offer to try to match it with other clients 1640 offers. In the event that the offer is fully or partially matched, the internal trading platform 1740 can make a request 2414 to depository engine 1715 or client manager unit 1750 for the deduction from client's 1640 account of the proportional amount corresponding to the amount that has been matched. The internal trading platform 1740 can send instructions to the transaction and calculation engine 1735 for the aggregation of the transaction to the corresponding records, such as a distributed database in the form of a blockchain. Depending on the type of materialization, the internal exchange platform 1740 may require an update of client 1640 account status to client manager unit 1750, the blockchain network engine 1755 or the appropriate system within the central server system 1700.

In certain cases the process may continue with step 2415 where the internal trading platform 1740 makes a request to depository engine 1715 or client manager unit 1750 to add to the corresponding client 1640 account the amount proportional to the amount that has been matched. The internal trading platform 1740 can send instructions to the transaction and calculation engine 1735 for the aggregation of the transaction to the corresponding records. In certain cases, the internal exchange platform 1740 may require an update of client 1640 account statement to client manager unit 1750 or the blockchain network engine 1755. Normally the process continues with step 2416 where the internal exchange platform 1740 makes a request to the depositary entity engine 1715 or client manager unit 1750 to credit the corresponding account of the managing entity 1619 with the fees charged to clients 1640 for the monetary exchange carried out. The internal trading platform 1740 can send instructions to the transaction and calculation engine 1735 for the aggregation of the transaction to the corresponding records. In certain cases, the internal exchange platform 1740 may require an update of client 1640 account statement to client manager unit 1750 or the blockchain network engine 1755. The process can continue with step 2417 where the internal exchange platform 1740 discriminates whether the offer of client 1640 has been fully or partially matched. If the offer has been partially matched, the internal exchange platform 1740 can generate a new updated offer 2418 and the process starts again in step 2412. If the bid has been fully matched the process is normally completed 2419.

FIG. 25 illustrates an example of a flowchart of a communication process between an external platform 1660 and the central network server 1700 to make secure use of the services implemented by the central network server 1700. According to some implementations, a majority of the protocol is managed by external platform engine 1725, external interface 1705, the security engine 1760 and client manager unit 1750, which handle the secure handling of information exchanged with external platform 1660, external platform 1660 security and client 1640 security. Depending on the type of request, these systems or any other system in the central network server 1700 network can also be responsible for transmitting requests from external platform 1660 to the corresponding system.

The process starts in step 2502 where external interface 1705 usually receives a request from an external platform 1660. External interface 1705 can transfer the request to the security engine 1760 for analysis based on parameters such as physical addresses, IP addresses, digital signatures or any other data needed to certify the security of the request. If the security of the request is guaranteed, in normal operation, the security engine 1760 together with the blockchain network engine 1755 can transfer the request to all necessary server systems 1800. External interface 1705 can send the request to external platform engine 1725, which checks data 2503 concerning external platform 1660 normally by accessing databases that can for example be relational, centralized, distributed, with or without blockchain structure and generally using the services of the network engine blockchain 1855. Depending on the materialization of the system, external interface 1705 or external platform engine 1725 can send the necessary data to the security engine 1760 for the verification of the security aspects 2504 of external platform 1660. External platform engine 1725 can check whether the identification 2503 and security processes 2504 have been passed 2505. If not, the process is terminated, whereas if the result is positive, external platform engine 1725 can normally generate a request to know the data of clients 1640 involved in the operation and transfer it to external platform 1660 via external interface 1705.

Generally, external platform 1660 sends the data 2506 of client 1640 or clients involved in the operation. This data is received by external interface 1705 which can transfer the necessary information 2507 to client manager unit 1750 which verifies the administrative status of client 1640, usually via client manager unit 1750. The process generally continues with step 2508 where, depending on the type of materialization, external interface 1705 or client manager unit 1750 uses the security engine 1760 to perform the relevant safety procedures (FIG. 29), (FIG. 30), (FIG. 32). The process can continue with the verification of the result 2509 of the processes related to client 1640 security. If the safety tests have not been passed, client manager unit 1750 can inform external platform engine 1725 that clients could not be verified. In some cases, external platform engine 1725 can communicate to external platform 1660 parameters that client 1640 authentication has failed. In general, in the event that clients do pass the testing process, client manager unit 1750 reports the success of the transaction to external platform engine 1725. External platform engine 1725 can manage the exchanged information and communications 2510 with external platform 1660 via external interface 1705 and can communicate the operation or information required to the appropriate engine, manager or unit within the system 1700.

In general, the relevant system(s) execute the operations 2511 required by clients 1640 via external platform 1660. The system(s) can communicate the result of the execution of the operation to external platform engine 1725, which can then transfer it to external platform 1660. Normally, external platform engine 1725 handles subsequent communications 2512 with external platform 1660 where you can exchange, for example, data related to commission settlement, request statuses, new communication protocols, updated logs or any other information required for the proper functioning of the process. Normally, after this step, the operation is completed.

According to some implementations, New Money 1530 can be acquired and sold in the following ways, among others: buying it or selling it to the system's managing entity 1610, which will normally involve the generation or reduction of New Money 1530 units, usually using fiat money 1532 or crypto-currency 1531 as payment. This process can in turn be implemented: by means of the direct services offered by the managing entity 1610; and by means of external platforms 1660, so that it is external platform 1660 that acts as an intermediary between client 1640 and the managing entity 1610.

Acquiring or selling New Money 1530 units in the pair to pair market, normally using fiat money 1532 or other crypto-currencies 1531 as payment through the internal platform provided by the managing entity 1610; by means of external exchange platforms 1660. Receiving or sending units of New Money 1530 in exchange for any type of transaction:

purchase and sale of goods or services, donations, and the like can be performed by means of the internal platform provided by the managing entity 1610 and by means of external exchange platforms 1660.

FIG. 26 illustrates an example of a flowchart for the transfer of New Money 1530 from a client1 1640 to a client2 1640, as payment for any type of transaction such as the purchase and sale of goods or services, donations, or other transactions, typically using, depending on the type of implementation, the transaction and calculation engine 1735 together with the managing entity's 1610 internal exchange platform 1740.

According to some materializations the process is initiated in step 2602 where external interface 1705 receives a request from a client1 1644 to make use of services offered by the system 1700. External interface 1705 can determine that the request intends to make a New Money 1530 transfer using the transaction and calculation engine 1735 and the internal exchange platform 1740. According to some implementations the process continues with step 2603 where external interface 1705 makes a call to client manager unit 1750 in order to discriminate client1 status 1640. In certain cases, external interface 1705 can transfer the request 1644 to the security engine 1760, so that it can perform the necessary management of the request 1644, usually next to the blockchain network engine 1755. If client1 1640 is not registered in the system, he or she may be asked to register (FIG. 19) and the process is usually completed. If client1 1640 is already registered, the process continues in step 2604 where client manager unit 1750 transfers to the security engine 1760 a request to check client1's 1640 security parameters (FIG. 32).

Once the security engine 1760 approves client1's security 1640 the process can continue to step 2605 where external interface 1705 can receive a New Money transfer order 1530 from client1 1640 being the transfer recipient client2 1640. For example, client1 1640 wishes to transfer to client2 ‘N’ units of New Money 1530 as payment for the acquisition from client2 of a good, or a service, or simply as a donation or as a consequence of any other business or gratuity.

Depending on certain implementations the flow may continue to step 2606 where external interface 1705 can send the necessary client data2 1640 to client manager unit 1750 in order to discriminate client2 status 1640. In general, external interface 1705 can transfer the request 1644 to the security engine 1760, so that it performs the necessary management of the request 1644, usually next to the blockchain network engine 1755. In case client2 1640 is not registered in the system, client1 1640 can be informed that it is not possible to process his transfer request to client2 1640 since client2 1640 is not registered in the system and normally New Money 1530 transfer process is terminated. If client2 1640 is registered, the process can be continued in step 2607 where client manager unit 1750 sends a request to the security engine 1760 to check client2's 1640 security parameters (FIG. 32).

Once the security engine 1760 confirms its approval of client2's security 1640 the flow can continue in step 2608 where the transaction and calculation engine 1735 performs the calculation of the fees that client1 1640 must pay for New Money 1530 transfer transaction to the managing entity 1610. Generally the process continues with step 2609 where the transaction and calculation engine 1735 counts the final cost of New Money 1530 that client1 1640 will have for the transfer operation to client2 1640.

In some implementations the process can continue in step 2610 where it is checked whether client1 1640 has sufficient balance in his account 1642. To do this, the transaction and calculation engine 1735 can send a request to client manager unit 1750 or to depository entity engine 1715 in order to check whether client1 1640 has enough money in his account. If the response received is that the balance of client1's account 1642 is insufficient to meet the transfer, the process can continue to step 2611 where the transaction and calculation engine 1735 can request via external interface 1705 that client1 1640 make a transfer or acquisition of New Money 1530 and the process generally ends 2617. If client1 1640 has enough money in his account 1642 to deal with the transaction, the transaction can continue in step 2612 where the internal exchange platform 1740 via external interface 1705 requires client1 1640 to confirm New Money 1530 transfer order to client2. If client1 1640 does not confirm the transfer order, the process usually ends 2617. Otherwise, this is when client1 1640 confirms New Money 1530 transfer order to client2, depending on the type of materialization, the flow can continue to step 2613 where the calculation and transaction engine 1735 can be instructed from the internal exchange platform 1740 to initiate the hold process on client1's 1640 account 1642 of the amount of New Money transfer 1530 to be made to client2 1640.

According to certain materializations the process can continue to step 2614 where internal exchange platform 1740, together with depository entity engine 1715 can send instructions to transaction and calculation engine 1735 to make the deduction to client1's account 1642 of the amount of New Money 1530 that has been withheld in step 2613. The internal exchange platform 1740, depositary entity engine 1715 or both can send specific instructions to transaction and calculation engine 1735 for the aggregation of the transaction to the corresponding records, such as a distributed database in the form of a blockchain 1756. Depending on the type of materialization, internal exchange platform 1740 may require an update of client account statement) 1642, client manager unit 1750, blockchain network engine 1755 or the appropriate system within the central server network systems 1700.

Depending on some implementations, the process may continue to step 2615 where internal exchange platform 1740, depository entity engine 1715 or both make a request to client manager unit 1750 to add the amount of New Money 1530 transferred to client2's account 1642 by client) 1640. The internal exchange platform 1740 can send instructions to transaction and calculation engine 1735 for the aggregation of the transaction to the corresponding records. In certain cases, the internal exchange platform 1740 may require an update of client's 1642 account statement to client manager unit 1750 or blockchain network engine 1755.

The process normally continues with step 2616 where internal exchange platform 1740, depository entity engine 1715 or both send instructions to client manager unit 1750 to credit the corresponding account 1619 of client1 1610 with the fees charged to client) 1640 for the transfer of New Money 1530. The internal exchange platform 1740 can send instructions to transaction and calculation engine 1735 for the aggregation of the transaction to the corresponding records.

According to some implementations, the acquisition, disposal and transfer of New Money 1530 can be done either using the internal platform of the managing entity 1610 or using external platforms 1660 outside the managing entity 1610. Regardless of whether clients 1640 access through external platforms 1660 or through the platforms developed by the managing entity 1610, the processes are substantially similar and the procedures in which transactions are managed through external platforms will not be described. However, as an example, FIG. 27 details the transfer of New Money 1530 units from a client) 1640 to a client2 1640, in exchange for any type of transaction: purchase and sale of goods or services, donations, or others using an external platform 1660.

FIG. 27 illustrates an example of a flowchart for the transfer of New Money 1530 from a client) 1640 to a client2 1640, in exchange for any type of transaction such as, among others, the sale and purchase of goods or services or donations, using an external platform 1660.

According to some implementations the process starts with step 2702 where external platform engine 1725 receives through external interface 1705 a request for an external platform 1660, to make use of the services offered by the system 1700. External interface 1705 may determine that the request is intended to make a New Money 1530 transfer from one client1 1640 to another client2 1640. According to some implementations the process continues with step 2703 where depending on the type of implementation, platform engine 1725 together with the security engine performs the necessary steps to verify external platform 1660.

Once security engine 1760 conforms to external platform 1660 the process can continue with step 2704 where external platform engine 1725 receives through external interface 1705 the data that external platform 1660 sends of client1 1640, who is the originator of the 1530 New Money transfer and from client2 1640, who is the receiver of the transfer. According to some implementations the process continues with step 2705 where external interface 1705 makes a call to client manager unit 1750 in order to discriminate the status of client1 1640 and client2 1640. In certain cases, external interface 1705 can transfer the request 1661 to security engine 1760, so that it can perform the necessary management of the request 1661, usually next to the network engine blockchain 1755. In case client1 1640 or client2 1640 is not registered in the system external platform engine 1725 through external interface 1705 can communicate to external platform 1660 that the required transaction cannot be made as one or both clients 1640 are not registered in the system and the process will be terminated 2720.

If both clients 1640 are registered, the process continues in step 2706 where client manager unit 1750 transfers a request to the security engine 1760 to check client 11640 and client2 1640 security parameters (FIG. 29), (FIG. 30).

Once security engine 1760 confirms the compliance of client1 1640 and client2 1640 security the process can continue with step 2707 where external platform engine 1725 can receive via external interface 1705 an order from external platform 1660 to transfer a certain amount of New Money 1530 from a client1 1640 to a client2 1640. For example, a client1 1640 wishes to transfer to a client2 ‘N’ units of New Money 1530 as payment for the acquisition from client2 of a good, or a service, or simply as a donation or as a consequence of any other business or gratuity.

According to some implementations the process can continue with step 2708 where transaction and calculation engine 1735 calculates the commissions that client1 1640 must pay for New Money 1530 transfer operation to both the managing entity 1610 and external platform 1660. Generally the process continues with step 2709 where transaction and calculation engine 1735 counts the final amount of New Money 1530 that client1 1640 will have for New Money 1530 transfer operation to client2 1640.

In certain implementations the process may continue in step 2710 where depending on the account type, calculation and transaction engine 1735 can send a request to client manager unit 1750 or depositary entity engine 1715 in order to check whether client1 1640 has sufficient amount in his account 1642. If the reply received is that the balance of client1's account 1642 is insufficient to make the transfer, which means that it is less than the amount calculated in step 2709, the process can continue with step 2711 where transaction and calculation engine 1735 can communicate to external platform engine 1725 through external interface 1705 that the operation cannot be performed as client1 1640 does not have enough New Money 1530 balance in his account 1642 and the process generally ends 2717. If client1 1640 has enough money in his account 1642 to deal with the operation, the operation can continue in step 2712 where external platform engine 1725 can communicate to external interface 1705 the cost calculated in step 2709 that client1 has to bear for the transfer of New Money 1530 to client2.

According to certain executions the process can continue with step 2713 where external platform engine 1725 sends a request through external interface 1705 for external platform 1660 to confirm client1 to client2 New Money transfer order 1530. If external platform 1660 does not confirm the transfer order, then the process usually ends 2717. Otherwise, this is when external platform 1660 confirms the transfer order for New Money 1530 from client1 1640 to client2 1640, usually, the process can continue with step 2714 where the transaction and calculation engine 1735 can send an order to network engine blockchain 1755 to initiate the process of withholding on client1's account 1642 from the amount of the cost of New Money 1530 transfer to be made to client2 1640 which is the same as that calculated in step 2709.

According to certain materializations the process can continue to step 2715 where transaction and calculation engine 1735 can make a request to depository entity engine 1715 or client manager unit 1750 for the deduction in client1 account 1642 of the amount of New Money 1530 that has been withheld in step 2714. Transaction and calculation engine 1735 can start the process of adding transaction to the corresponding records. Depending on the type of materialization, transaction and calculation engine 1735 may require an update of client1's account status 1642, client manager unit 1750, blockchain network engine 1755 or the appropriate system within central server system 1700.

Depending on some implementations the process may continue with step 2716 where transaction and calculation engine 1735 requests depository entity engine 1715 or client manager unit 1750 to add the amount of New Money 1530 transferred to client2's account 1642 by client1 1640. Transaction and calculation engine 1735 can start the process of adding the transaction to the corresponding records. In certain cases, transaction and calculation engine 1735 may require an update of client's account statement 1642, client manager unit 1750 or the network engine blockchain 1755.

The process normally continues with step 2717 where transaction and calculation engine 1735 makes a request to depositary entity engine 1715 or client manager unit 1750 to credit the relevant account of the managing entity 1619 the fees payable to the managing entity 1610 for the transfer of New Money 1530. Transaction and calculation engine 1735 can send instructions to transaction and calculation engine 1735 for the aggregation of the transaction to the corresponding records. In certain cases, transaction and calculation engine 1735 may require an update of client2 account statement 1642 from client manager unit 1750 or the blockchain network engine 1755.

According to certain executions the process continues with step 2718 where transaction and calculation engine 1735 makes a request to depository entity engine 1715 to transfer the commissions for the transfer of New Money 1530 through external platform engine 1725 to external platform 1660. Transaction and calculation engine 1735 can send instructions to transaction and calculation engine 1735 for the aggregation of the transaction to the corresponding records. In certain cases, the transaction and calculation engine 1735 may require an update of client2 account statement 1642 from client manager unit 1750 or the blockchain network engine. Normally the process continues with step 2719 where external platform engine 1725 through external interface 1705 communicates to external platform 1660 that the transfer of New Money 1530 from client1 to client2 has been successfully completed.

Modifications, additions or omissions may be made to the methods described herein without deviating from the scope of the invention. For example, the steps can be combined, changed or deleted where appropriate, and additional steps can be added. In addition, the steps may be carried out in any order that is appropriate without deviating from the scope of the present invention.

Although the present invention has been described with several implementations, a myriad of changes, variations, alterations, transformations and modifications may be suggested by an expert in the field, and it is intended that the present invention will encompass such changes, variations, alterations, transformations and modifications to the extent that they are contained in the claims accompanying the present document.

FIG. 28 illustrates an example of a flowchart of the operation of a blockchain system for the execution of a particular request and the updating of the database distributed as a secure blockchain 1756. Usually, the operation is mostly managed by blockchain network engine 1755 and the security engine 1760 which are in charge of editing the databases, security of requests, security of communications and transmission of certain data structures to other systems.

The process starts in step 2802 where a client 1640 or external platform 1660 generates a request to perform a particular operation and signs it with their private key. Signing can be done in a variety of ways such as with a pair of master keys, a regular pair of keys or a multi-signature process.

Normally client 1640 or external platform 1660 sends the request 2803 following the protocols previously defined to external interface 1705. In general, client 1640, 1660 maintains a record, table, or any appropriate data structure to know which server system 1800 to direct the request to. In general, external interface 1705 receives request 2804 from applicant 1640, 1660. External interface 1705 can transfer the request 2805 to the implementation of security engine 1760 in the relevant server system 1800 to, for example, check the request format, applicant addresses, client public key or any other element necessary to ensure security. External interface 1705 can send the request 2805 to client manager unit 1750 in relevant server system 1800 which, depending on certain implementations, can perform client 1640 security checks, usually related to the public key, identification data, or contact data.

In general, security engine 1760 or client manager unit 1750 transmits the applicant's request 1640, 1660 to the network engine blockchain 1755. Blockchain network engine 1755 can build new messages with the built-in request 2806 in order to transmit these messages to the corresponding 2807 server systems 1800. Security engine 1760 can implement security mechanisms in the generated messages such as the creation of a pair of keys, public and private. In some materializations, either the security engine 1760 or blockchain network engine 1755 can build data structures to make information encryption mechanisms known to server systems 1800.

Normally, blockchain network engine 1755 implemented in the server systems 1800 can receive the previously generated messages 2808. In some implementations, security engine 1760 establishes a primary node 2808 that can serve as a reference against other nodes or maintain an authoritative record of parts of blockchain information 1756, for example. The choice of a primary node can be made based on several variables such as proximity to the request transmitter, computing power, leadership division algorithms or any other method suitable for the operation of the system.

In some materializations, the implementation of security engine 1760 in a server system 1800 may test the integrity of received message 2809. Blockchain network engine 1755 and client manager unit 1750 can also support the process, for example by checking the security of the encapsulated request. If either the message generated by blockchain network engine 1755 or the request fails the security tests, the message will be discarded 2813. The discard process can be done with a variety of methods, such as communication to other nodes, or not forwarding the corrupted message and deleting internal logs by security engine 1760.

In general, blockchain network engine 1755 and security engine 1760 can build new negotiation messages and disseminate them to the network nodes using a variety of methods such as point-to-point communications or multicast between nodes. In addition, both engines will normally be able to implement any consensus algorithms 2811 necessary to ensure that the information in the records of each server system 1800 is homogeneous. In some cases, blockchain network engine 1755 and security engine 1760 can ensure that other parameters relative to each node are correct, such as the status of each node that replicates to a state machine. In addition, depending on the implementation, both engines 1755, 1760 are able to discern when an agreement between the nodes has or has not been reached 2812, generally based on a number of iterations, messages of agreement or time elapsed since the beginning of the consensus process. In the event that consensus is not reached, the message can be discarded 2813 by system 1700. In the event that consensus is reached between the nodes, the implementation of the corresponding engine, unit, platform, interface or manager in each server system 1800 can execute the initial request 2814 normally sent by a client 1640 or external platform 1660. Generally, blockchain network engine 1755 is responsible for executing the request at the lowest level, performing the update tasks of the distributed blockchain 1756 or any database that manages 2815.

Depending on the implementation, a node can communicate to the transmitter of the request 1640, 1660 the result of the execution of the request 2816. Usually the primary node is in charge of this communication. In some cases, blockchain network engine 1755 can transmit to the corresponding nodes the result of the operation to other nodes, for example, the primary node can communicate the result of the operation based on its own result and that of other secondary nodes. In other materializations the primary node can communicate the outcome directly relying on the robustness of the consensus protocols. Normally, after this step, the operation is completed.

Modifications, additions or omissions may be made to the methods described herein without deviating from the scope of the invention. For example, the steps can be combined, changed or deleted where appropriate, and additional steps can be added. In addition, the steps may be carried out in any order that is appropriate without deviating from the scope of the present invention.

Although the present invention has been described with several implementations, a myriad of changes, variations, alterations, transformations and modifications may be suggested by an expert in the field, and it is intended that the present invention will encompass such changes, variations, alterations, transformations and modifications to the extent that they are contained in the claims accompanying the present document.

FIG. 29 illustrates an example of a flowchart of the security operation for the online registration of a client 1640 who lacks a wallet 1516 or local wallet 1517 and therefore delegates the custody of his keys 1518 to the central server network 1501. Generally, the transaction takes place in an environment where there is online access to a registration service. In the most common implementations the access is done through systems based on light browsers following the protocols recognized for online access through thin clients. The server side usually generates online access portals following the most common standards for building user interfaces through public networks.

The process is initiated by establishing a secure 2902 connection 1511 through a public network between the user system 1514 belonging to a client 1640 and the central server network 1501, usually with a particular server system computer system 1800. In the most common implementations, the secure link 1511 employs communications security protocols that guarantee the identity of the user system 1514 and the server system 1800, the confidentiality, the integrity of the information exchanged between both parties and the non-repudiation at origin and destination.

Once the connection 1511 is established, the secure registration process is started on the server system 1800 as a continuation of the registration administrative process (FIG. 19). The server system 1800 locates client account 1642 created during the registration administrative process (FIG. 19). In most implementations this location is done by the identification of a data point linked 1521 to client 1640 and acting as a reference to unequivocally identify 2903 to client account 1642. After associating client 1640 connected to client account 1642 created on the server system 1800 side, the server processor generates client software to be executed locally on the user system 1514 usually using a light browser.

User system processor 1512 then loads and runs client software from the server system 1800 and proceeds to the generation of a pair of asymmetric 2904 keys 1518, usually public and private respectively, which is then linked to new client 1640. In the most common implementations the system must use algorithms that guarantee the randomness and not duplicity of generated keys 1518. In certain implementations, user system 1514 sends the public key 1518 to the server system 1800 in order to previously check whether generated key 1518 matches any of the keys linked to an existing 2905 client 1640. If so, the process may continue to make an annotation of the incident in the relevant security logs 2906 and may display an error message. It then destroys the information associated with the current registration process and interrupts the 2910 process.

If generated keys 1518 are unique, user system 1514 asks client 1640 for a password 1519 to protect private key 1518 and encrypts private key 1518 with password 2907. The entire process can be performed on client side, preventing unencrypted private key 1518 from traveling to the server side of the system. In the most common implementations, encryption algorithms are used that offer maximum security according to the current state of technology at all times and with encryption keys generated from client's password 1519 that guarantee its robustness and therefore makes brute force attacks difficult. In some implementations, client 1640 may also be required to comply with minimum quality measures such as length, variety of alphabet used or non-use of words found in dictionaries.

After obtaining private key 1518 encrypted with a password 1519 known only to client 1640 and not stored on any of the systems, client side can send public key 1518 and private key 1518, encrypted, 2908 to the server system 1800. Generally, both data are stored in client account 1642 in order to be used later in various operations related to the security process for that client 1640. In this type of zero-knowledge implementation, client 1640 is solely responsible for custody of the password 1519 that protects his or her private key 1518. In some instances, the server system 1800 may assist by allowing a reminder to be logged into client account 1642. In certain implementations the password 1519 chosen by client 1519 serves as a seed for the generation of different keys in different contexts related to the system depending on the algorithms and processes chosen to make it difficult to decrypt the keys associated with client.

After the keys have been stored, a session will be opened between the user system 1514 and the server system 1800 with a limited timeout 2909.

Modifications, additions or omissions may be made to the methods described herein without deviating from the scope of the invention. For example, the steps can be combined, changed or deleted where appropriate, and additional steps can be added. In addition, the steps may be carried out in any order that is appropriate without deviating from the scope of the present invention.

Although the present invention has been described with several implementations, a myriad of changes, variations, alterations, transformations and modifications may be suggested by an expert in the field, and it is intended that the present invention encompasses such changes, variations, alterations, transformations and modifications to the extent that they are contained in the claims accompanying the present document.

FIG. 30 illustrates an example of a flowchart of the security operation for the online registration of a client 1640 with a wallet 1516 or local wallet 1517. In some implementations, local wallet 1517 is a system with its own processor and storage that allows clients to transport their keys 1518 and store the transactions they make with a high degree of security. In this way, secret keys 1518 linked to clients 1640 remain under their absolute control and do not travel to external systems, not even encrypted.

Generally, the operation takes place in an environment where there is a server system 1800 that offers APIs 1503 and allows the exchange of information through a secure communication 1511 channel without the use of thin clients. Communications 1511 security may be based on the use of recognized protocols for application interconnection using public networks.

The process is initiated by establishing a secure 3002 connection 1511 over a public network between the user system 1514 belonging to a client 1640 and the server system 1800. In the most common implementations, secure link 1511 employs communications security protocols that guarantee the identity of user system 1514 and server system 1800, the confidentiality, the integrity of the information exchanged between both parties and the non-repudiation at origin and destination.

Once the connection 1511 is established, the secure registration process is started on the server system 1800 as a continuation of the registration administrative process (FIG. 19). The server system 1800 locates client account 1642 created in the registration administrative process 3003. In most implementations the locating of client 1642 account is done by the identification of a data point 1521 linked to client and acting as a reference to uniquely identify client account 1642. After having associated client 1640 connected to client account 1642 created on the server side, the server processor normally communicates to client's wallet 1516 or local wallet 1517 the information that is used as client account 1642 identifier.

wallet 1516 or local wallet 1517 processor can then generate an asymmetric pair of keys 1518, usually public and private respectively, which are then linked to the new client 1640. In the most common implementations the system must use algorithms that guarantee the randomness and not duplicity of the generated keys 1518. In some implementations user system 1514 can send public key 1518 to server system 1800 in order to previously check if generated key 1518 matches any of the keys linked to an existing 3005 client 1640. If so, server system 1800 can note the incident in the relevant security logs 3006 and display an error message to the 1600 client. Generally, server system 1800 communicates to wallet 1516 or local wallet 1517 an instruction to abort the process that may involve the destruction by both systems of the information associated with the current registration process. Normally, after the destruction of the relevant information, process ends 3011

If the generated keys 1518 are unique, wallet 1516 or local wallet 1517 usually asks client 1640 for a password 1519 to protect private key 1518 and encrypts private key 1518 with the password 3007. The entire process is performed in wallet 1516 or local wallet 1517, thus avoiding the encrypted or unencrypted private key 1518 traveling to the server system 1800. In the most common implementations, encryption algorithms can be used that offer maximum security according to the current state of technology at all times and with encryption keys generated from client's password 1519 that guarantee their robustness and therefore make brute force attacks difficult. In some implementations, client may be required to comply with minimum quality measures for the password 1519 chosen, which may concern parameters such as length, variety of alphabet use or non-use of words found in dictionaries.

Once you have obtained private key 1518 encrypted with a password 1519 known only to client 1640 and not stored on any of the systems, the wallet side usually stores the private key 1518 encrypted 3008. In addition, client side 1520 sends the public key 1518 to the server system 1800 which is stored by the server system 1800 in client account 3009 for later use in various operations related to process security for that client 1640. In most implementations, wallet 1516 or local wallet 1517 also stores the public key 1518 but with private key 1518 encrypted with client's password 1519. In this type of zero-knowledge implementation, client 1640 is solely responsible for the custody of password 1519 that protects his or her private key 1518. Server system 1800 cannot assist you except by allowing a reminder to be made on client account 1642, which can normally be made either on server system 1800 or on wallet 1516 or local wallet 1517, of the choice of your password 1519. In some materializations the password 1519 chosen by client 1640 can serve as a seed for the generation of various keys in different contexts related to the system depending on the algorithms and processes chosen to make the decryption of the keys 1518 associated with client 1640 difficult.

After storing keys 1518, a session is usually opened between user system 1514 and server system 1800 with a limited timeout 3010.

Modifications, additions or omissions may be made to the methods described herein without deviating from the scope of the invention. For example, the steps can be combined, changed or deleted where appropriate, and additional steps can be added. In addition, the steps may be carried out in any order that is appropriate without deviating from the scope of the present invention.

Although the present invention has been described with several implementations, a myriad of changes, variations, alterations, transformations and modifications may be suggested by an expert in the field, and it is intended that the present invention encompasses such changes, variations, alterations, transformations and modifications to the extent that they are contained in the claims accompanying the present document.

FIG. 31 illustrates an example of a flowchart of the security operation for the online registration of an external platform 1660 that, once registered as a trusted platform, allows clients of external platform 1660 to register as clients 1640 based on their data on external platform 1660 and carry out transactions with the managing entity 1610. In most implementations, external platform 1660 is an external system that works on an external electronic device 1510 with its own processor 1512 and storage 1513 that allows a client 1640 to communicate and perform operations with the central server network 1501. Depending on the type of implementation, this communication may occur with one or more particular server systems 1800.

Generally, the operation takes place in an environment that offers system exchange interfaces (API) 1503 and allows the exchange of information through a secure communication channel 1511. Communications 1511 security is typically based on the use of recognized protocols for application interconnection using public networks.

The process is initiated by the registration of an external platform registry 3102 that has to be authorized on server system 1800 and the establishment of a secure connection 1511 through a public network between user system 1514 belonging to an external platform 1660 and the server system 1800. In the most common implementations, the secure link 1511 employs communications security protocols that guarantee the identity of the user system 1514 and server system 1800, confidentiality, integrity of the information exchanged between both parties, and non-repudiation at origin and destination. Such registration generally produces new entries in the corresponding registers and directories to indicate confidence in external platform 1660.

Once a secure connection 1511 is established between user system 1514 and the server system 1800, user system 1514 of external platform 1660 typically generates an asymmetric pair of keys 1518, public and private respectively 3103, which allows user system 1514 to be identified by server system 1800 in subsequent operations.

In the most common materializations the system must use algorithms that guarantee the randomness and not duplicity of generated keys 1518. In certain implementations, user system 1514 belonging to external platform 1660 sends its public key 1518 to server system 1800 in order to previously check whether generated key 1518 matches any of the keys linked to an existing 3104 external platform 1660. If so, server system 1800 can note the event in the relevant security logs 3105 and return an error message to user system 1514. In a normal operation, server system 1800 aborts and terminates process 3110, which may involve the destruction by user system 1514 and server system 1800 of the information associated with the current registration process.

If generated keys 1518 are unique, user system 1514 can encrypt your private 3106 key 1518 and, normally, send it to the server system 1800 along with your 1518 public 3107 key 1518. Both keys 1518 are stored by server system 1800 in external platform account 1642 created 3108. Finally, the server system 1800 returns to the user system 1514 of external platform 1660 a confirmation that the account 1642 has been successfully created.

Modifications, additions or omissions may be made to the methods described herein without deviating from the scope of the invention. For example, the steps can be combined, changed or deleted where appropriate, and additional steps can be added. In addition, the steps may be carried out in any order that is appropriate without deviating from the scope of the present invention.

Although the present invention has been described with several implementations, a myriad of changes, variations, alterations, transformations and modifications may be suggested by an expert in the field, and it is intended that the present invention encompasses such changes, variations, alterations, transformations and modifications to the extent that they are contained in the claims accompanying the present document.

FIG. 32 illustrates an example of a flowchart of the security operation for the identification process of a client 1640 who has previously registered with the system (FIG. 19), (FIG. 29) and who is accessing it through a public network. The access in the most common implementations is done by means of a thin client (e.g. internet browser) or through a wallet 1516 or local wallet 1517.

The process is initiated by establishing a secure 3202 connection 1511 over a public network between a client's 1640 user system 1514 and central server network 1501. Depending on the type of implementation, this connection 1511 can be made with one or more particular server systems 1800. In the most common implementations, secure link 1511 employs communications security protocols that guarantee the identity of user system 1514 and server system 1800, confidentiality, integrity of the information exchanged between both parties, and non-repudiation at origin and destination.

The process continues with step 3203. Once secure connection 1511 is established, client 1640 requests access by sending server system 1800 a user ID 1521 that matches the ID defined in client registration administrative process (FIG. 19).

Once the access request is received, server system 1800 proceeds to the location 3204 of client account 1642 created during the registration administrative process (FIG. 19) and which corresponds to the identifier 1521 sent.

If a client account 1642 with expected identifier 1521 exists, the server system 1800 sends the user system 1514 a session set-up confirmation. Following this revelation, once the session is established, the server system 1800 generates a single-use random value such as a nonce 3205, which serves as a challenge to the authentication process and makes it difficult to replay. Server system 1800 sends the nonce to user system 3205.

Once the nonce is received, user system 1514 starts the encryption process. Depending on type of key 1518 storage available on user system 1520, the method of retrieving private key 1518 may vary from 3206. If user system 1514 has a wallet 1516 or a local wallet 1517, user system 1514 usually retrieves from wallet 1516 or local wallet 1517 the private encrypted 3207 key 1518 and asks client 1640 for the password 1519 to decipher it 3209. If deciphered correctly, 1515 encryption unit can proceed to encrypt the nonce 3210 with obtained private key 1518. User system 1514 sends the nonce 3211 encryption to the server system 1800.

If user system 1514 does not have a wallet 1516 or a local wallet 1517, the server system 1800 can locate the encrypted private key 1518 in client account 1642 and send 3208 it to user system 1514 by preloading client software onto the local system. In most implementations, such a local system consists of a lightweight browser with the ability to run client software. Once the encrypted private key 1518 is received, user system processor 1512 generally asks client 1640 for password 1519 to decipher the same private key 1518 and proceed to encrypt the nonce with it 3211. User system 1514 sends the nonce 3211 encryption to the server system 1800.

In both cases, decrypted private key 1518 remains on user system 1514 and the nonce encryption occurs equally on the local system from where it is sent to server system 1800.

Upon receipt of the nonce encryption with client 1640 private key 1518, server system 1800 performs 3212 decipher testing with client 1640 public key 1518 retrieved from its account 1642. According to this revelation, the process varies depending on the outcome of the 3213 deciphering. If deciphering is successful, the server system 1800 can compare the deciphered nonce with the nonce initially sent to the user system 1514. In the case of a match, the server system 1800 generally determines that the correct authentication of client 1640 has occurred and proceeds to log in between the user system 1514 and the server system 1800 with an associated timeout 3217. After the opening of the session, the process ends 3218.

In the event that the data sent by client 1640 cannot be deciphered or, even if it is deciphered, and it does not match the nonce sent, server system 1800 can ask 1640 user system to repeat the process a maximum of n 3214 attempts. Once this threshold is exceeded, the identification process is interrupted and server system 1800 can note the incident in relevant security logs 3215 and send a message to user system 1514 that authentication has not been successful. In some implementations, server system 1800 blocks client account 1642 temporarily or permanently based on the risk control rules established in the system 3216. Normally, after the temporary blocking has been established, process is completed 3218.

Modifications, additions or omissions may be made to the methods described herein without deviating from the scope of the invention. For example, the steps can be combined, changed or deleted where appropriate, and additional steps can be added. In addition, the steps may be carried out in any order that is appropriate without deviating from the scope of the present invention.

Although the present invention has been described with several implementations, a myriad of changes, variations, alterations, transformations and modifications may be suggested by an expert in the field, and it is intended that the present invention encompasses such changes, variations, alterations, transformations and modifications to the extent that they are contained in the claims accompanying the present document.

FIG. 33 illustrates an example of a security operation flowchart for the identification process of an external platform 1660 as a step prior to the access of a client 1640 of external platform 1660 to the central server network 1501.

The process is initiated by establishing a secure 1511 connection 3302 through a public network between the user system 1514 of external platform 1660 and the central server network 1501. Depending on the type of materialization, the connection 1511 can be made with one or more private server systems 1800. In the most common implementations, the secure 1511 connection employs communications security protocols that can guarantee confidentiality, integrity of information exchanged between both parties and non-repudiation at origin and destination.

Once the secure connection 1511 is established, client 1640 of external platform 1660 requests access to the server system 1800 via the platform 1660. Normally the user system 1514 sends 3303 a client identifier 1521 and external platform identifier 1521. Using external platform identifier 1521, server system 1800 can check whether it is authorized, while client identifier 1521 generally allows the server system 1800 to initiate a pre-registration process if it has no associated account 1642 or an authorized access, if it does not. Upon receipt of the access request, the server system 1800 proceeds to locate the account on external platform 1642 stored in relevant logs or directories 3304.

If an external platform account 1642 exists, server system 1800 generates a one-time random value, such as a nonce, that can serve as a challenge to the authentication process of external platform 1660 and makes it difficult to replay. Server system 1800 then sends the nonce 3305 to user system 1514 of external platform 1660. Depending on the type of implementation, user system 1514 can access the private key 1518 either directly if it is stored in a wallet 1516 or local wallet 1517 or through the server system 1800 which can retrieve private key 1518 from external platform account 1642 once private key 1518 is known, user system 1514 can encrypt the nonce 3306, and send it to the server system 1800.

After receiving the nonce encrypted with private key of the user system 1514 from external platform 1660, server system 1800 tries to decipher it 3308 with the public key of the user system 1514 normally recovered from the account of external platform 1642. Server system 1800 can check if the nonce deciphering is successful 3309.

In the event that the sent nonce cannot be deciphered, the server system 1800 can ask user system 1514 to repeat the process a maximum of n attempts. Server system 1800 can check the number of 3310 user system 1514 authentication attempts. Once this threshold is exceeded, the identification process is normally interrupted and server system 1800 records the incident 3315 in the appropriate security logs. Server system 1800 can send a message to user system 1514 that authentication has not been successful. In some materializations, server system 1800 blocks access to external platform 1660, temporarily or permanently 3316 depending on the risk control rules established in the system.

Based on this implementation, if deciphering is successful, server system 1800 determines that successful authentication of external platform 1660 has occurred and proceeds to the opening of a session 3311 between user system 1514 and server system 1800. The server system 1800 can then check whether client 1521 identifier sent from external platform 1660 at the request of client 1640 matches that of one of its client accounts 3312. If this is the case, client identification 3313 (FIG. 32) is continued, otherwise a standard registration process 3314 (FIG. 29), (FIG. 30) can be started from the data that client 1640 sends from external platform 1660.

Modifications, additions or omissions may be made to the methods described herein without deviating from the scope of the invention. For example, the steps can be combined, changed or deleted where appropriate, and additional steps can be added. In addition, the steps may be carried out in any order that is appropriate without deviating from the scope of the present invention.

Although the present invention has been described with several implementations, a myriad of changes, variations, alterations, transformations and modifications may be suggested by an expert in the field, and it is intended that the present invention encompasses such changes, variations, alterations, transformations and modifications to the extent that they are contained in the claims accompanying the present document.

FIG. 34 illustrates an example of a flowchart of the security operation for the confidentiality process in transactions. This is a scenario in which a transaction occurs that must only be visible to a set of authorized entities or persons.

In any case, the managing entity 1610 of New Money 1530 and user 1520 are always authorized to access the transaction. In some implementations, access can also be extended to other entities depending on the nature of the operation. For example, in the case of a transfer of an asset from client 1640 to a third party, then both the recipient and the entity where the recipient has an account can also be authorized to access the transaction.

The process is initiated by the server system 1800 checking a number of operation-related parameters to determine whether the transaction is a suspicious transaction 3402, for example, but not limited to, an abnormally large amount transferred or transactions from a location not recognized by user 1520. If any anomaly is detected, the incidence is recorded in appropriate security logs 3403 and process 3411 is normally aborted. Otherwise, the process of securing the operation by generating a one-time symmetric key 3404 on server system 1800 begins. We call the generated key CST. In more general materializations, there is a different key for each operation. This key is the one that guarantees the confidentiality of the transaction and is only accessible by authorized parties. Care must be taken to ensure that the generated key is sufficiently cryptographically robust. In most implementations, a random key generation system can be used that can be based on a nonce provided by the client and on completely random factors that make it impossible or highly unlikely that two identical keys can be generated for different transactions.

The server system 1800 then retrieves its public key and encrypts the one-time symmetric key with aforementioned key with its public key 3405. The result of this encryption is called CSTS. In most implementations, server system 1800 performs a similar process by retrieving 3406 the public key 1518 from client account 3406 or external platform account 1642 and encrypting the CST with the recovered public key 1518 3407. The result is called CSTC.

In some implementations, and depending on the nature of the operation, the server system 1800 may determine which other parties should be authorized to access the operation and obtain their public keys to generate the encrypted CST with each of them.

Once each of the CST's encrypted values is obtained, the server system 1800 encrypts the operation with the CST 3408. The most common implementations generally use symmetric encryption algorithms based on the technology available at any given time, so it is very difficult to decrypt the operation later unless CST is known.

For certain materializations, the set of CST encryptions is linked to the operation encrypted in the corresponding blockchain 3409 and the CST is destroyed without encryption at 3410.

To decrypt the operation, the reverse process is carried out, i.e. authorized user 1520, who may be a client 1640 or an external platform 1660 by way of example and without limitation to, may use his private key 1518 to decrypt with encryption unit 1515 the value of the CST encrypted with his public key 1518 and, once the CTS has been obtained, proceed to decrypt it.

Modifications, additions or omissions may be made to the methods described herein without deviating from the scope of the invention. For example, the steps can be combined, changed or deleted where appropriate, and additional steps can be added. In addition, the steps may be carried out in any order that is appropriate without deviating from the scope of the present invention.

Although the present invention has been described with several implementations, a myriad of changes, variations, alterations, transformations and modifications may be suggested by an expert in the field, and it is intended that the present invention encompasses such changes, variations, alterations, transformations and modifications to the extent that they are contained in the claims accompanying the present document.

By merging the crypto-currencies with the investment vehicles, so that each unit of crypto-currency represents a percentage share in an investment vehicle, and so that the holder of the coin is also the holder of the share in the investment vehicle, we provide the crypto-currencies with a real objective value and thus unify the advantages of two worlds, that of crypto-currencies and that of the investment vehicles.

Any transfer of the crypto-currency implies, in turn, the transfer of its share in the investment vehicle, so that the new owner is also the owner of the percentage that corresponds to the currency in the investment vehicle.

By establishing that the crypto-currency can be exchanged at any time for the value represented by its participation in the investment vehicle, we obtain a currency with all the advantages of crypto-currency and which also has a real objective value.

With this technique we improve the crypto-currencies in use, limiting monetary speculation since the value of the currency will hardly deviate from the value of the assets in which the investment vehicle materializes.

With this system, in the same way that occurs on a personal level, society is encouraged to take responsibility for its decisions and actions, facing the results and consequences derived from them, which, consequently, will increase the level of social awareness. It encourages nations to use their resources to the extent of their possibilities, not mortgaging future generations, avoiding devaluations and inflation and limiting the possibilities of generating financial bubbles.

They can be used in any country in the world, reducing transaction costs and times and they will also have an economic return that is that obtained by the investment vehicle, which enhances the function of money as a deposit of savings and value, mainly favoring the poorer classes.

The described system is subject to modifications, additions or omissions without deviating from the scope of the invention. For example, the entities described may be combined, modified or deleted where appropriate, and additional entities may be added.

Although the present invention has been described with several implementations, all of them as examples, a multitude of changes, variations, alterations, transformations and modifications can be suggested by an expert in the field, and it is intended that the present invention includes such changes, variations, alterations, transformations and modifications to the extent that they are included in the claims that accompany this document.

Modifications, additions or omissions may be made to the methods described herein without deviating from the scope of the invention. For example, the steps can be combined, changed or deleted where appropriate, and additional steps can be added. In addition, the steps may be carried out in any order that is appropriate without deviating from the scope of the present invention.

Although the present invention has been described with several implementations, a myriad of changes, variations, alterations, transformations and modifications may be suggested by an expert in the field, and it is intended that the present invention will encompass such changes, variations, alterations, transformations and modifications to the extent that they are contained in the claims accompanying the present document.

1. A computer-based system for issuing and managing a new currency comprising:
a management module, executable by a computer processor, configured to: create and manage a new currency backed by assets stored in an investment vehicle, wherein a currency unit of the new currency is a title of an undifferentiated interest in the investment vehicle that the owner of the currency unit will therefore be the owner of the interest in the investment vehicle and can exchange the currency unit for the value of the interest in the investment vehicle that ensures real and objective value for its holder wherein the management module comprises a managing entity, said managing entity comprises a memory operable to the new currency and crypto-currencies.

2. The system of claim 1 wherein the management module maintains fiat money accounts.

3. The system of claim 1, wherein the management module further comprises a professional investment manager interface for a professional investment manager to administer and manage the investment vehicle.

4. The system of claim 3 wherein the management module further comprises external electronic terminals for access by users, the external electronic terminals each including at least one processor communicatively coupled to at least one memory operable to: store a client identifier associated with a user, the memory including executable instructions that upon execution by the processor cause the system to: encrypt and decrypt information in an encryption unit, maintain one or more keys, store the one or more keys in a wallet or a local wallet and maintain one or more passwords on the external electronic terminals that encrypt or decrypt the one or more keys stored in the wallet or the local wallet.

5. The system of claim 4 wherein the management module further comprises a central server network including an API having at least one processor communicatively coupled to at least one memory operable to manage a connection with the external electronic terminal, manage procedures with the including a sale of the new currency, fiat money or crypto-currency, transfers of the new currency, placement of an offer to purchase or update the status of the wallet or the local wallet.

6. The system of claim 5 wherein a unit of the new currency is supported on a block chain system that can be used for electronic payments.

7. The system of claim 5 wherein the investment vehicle is maintained in a depository entity, the depository entity having at least one processor communicatively coupled to at least one memory operable to manage the new currency from clients and managing entity accounts and maintain the investment vehicle.

8. The system of claim 5 wherein the central server network includes an external interface to external platforms, depository entity engine, currency market monitoring engine, external platforms engine, monetary unit manager, transactions and calculations engine, internal exchange platform, investment vehicle management unit, client manager unit, blockchain network engine and security operable to provide engine administrative registration of clients, expansion of the investment vehicle, decrease of the investment vehicle, purchase of the new currency from the managing entity, sale of the new currency to the managing entity, peer-to-peer currency exchange via the internal exchange platform, use of the internal exchange platform, communication with the external platforms, peer to peer transfers of the new currency through the internal platform, peer to peer transfer of the new currency through the external platforms, execution of operations in the blockchain network engine, security in registration of a user with a remote coin mechanism, security in registering of a user with the wallet or the local wallet, security when registering the external platform, security when identifying a user, and security when identifying the external platform or confidentiality.

9. The system of claim 1 wherein management module determines a number of units of the new currency which are adapted to an evolution of demand and supply for the new currency, wherein the management module will increase the number of units of the new currency if demand is greater than supply and expand the investment vehicle and decrease the number of units if demand is less than supply and reduce the investment vehicle.

10. The system of claim 1 wherein there is a return on investment of the new currency that is the sum of the return on assets that make up the investment vehicle and the variation in a price of the assets that make up the investment vehicle.

11. The system of claim 1 wherein of the new currency has a theoretical price subject to a series of calculation formulas and a real price that depends on supply and demand of the new currency in the market and an automatic management processes is used to avoid a substantial deviation of the real price from the theoretical price.

12. The system of claim 1 wherein the management module allows operations with third parties, in relation to the management of the new currency.

13. The system of claim 1 wherein the unit value of the new currency is adapted by splits and reverse splits to the needs of the cost of transactions of daily life.

14. The system of claim 1 wherein the new currency is materialized in a form selected from one or more of crypto-coins, electronic money, paper money, and metallic coins.

15. The system of claim 1 wherein the new currency is a means of payment or exchange, as a unit of account or exchange, as a pattern of deferred payments and as a deposit of value.

16. The system of claim 1 wherein a plurality of currencies can coexist simultaneously with each backed by an investment vehicle, which will be managed by a corresponding professional manager.

17. The system of claim 1 wherein the new currency is acquired or sold by buying or selling the new currency through a system manager platform or through external platforms, by buying the new currency on a peer to peer market using the system manager platform or through the external platforms and new currency is received or sent in exchange for a transaction including a purchase and sale of goods or services or donations using both the system manager platform and the external platforms.

18. The system of claim 3 wherein the management module includes an investment vehicle management unit for executing an automatic process to determine a best possible combination of the assets in order to optimize the acquisition of the assets or to select the assets of the investment vehicle whose disposal optimizes a value and performance of the investment vehicle wherein an evolution of the value of the investment vehicle and the value of a currency unit of the new currency depends on the optimization of the investment vehicle management unit and the investment vehicle management unit includes the professional investment manager interface to enable administration and management by the professional investment manager for sales or acquisitions above an established security threshold.

19. The system of claim 18 wherein the investment vehicle management unit has capacity to carry out a substantially unlimited number of automatic sale or acquisition of assets processes for the investment vehicle allowing substantially unlimited extension of the investment vehicle and substantially unlimited issue of units of the new currency per a monetary unit manager wherein the asset base that can be acquired is substantially unlimited as it is extended to all existing assets.

20. A method comprising the step of:
implementing a management module, executable by a computer processor, configured to: create and manage a new currency backed by assets acquired by an investment vehicle, wherein a currency unit of the new currency is a title of an undifferentiated interest in the investment vehicle that the owner of the currency unit will therefore be the owner of the interest in the investment vehicle and can exchange the currency unit for the value of the interest in the investment vehicle that ensures real and objective value for its holder.

21. The method of claim 20 wherein the management module includes an investment vehicle management unit for executing an automatic process to determine a best possible combination of the assets in order to optimize the acquisition of the assets or to select the assets of the investment vehicle whose disposal optimizes a value and performance of the investment vehicle wherein an evolution of the value of the investment vehicle and the value of a currency unit of the new currency depends on the optimization of the investment vehicle management unit and the investment vehicle management unit includes the professional investment manager interface to enable administration and management by the professional investment manager for sales or acquisitions above an established security threshold and the investment vehicle management unit has capacity to carry out a substantially unlimited number of automatic sale or acquisition of assets processes for the investment vehicle allowing substantially unlimited extension of the investment vehicle and substantially unlimited issue of units of the new currency per a monetary unit manager wherein the asset base that can be acquired is substantially unlimited as it is extended to all existing assets.
